(19) United States
(12) Patent Application Publication
(10) Pub. No.: US 2026/0303586 A1
(43) Pub. Date: Oct. 1, 2026

(54) METHOD AND SYSTEM FOR A REAL-TIME MULTI-LAYER PERSONAL AWARENESS AND OPERATIONAL COORDINATION SYSTEM

(71) Applicant: Regina DeBellis, Long Beach, NY (US)

(72) Inventor: Regina DeBellis, Long Beach, NY (US)

(21) Appl. No.: 19/704,002

(22) Filed: Jun. 10, 2026

Related U.S. Application Data
(63) Continuation-in-part of application No. 19/013,389, filed on Jan. 8, 2025.
(60) Provisional application No. 63/619,941, filed on Jan. 11, 2024.

(51) Int. Cl. H04L 9/40

(52) U.S. Cl. CPC H04L 63/08

(57) ABSTRACT

A multi-layer personal awareness and operational coordination system. The system operates as a multi-layer real-time awareness operational platform as predictive intelligence engine, wherein continuously updated operational data is used to determine current physical locations, identity desired people, desired vehicles and desired objects, forecast future movements, behaviors, interactions, and risk events prior to their occurrence, enabling preemptive intervention of civilian and criminal activities.

### CROSS REFERENCES TO RELATED APPLICATIONS

This U.S. utility patent application is a Continuation-In-Part (CIP) of U.S. patent application Ser. No. 19/013,389, filed Jan. 8, 2025, that claims priority to U.S. Provisional patent applications No. 63/619,941, filed on Jan. 11, 2024, the contents of all of which are incorporated by reference.

### FIELD OF INVENTION

This invention relates to identification verification and location information. More specifically, it relates to a method and system for providing a multi-layer personal awareness and operational coordination system.

### BACKGROUND OF THE INVENTION

Current public-safety, military, and emergency-response technologies rely on separate systems to manage geofencing, personnel tracking, device proximity, analytics, and identification verification and location information.

These tools operate independently, often requiring agencies to combine multiple products to obtain only partial situational awareness. For example, location tracking may be handled by one platform, geofencing by another, and identification verification and location information by an entirely separate system.

Existing solutions also lack integrated device-to-device awareness, preventing real-time proximity understanding between field personnel. As a result, law enforcement and military agencies face operational blind spots, fragmented information flows, and delayed response capabilities.

There is no true unified architecture that combines pre-defined sector geofencing, real-time personnel mapping, proximity detection, behavioral analytics, and identification verification and location information into a single, coordinated workflow.

Command centers, dispatchers, and field responders must navigate disconnected interfaces, which limits their ability to maintain a full operational picture during routine patrols, high-risk incidents, and large-scale deployments.

There is a need for a comprehensive system capable of fusing these components into one continuous environment. Such a system should provide complete, real-time awareness of personnel within designated zones, support peer-based proximity detection in low-connectivity conditions, analyze movement patterns, and optionally verify identification verification and location information in accordance with legal and jurisdictional rules.

Thus, it is desirable to solve some of the problems associated with providing personal awareness and operational coordination systems.

### SUMMARY OF THE INVENTION

In accordance with preferred embodiments of the present invention, some of the problems associated with providing a personnel awareness and operational coordination system is presented.

A multi-layer personal awareness and operational coordination system. The system operates as a multi-layer real-time awareness operational platform as predictive intelligence engine, wherein continuously updated operational data is used to determine current physical locations, identity desired people, desired vehicles and desired objects, forecast future movements, behaviors, interactions, and risk events prior to their occurrence, enabling preemptive intervention of civilian and criminal activities

The foregoing and other features and advantages of preferred embodiments of the present invention will be more readily apparent from the following detailed description. the detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary identification verification and location processing and display system;

FIG. 2 is a block diagram illustrating an exemplary identification verification and location information display system;

FIG. 3 is a block diagram illustrating an exemplary networking protocol stack;

FIG. 4 is a block diagram illustrating an exemplary cloud communications network;

FIG. 5 is a block diagram illustrating an exemplary cloud storage object;

FIG. 6 is a block diagram illustrating wearable network devices;

FIGS. 7A, 7B and 7C are a flow diagram illustrating a method for providing identification verification and location services for a desired person;

FIG. 8 is a block diagram illustrating a plural different security layers available on the server identification verification and location application on the server network device;

FIGS. 9A and 9B are a flow diagram illustrating a method for providing identification verification and location services;

FIG. 10 is a flow diagram illustrating a method for providing identification verification and location services;

FIG. 11 is a flow diagram illustrating a method for providing identification verification and location services for a desired person;

FIG. 12 is a block diagram illustrating a data flow for providing identification verification and location services;

FIG. 13 is a block diagram illustrating an exemplary block chain;

FIG. 14 is a block diagram illustrating plural different services available on the server identification verification and location application on the server network device;

FIG. 15 is a block diagram illustrating an exemplary multi-layer personal awareness and operational coordination system application;

FIGS. 16A, 16B, 16C and 16D are a flow diagram including a method for providing a multi-layer personal awareness and operational coordination system;

FIG. 17 is a block diagram illustrating exemplary primary geofenced boundaries and internal spatial subdivisions;

FIG. 18 is a block diagram illustrating exemplary augmenting through network beacons when direct network signaling is limited or not available on the communications network;

FIG. 19 is a block diagram illustrating exemplary augmenting through mesh network beacons on a mesh network when direct network signaling is limited or not available on the communications network;

FIG. 20 is a block diagram illustrating a unified operational map, including movement histories of the registered plurality of authorized network devices, the collected positional data and relational data for the registered plurality of authorized network devices; and

FIGS. 21A, 21B and 21C are a flow diagram including a method for providing a multi-layer personal awareness and operational coordination system.

### DETAILED DESCRIPTION OF THE INVENTION

### Exemplary Identification Verification and Location Processing and Display System

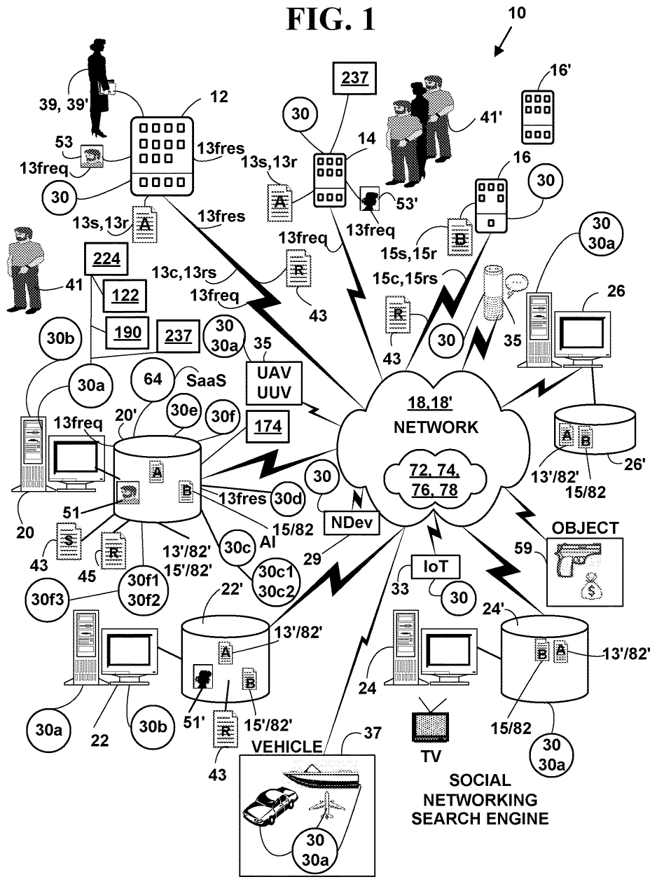

FIG. 1 is a block diagram illustrating an exemplary identification verification and location processing and display system 10 for sending and receiving electronic messages. the exemplary system 10 includes, but is not limited to, one or more target network devices 12, 14, 16, etc. each with one or more processors and each with a non-transitory computer readable medium, connected to a communications network 18, 18′. A network device is any device that can be connected to the communications network 18, 18′ with a wireless and/or wired connection.

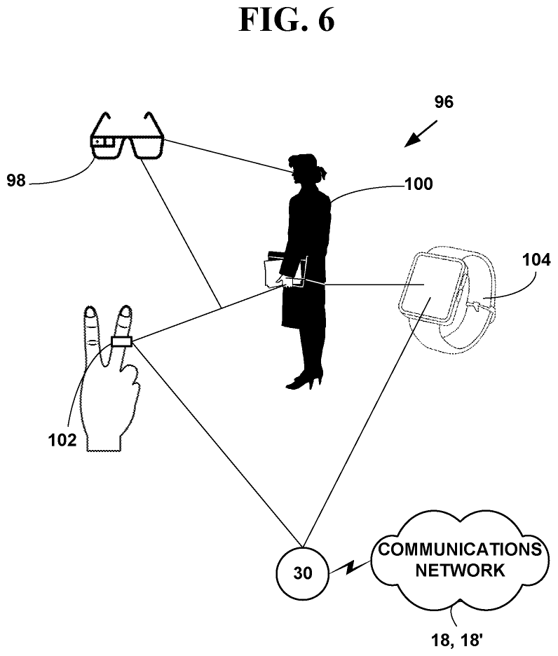

The one or more target network devices 12, 14, 16 (illustrated in FIG. 1 only as a tablet and two smart phones for simplicity) include, but are not limited to, (desktop and laptop computers, tablet computers, mobile phones, non-mobile phones with displays, smart phones, Internet phones, Internet appliances, personal digital/data assistants (PDA), portable, handheld and desktop video game devices, cable television (CATV), satellite television (SATV) and Internet television set-top boxes, digital televisions including high definition television (HDTV), three-dimensional (3DTV) televisions, collectively, network devices (NDev) 29, smart speakers 31, Internet of Things (IoT) devices 33, Unmanned Ariel Vehicles (UAVs) 35, vehicles 37, wearable network devices 106-112 (FIG. 6), Point of Sale (PoS) network devices 224 and/or other types of network devices.

A “smart phone” is a mobile phone 14 that offers more advanced computing ability and connectivity than a contemporary basic feature phone. Smart phones and feature phones may be thought of as handheld computers integrated with a mobile telephone, but while most feature phones are able to run applications based on platforms such as JAVA ME, a smart phone usually allows the user to install and run more advanced applications. Smart phones and/or tablet computers run complete operating system software providing a platform for application developers.

The tablet computers 12 include, but are not limited to, tablet computers such as the IPAD, by APPLE, Inc., the HP Tablet, by HEWLETT PACKARD, Inc., the PLAYBOOK, by RIM, Inc., the TABLET, by SONY, Inc., etc.

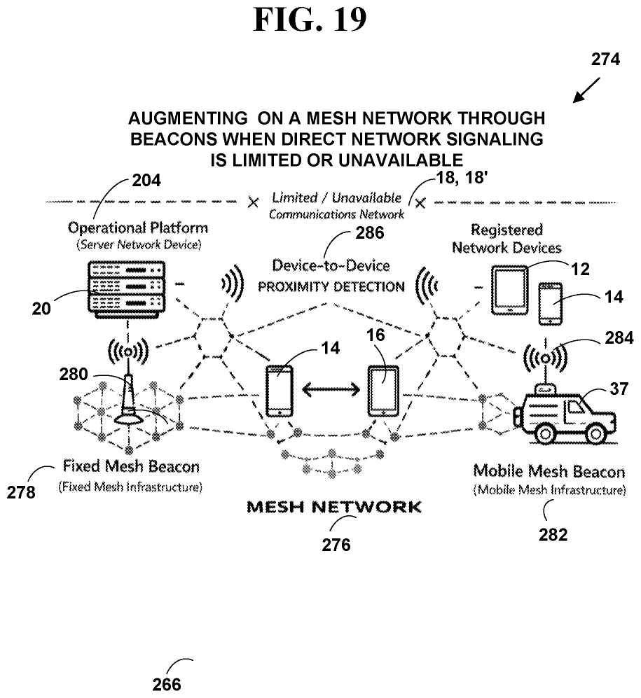

A “smart speaker” 31 includes but is not limited to, a type of wireless speaker and voice command device with an integrated virtual assistant that offers interactive actions and hands-free activation with the help of one “hot word” (or several “hot words”). Some smart speakers can also act as a smart device that utilizes Wi-Fi, BLUETOOTH and other wireless protocol standards to extend usage beyond audio playback, such as to control home automation devices. This can include, but is not be limited to, features such as compatibility across a number of services and platforms, peer-to-peer connection through mesh networking 276 (FIG. 19), virtual assistants, and others. Each can have its own designated interface and features in-house, usually launched or controlled via application or home automation software. Some smart speakers also include a screen to show the user a visual response.

The IoT network devices 33, include but are not limited to, cameras, security cameras, doorbells with real-time video cameras, baby monitors, televisions, set-top boxes, lighting, heating (e.g., smart thermostats, etc.), ventilation, air conditioning (HVAC) systems, and appliances such as washers, dryers, robotic vacuums, air purifiers, ovens, refrigerators, freezers, toys, game platform controllers, game platform attachments (e.g., guns, goggles, sports equipment, etc.), gun-shot detection monitors and/or other types of IoT network devices.

Unmanned aerial vehicles (UAV) 35, commonly known as “drones” and also referred to as Remotely Piloted Aircraft (RPA), included but are not limited to, are aircraft and watercraft guided autonomously, by remote control, or both and that carry sensors and cameras to collect information and display the collected information to an operator.

Unmanned underwater vehicles 35 (UUV), also known as uncrewed underwater vehicles and underwater drones, are submersible vehicles that can operate underwater without a human occupant. These vehicles may be divided into two categories: remotely operated underwater vehicles (ROUVs) and autonomous underwater vehicles (AUVs).

Vehicles 37, include, but are not limited to, vehicles with and/or without a driver including, land vehicles (e.g., automobiles, trucks, buses, motorcycles, locomotives, snow machines, etc.), air vehicles (e.g., drones, UAVs, airplanes, helicopter, hot air balloon, blimp, etc.), water vehicles, (e.g., UUVs, ROUVs AUVs, ships, boats, barges, rafts, canoes, kayaks, personal water craft (PWC), etc.) and/or other types of vehicles with a wired and/or wireless network interface for connecting with the communications network 18, 18′.

Point of Sale (PoS) network devices 224, include, but are not limited to, a network device used by businesses to process customer transactions, track inventory, and manage sales data. The PoS 224 network devices include hardware and software 30 combination used at the place where a customer makes a purchase, whether in-store or online. the PoS network devices 224 include, but are not limited to, cash registers, credit and debit card readers, barcode scanners, easy pay readers (e.g., NFC, M2M, etc.), mobile payment readers (e.g. APPLE PAY, GOOGLE PAY, etc.), receipt printers, touchscreen displays and/or other types of PoS 224 network devices 224.

The target network devices 12, 14, 16, 31, 33, 35, 37, 106-112 are in communications with a cloud communications network 18 or a non-cloud computing network 18′ via one or more wired and/or wireless communications interfaces. the cloud communications network 18, is also called a “cloud computing network” herein and the terms may be used interchangeably.

The plural target network devices 12, 14, 16, 31, 33, 35, 37, 106-112 send and receive requests for electronic information 13, 15 including but not limited to, identification verification and/or location information for a desired person 41 (e.g., criminal, terrorist, solider, missing person, professional (e.g., doctor, lawyer, nurse, etc.), student, ride share driver, etc.) via the cloud communications network 18 or non-cloud communications network 18′

the cloud communications network 18 and non-cloud communications network 18′ includes, but is not limited to, communications over a wire connected to the target network devices, wireless communications, and other types of communications using one or more communications and/or networking protocols.

Plural server network devices 20, 22, 24, 26 (only four of which are illustrated) each with one or more processors and a non-transitory computer readable medium include one or more associated databases 20′, 22′, 24′, 26′. the plural network devices 20, 22, 24, 26 are in communications with the one or more target devices 12, 14, 16, 31, 33, 35, 37, 106-112 via the cloud communications network 18 and/or the non-cloud communications network 18′.

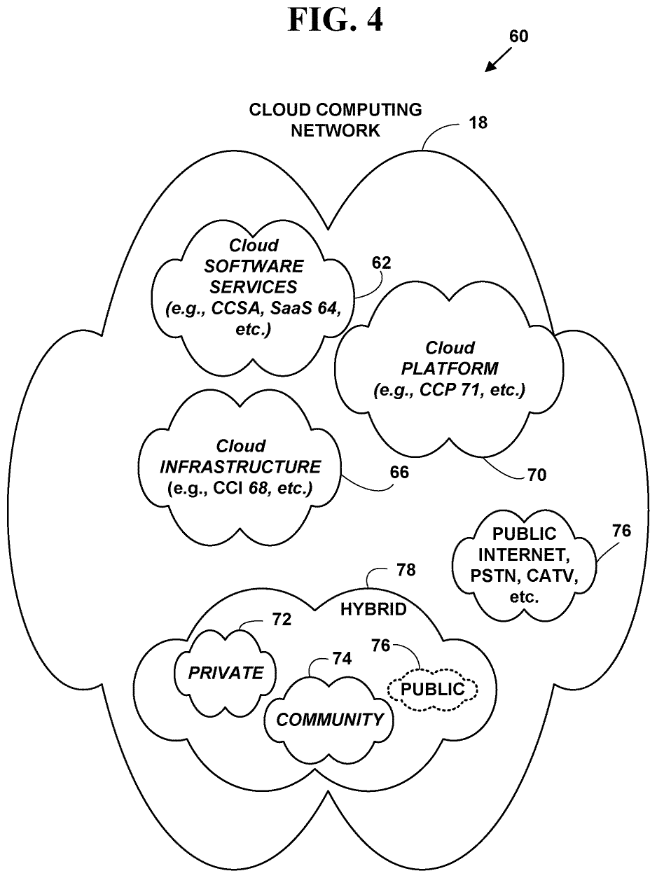

Plural server network devices 20, 22, 24, 26 (only four of which are illustrated) are physically located on one more public networks 76 (See FIG. 4), private networks 72, community networks 74 and/or hybrid networks 78 comprising the cloud network 18.

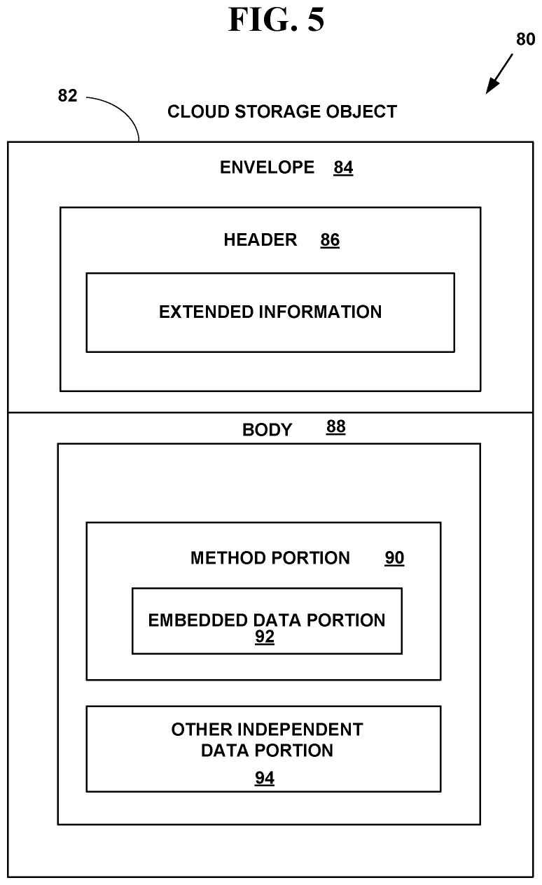

In one embodiment, the one or more server network devices (e.g., 20, 22, 24, 26, etc.) store portions 13′, 15′ of the electronic information 13, 15 (e.g., identification verification and/or location information, etc.) as cloud storage objects 82 (FIG. 5) as is described herein.

The plural server network devices 20, 22, 24 26, may be connected to, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.).

The plural server network devices 20, 22, 24, 26 also include, but are not limited to, network servers used for cloud computing providers, etc.

The cloud communications network 18 and non-cloud communications network 18′ includes, but is not limited to, a wired and/or wireless communications network comprising one or more portions of: the Internet, an intranet, a Local Area Network (LAN), a wireless LAN (WiLAN), a Wide Area Network (WAN), a Metropolitan Area Network (MAN), a Public Switched Telephone Network (PSTN), a Wireless Personal Area Network (WPAN) and other types of wired and/or wireless communications networks 18.

The cloud communications network 18 and non-cloud communications network 18′ includes one or more gateways, routers, bridges and/or switches. A gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.).

An operating environment for the network devices of the exemplary electronic information display system 10 include a processing system with one or more high speed Central Processing Unit(s) (CPU), processors, one or more memories and/or other types of non-transitory computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor. An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information, the memory locations where data bits are maintained are physical locations that have particular electrical, magnetic, optical, or organic properties corresponding to the data bits.

The data bits may also be maintained on a non-transitory computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. the non-transitory computer readable medium includes cooperating or interconnected computer readable medium, which exist exclusively on the processing system or can be distributed among multiple interconnected processing systems that may be local or remote to the processing system.

### Exemplary Identification Verification Location Information Display System

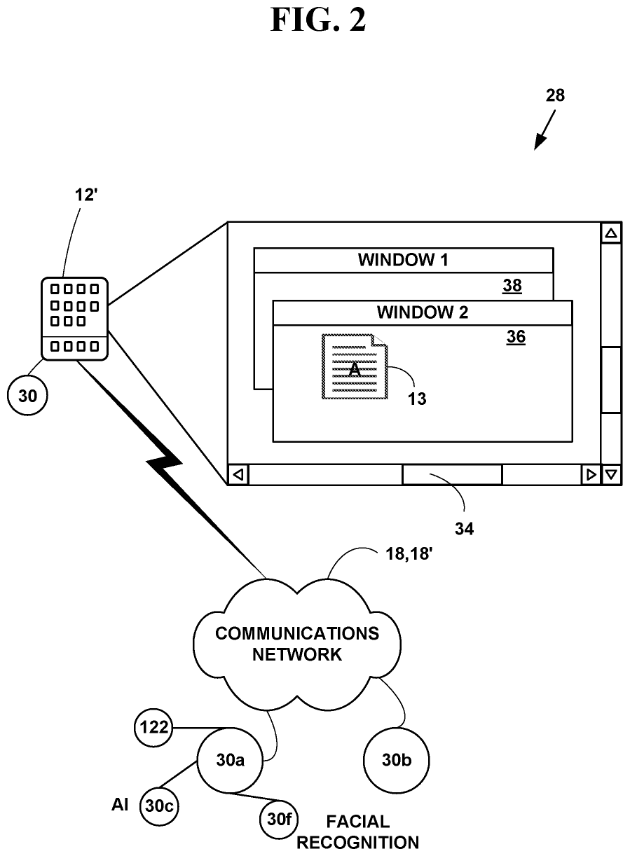

FIG. 2 is a block diagram illustrating an exemplary identification verification and location information display system 28. The exemplary electronic message information display system 12′ includes, but is not limited to a target network device (e.g., 12, etc.) with an application 30 and a display component 32. the application 30 presents a graphical user interface (GUI) 34 on the display 32 component. The GUI 32 presents a multi-window 36, 38, etc. (only two of which are illustrated) interface to a user.

In one embodiment of the invention, the application 30 is a software application. However, the present invention is not limited to this embodiment and the application 30 can be hardware, firmware, hardware and/or any combination thereof. In one embodiment, the application 30 includes a mobile application for a smart phone, electronic tablet and/or other network device. In one embodiment, the application 30 includes web-browser based application. In one embodiment, the application 30 includes a web-chat client application. In another embodiment, the application 30a, 30b, 30c, 30d, 30e, 30f includes a cloud application used on a cloud communications network 18. However, the present invention is not limited these embodiments and other embodiments can be used to practice the invention

In another embodiment, a full application 30 and/or a portion of the application 30 is executing on the target network devices 12, 14, 16, 31, 33, 35, 37, 106-112 and another portion of the application 30a, 30b, 30c, 30d, 30e, 30f is executing on the server network devices 20, 22, 24, 26. the applications also include one or more library applications. However, the present invention is not limited these embodiments and other embodiments can be used to practice the invention.

### Exemplary Networking Protocol Stack

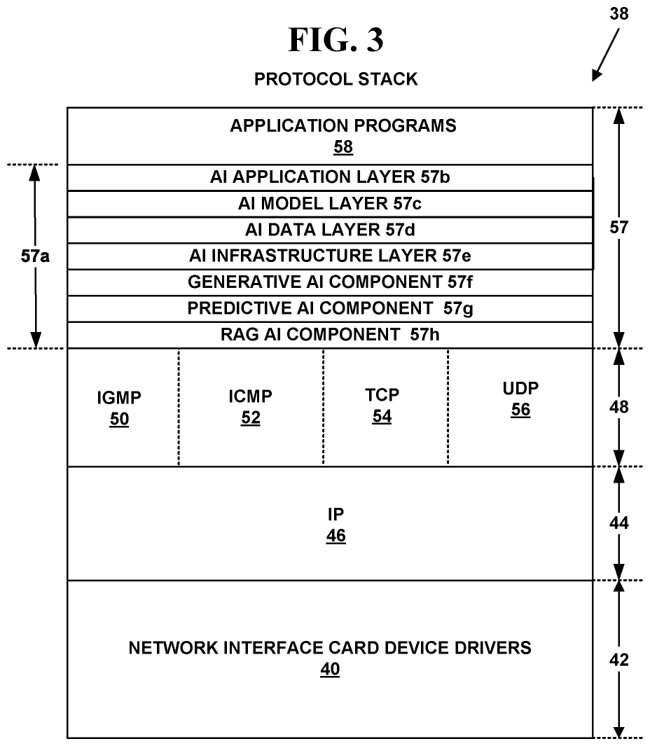

FIG. 3 a block diagram illustrating a layered protocol stack 38 for network devices in the electronic message information display system 10. the layered protocol stack 38 is described with respect to Internet Protocol (IP) suites comprising in general from lowest-to-highest, a link 42, network 44, transport 48 and application 56 layers. However, more or fewer layers could also be used, and different layer designations could also be used for the layers in the protocol stack 38 (e.g., layering based on the Open Systems Interconnection (OSI) model including from lowest-to-highest, a physical, data-link, network, transport, session, presentation and application layer.).

The network devices 12, 14, 16, 31, 33, 35, 37, 106-112 are connected to the communication network 18 with Network Interface Card (NIC) cards including device drivers 40 in a link layer 42 for the actual hardware connecting the network devices 12, 14, 16, 31, 33, 35, 37, 106-112 to the communications network 18, 18′. For example, the NIC device drivers 40 may include a serial port device driver, a digital subscriber line (DSL) device driver, an Ethernet device driver, a wireless device driver, a wired device driver, etc. the device driver interface with the actual hardware being used to connect the network devices to the communications network 18, 18′. the NIC cards have a Medium Access Control (MAC) address that is unique to each NIC and unique across the whole communications network 18, 18′. the Medium Access Control (MAC) protocol is used to provide a data link layer of an Ethernet LAN system and/or for other network systems.

Above the link layer 42 is a network layer 44 (also called the Internet Layer for Internet Protocol (IP) and IP related protocol suites). the network layer 44 includes, but is not limited to, an IP layer 46.

IP 46 is an addressing protocol designed to route traffic within a network or between networks. However, more, fewer or other protocols can also be used in the network layer 44, and the present invention is not limited to IP 46. For more information on IP 46 see IETF RFC-791, incorporated herein by reference.

Above network layer 44 is a transport layer 48. the transport layer 48 includes, but is not limited to, an optional Internet Group Management Protocol (IGMP) layer 50, a Internet Control Message Protocol (ICMP) layer 52, a Transmission Control Protocol (TCP) layer 52 and a User Datagram Protocol (UDP) layer 54. However, more, fewer or other protocols could also be used in the transport layer 48.

Optional IGMP layer 50, hereinafter IGMP 50, is responsible for multicasting. For more information on IGMP 50 see RFC-1112, incorporated herein by reference. ICMP layer 52, hereinafter ICMP 52 is used for IP 46 control. the main functions of ICMP 52 include error reporting, reachability testing (e.g., pinging, etc.), route-change notification, performance, subnet addressing and other maintenance. For more information on ICMP 52 see RFC-792, incorporated herein by reference. Both IGMP 50 and ICMP 52 are not required in the protocol stack 38. ICMP 52 can be used alone without optional IGMP layer 50.

TCP layer 54, hereinafter TCP 54, provides a connection-oriented, end-to-end reliable protocol designed to fit into a layered hierarchy of protocols which support multi-network applications. TCP 54 provides for reliable inter-process communication between pairs of processes in network devices attached to distinct but interconnected networks. For more information on TCP 54 see RFC-793, incorporated herein by reference.

UDP layer 56, hereinafter UDP 56, provides a connectionless mode of communications with datagrams in an interconnected set of computer networks. UDP 56 provides a transaction-oriented datagram protocol, where delivery and duplicate packet protection are not guaranteed. For more information on UDP 56 see RFC-768, incorporated herein by reference. Both TCP 54 and UDP 56 are not required in protocol stack 38. Either TCP 54 or UDP 56 can be used without the other.

Above transport layer 48 is an application layer 57 where application programs 58 (e.g., 30, 30a, 30b, 30c, 30d, 30e, 30f, etc.) to carry out desired functionality for a network device reside. For example, the application programs 58 for the client network devices 12, 14, 16, 31, 33, 35, 37, 106-112 may include web-browsers or other application programs, application program 30, while application programs for the server network devices 20, 22, 24, 26 may include other application programs (e.g., 30a, 30b, 30c, 30d, 30e, 30f etc.).

The AI technology stack 57a includes, but is not limited to, four foundational layers: an AI application layer 57b (FIG. 3) an AI model layer 57c, an AI data layer 57d, and an AI infrastructure layer 57e.

The AI application layer 57b of the AI tech stack 57a includes any software, user interfaces, and accessibility features that enable users to interact with the underlying AI models and the datasets that power an AI solution. For example, browser-based interfaces allow users to send questions to a Generative AI 57f model like CHATGPT, or a data analytics suite including Predictive AI 57g to provide visualizations in the form of graphs and charts to help users understand the AI model's results and/or Retrieval-Augmented Generation AI 57h (RAG or RAG-AI) reduces LLM limitations.

Generative AI (GenAI, or GAI) 57f is a subset of AI that uses Generative AI models to produce new text, images, videos, and/or other forms of data.

Predictive AI (PredAI or PAI) 57g is also a subset of AI that uses Predictive AI models, neural networks, machine learning and statistical analysis to forecast future events. Machine learning is a field of study in AI concerned with the development and study of statistical algorithms that can learn from data and generalize to unseen data, and thus perform tasks without explicit instructions.

Retrieval-Augmented Generation AI (RAG or RAG-AI) 57h reduces LLM limitations by grounding AI responses in a defined set of materials (e.g., trusted databases or specific knowledge, e.g., law enforcement, behavior patterns, biometric information, etc.), increasing, accuracy, reducing AI hallucinations, increasing specificity and enabling more current information than the LLM training data alone.

In one embodiment the AI application 30c and/or the AI technology stack 57a, includes but is not limited to, a Generative AI component 57f and/or a Predictive AI component 57g. In one embodiment, the Generative AI component 57f and the Predictive AI component 57g are standalone components of the AI application 30c. In another embodiment, the Generative AI component 57f, the Predictive AI component 57g and the RAG AI component 57h are included as layers in the AI technology stack 57a. However, the present invention is not limited to such embodiments and other embodiments and/or other combinations can be used to practice the invention.

The AI model layer 57c of the AI technology stack 57a is where AI models are developed, trained, and optimized. AI models are developed using a combination of AI frameworks, toolsets, and libraries and are subsequently trained on vast amounts of data to help refine their decision-making processes.

The AI data layer 57d layer focuses on dataset collection, storage, and management, interfacing with and enabling all the other layers. Data from this layer is fed to the AI model layer 57c, new data from the AI application layer 57b is captured here for future model analysis, and the AI infrastructure layer 57e provides the resources needed to scale, secure, and reliably process the data.

The AI infrastructure layer 57e of the AI technology stack 57a includes all hardware and compute resources needed to run AI models in the AI model layer 57c and any user-facing software. This can include enterprise data centers, cloud 18 or non-cloud 18′ server network devices 20, 22, 24, 26, client/target network devices 12, 14, 16, 31, 35, 98-104, etc.

In one embodiment, the AI application 30c, includes but is not limited to, plural different AI agents. However, the present invention is not limited to such an embodiment and other embodiments, with more, fewer and/or other types of AI can be used to practice the invention.

In one exemplary embodiment, the plural AI agents 30c1, 30c2, etc. (FIG. 1), include, but are not limited to, the AI functionality included in Table 1.

```
TABLE 1
1. AI-Powered Generative AI Conversational Agent 30c
Description: Using Generative AI 57f to create advanced conversational agents that leverage
AI messaging to deliver hyper-personalized interactions. These agents can analyze customer
data, past interactions, and real-time context to provide tailored responses, product
recommendations, and support.
  AI Technologies:
    Hosted AI Models: Pre-trained models hosted the platform 204 for general
    use cases (e.g., sentiment analysis, intent recognition).
    Private Trained Models: Custom AI models fine-tuned on proprietary
    customer data to ensure specific tone, compliance, and accuracy.
    Large Language Models (LLMs): Integration with LLMs like GPT or
    proprietary LLMs for natural language understanding and generation.
    Multimodal AI: Combining text, image, and video analysis to enable richer
    interactions (e.g., analyzing a product image sent by a customer and
    suggesting solutions).
2. AI-Powered Predictive AI Analytics Agent 30c for Proactive User Engagement
  Description: Using Predictive AI 57g to analyze behavior, preferences, and historical
  data to predict future needs and proactively engage users via AI messaging. For
  example, predicting next location and sending timely, context-aware messages.
  AI Technologies:
    Public AI Models: Leveraging publicly available models for Predictive
    analytics (e.g., time-series forecasting models).
    Private Trained Models: Custom models trained on proprietary business
    data to predict customer behavior with high accuracy.
    Reinforcement Learning: AI systems that learn optimal engagement
    strategies over time by analyzing customer responses.
    Edge AI: Deploying lightweight AI models on devices to enable real-time
    predictions without relying on cloud infrastructure.
3. AI-Powered Retrieval Augmented Generation (RAG) 57h Agent 30c
  Description: Retrieval Augmented Generation (RAG) is an AI method that
  improves the accuracy and usefulness of an AI system by allowing it to retrieve
  information from external sources on the Internet or other networks before generating
  a response. Instead of relying only on what was learned during LLM training. RAG-
  AI searches documents, databases, websites, PDFs, or other knowledge sources and
  use that information when answering questions.
  AI Technologies
  Traditional AI Large Language Models (LLMs):
  Have a fixed knowledge base from their LLM training data.
  Can become create incomplete context and associations in LLMs.
  Can ″hallucinate″ (i.e., make up facts).
  Cannot easily access private or proprietary information.
  RAG-AI addresses these limitations by connecting the LLM to external knowledge
  sources and verifying LLM outputs with those external knowledge sources.
  RAG-AI retrieves relevant content and generates a synthesized answer from multiple
  knowledge bases rather than relying solely on the LLM's training data.
```

In one embodiment, application program 30 includes IVL application 30 including an identification verification and location information application 30a, an identification verification and location information application program interface (API) 30b, Artificial Intelligence (AI) application 30c, 30c1, 30c2, etc. and/or other applications 30d, 30e, 30f. However, the present invention is not limited to such an embodiment and more, fewer and/or other applications can be used to practice the invention.

However, the protocol stack 38 is not limited to the protocol layers illustrated and more, fewer or other layers and protocols can also be used in protocol stack 38. In addition, other protocols from the Internet Protocol suites, including but not limited to, Simple Mail Transfer Protocol, (SMTP), Hyper Text Transfer Protocol (HTTP), File Transfer Protocol (FTP), Dynamic Host Configuration Protocol (DHCP), Domain Name System (DNS), Short Message Peer-to-Peer (SMPP), and/or other protocols from other protocol suites may also be used in protocol stack 38.

In addition, markup languages such as HyperText Markup Language (HTML), EXtensible Markup Language (XML) and others are used.

HyperText Markup Language (HTML) is a markup language for creating web pages and other information that can be displayed in a web browser.

HTML is written in the form of HTML elements consisting of tags enclosed in angle brackets within the web page content. HTML tags most commonly come in pairs although some tags represent empty elements and so are unpaired. The first tag in a pair is the start tag, and the second tag is the end tag (they are also called opening tags and closing tags). In between these tags web designers can add text, further tags, comments and other types of text-based content.

The purpose of a web browser is to read HTML documents and compose them into visible or audible web pages. The browser does not display the HTML tags, but uses the tags to interpret the content of the page.

HTML elements form the building blocks of all websites. HTML allows images and objects to be embedded and can be used to create interactive forms. It provides a means to create structured documents by denoting structural semantics for text such as headings, paragraphs, lists, links, quotes and other items. It can embed scripts written in languages such as JavaScript which affect the behavior of HTML web pages.

EXtensible Markup Language (XML) is another markup language that defines a set of rules for encoding documents in a format that is both human-readable and machine-readable. It is defined in the XML 1.0 Specification produced by the W3C, the contents of which are incorporated by reference and several other related specifications, all free open standards.

XML a textual data format with strong support via Unicode for the languages of the world. Although the design of XML focuses on documents, it is widely used for the representation of arbitrary data structures, for example in web services. the oldest schema language for XML is the Document Type Definition (DTD). DTDs within XML documents define entities, which are arbitrary fragments of text and/or markup tags that the XML processor inserts in the DTD itself and in the XML document wherever they are referenced, like character escapes.

The Short Message Peer-to-Peer (SMPP) protocol in the telecommunications industry is an open, industry standard protocol designed to provide a flexible data communication interface for the transfer of short message data between External Short Messaging Entities, Routing Entities (ESME) and Short Message Service Center (SMSC).

Preferred embodiments of the present invention include network devices and wired and wireless interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum.

### Wireless Interfaces

In one embodiment of the present invention, the wireless interfaces on network devices 12, 14, 16, 31, 33, 35, 37, 106-112 include but are not limited to, IEEE 802.11a, 802.11b, 802.11g, 802.11n, 802.11ac, 802.11ax, 802.11be, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” integral or separate Bluetooth and/or infra data association (IrDA) module for wireless BLUEOOTH and/or other types of wireless communications interfaces. However, the present invention is not limited to such an embodiment other types of wireless communications interfaces can also be used.

802.11b is a short-range wireless network standard. the IEEE 802.11b standard defines wireless interfaces that provide up to 11 Mbps wireless data transmission to and from wireless devices over short ranges. 802.11a is an extension of the 802.11b and can deliver speeds up to 54 M bps. 802.11g deliver speeds on par with 802.11a. However, other 802.11XX interfaces can also be used and the present invention is not limited to the 802.11 protocols defined. the IEEE 802.11a, 802.11b and 802.11g standards are incorporated herein by reference.

802.11ac is a Wi-Fi standard, also known as Wi-Fi 5, that provides significantly faster and more efficient wireless connections compared to its predecessor, 802.11n. It operates exclusively on the 5 GHz band and uses technologies like wider channels, more spatial streams, multiple input multiple output (MIMO), and improved data encoding to achieve multi-gigabit speeds, making it ideal for high-bandwidth activities like 4K streaming and online gaming.

802.11ax is the technical name for the Wi-Fi 6 standard, a next-generation wireless networking protocol designed to improve speed, efficiency, and capacity, especially in crowded network environments. It uses technologies like Orthogonal frequency-division multiple access (OFDMA) and enhanced multi-user multiple input multiple output (MU-MIMO) to handle more connected devices simultaneously with higher throughput and lower latency compared to its predecessor, 802.11ac (Wi-Fi 5).

802.11be is a formal designation for the Wi-Fi 7 wireless networking standard, which offers significantly higher speeds, lower latency, and improved efficiency compared to previous generations. Key advancements include wider channel widths (up to 320 MHz), enhanced modulation (4096-Quadrature Amplitude Modulation (QAM)), more spatial streams, and the ability to use multiple bands and links simultaneously to improve performance. This results in speeds up to 40 Gbps and makes it suitable for demanding applications like high-definition streaming, large file transfers, and real-time artificial realities and virtual realities.

Wi-Fi is a type of 802.11xx interface, whether 802.11b, 802.11a, 802.11ac, 802.11ax, 802.11be, dual-band, etc. Wi-Fi devices include an RF interface such as 2.4 GHz for 802.11b, 802.11g and others and 5 GHz for 802.11a, 802.11ac, 802.11ax, 802.11be and others.

802.15.4 (Zigbee) is low data rate network standard used for mesh network 276 (FIG. 19) devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, a full handshake protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station, the IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

In one embodiment, the plural server network devices 20, 22, 24, 26 include a connection to plural network interface cards (NICs) in a backplane connected to a communications bus. the NIC cards provide gigabit/second (1×10⁹ bits/second) communications speed of electronic information. This allows “scaling out” for fast electronic content retrieval. the NICs are connected to the plural server network devices 20, 22, 24, 26 and the cloud communications network 18. However, the present invention is not limited to the NICs described and other types of NICs in other configurations and connections with and/or without buses can also be used to practice the invention.

In one embodiment, of the invention, the wireless interfaces also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, table computer two-way pager, etc.)

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as cloud communications network 18 or non-cloud communications network 18′.

The one or more target network devices 12, 14, 16, 20, 22, 24, 26, 31, 98-104 and one or more server network devices 20, 22, 24, 26 communicate with each other and other network devices with near field communications (NFC) and/or machine-to-machine (M2M) communications.

“Near field communication (NFC)” is a set of standards for smartphones and similar network devices to establish radio communication with each other by touching them together or bringing them into close proximity, usually no more than a few centimeters. Present applications include contactless transactions, data exchange, and simplified setup of more complex communications such as Wi-Fi. Communication is also possible between an NFC device and an unpowered NFC chip, called a “tag” including radio frequency identifier (RFID) tags and/or RFID sensors and/or RFID network devices 99 including one or more RFID tags, RFID sensors and/or a combination thereof.

NFC standards cover communications protocols and data exchange formats, and are based on existing radio-frequency identification (RFID) standards including ISO/IEC 14443 and FeliCa. These standards include ISO/IEC 1809 and those defined by the NFC Forum, all of which are incorporated by reference.

An “RFID tag” is an object that can be applied to or incorporated into a product, animal, or person for the purpose of identification and/or tracking using RF signals.

An “RFID sensor” and/or RFID network device is a device that measures a physical quantity and converts it into an RF signal which can be read by an observer or by an instrument (e.g., target network devices 12, 14, 16, 20, 22, 24, 26, 31, 33, 35, 37, 98-104, server network devices 20, 22, 24, 26, etc.).

“Machine to machine (M2M)” refers to technologies that allow both wireless and wired systems to communicate with other devices of the same ability. M2M uses a device to capture an event (such as option purchase, etc.), which is relayed through a network (wireless, wired cloud, etc.) to an application (software program), that translates the captured event into meaningful information. Such communication was originally accomplished by having a remote network of machines relay information back to a central hub for analysis, which would then be rerouted into a system like a personal computer.

However, modem M2M communication has expanded beyond a one-to-one connection and changed into a system of networks that transmits data many-to-one and many-to-many to plural different types of devices and appliances. The expansion of IP networks across the world has made it far easier for M2M communication to take place and has lessened the amount of power and time necessary for information to be communicated between machines.

However, the present invention is not limited to such wireless interfaces and wireless networks and more, fewer and/or other wireless interfaces can be used to practice the invention.

### Wired Interfaces

In one embodiment of the present invention, the wired interfaces include wired interfaces and corresponding networking protocols for wired connections to the Public Switched Telephone Network (PSTN) and/or a cable television network (CATV) and/or satellite television networks (SATV) and/or three-dimensional television (3DTV), including HDTV that connect the network devices 12, 14, 16, 31, 33, 35, 37, 106-112 via one or more twisted pairs of copper wires, digital subscriber lines (e.g. DSL, ADSL, VDSL, etc.) coaxial cable, fiber optic cable, other connection media or other connection interfaces. the PSTN is any public switched telephone network provided by AT&T, GTE, Sprint, MCI, SBC, Verizon and others. the CATV is any cable television network provided by the Comcast, Time Warner, etc. However, the present invention is not limited to such wired interfaces and more, fewer and/or other wired interfaces can be used to practice the invention.

### Television Services

In one embodiment, the cloud applications 30, 30a, 30b, 30c, 30d, 30e, 30f provide cloud SaaS 64 services and/or non-cloud application services from television services over the cloud communications network 18 or application services over the non-cloud communications network 18′. the television services include digital television services, including, but not limited to, cable television, satellite television, high-definition television, three-dimensional, televisions and other types of network devices.

However, the present invention is not limited to such television services and more, fewer and/or other television services can be used to practice the invention.

### Internet Television Services

In one embodiment, the cloud applications 30, 30a, 30b, 30c, 30d, 30e, 30f provide cloud SaaS 64 services and/or non-cloud application services from Internet television services over the cloud communications network 18 or non-cloud communications network 18′ the television services include Internet television, Web-TV, and/or Internet Protocol Television (IPtv) and/or other broadcast television services.

“Internet television” allows users to choose a program or the television show they want to watch from an archive of programs or from a channel directory. The two forms of viewing Internet television are streaming content directly to a media player or simply downloading a program to a viewer's set-top box, game console, computer, or other network device.

“Web-TV” delivers digital content via broadband and mobile networks. the digital content is streamed to a viewer's set-top box, game console, computer, or other network device.

“Internet Protocol television (IPtv)” is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television formats.

However, the present invention is not limited to such Internet Television services and more, fewer and/or other Internet Television services can be used to practice the invention.

### General Search Engine Services

In one embodiment, the cloud applications 30, 30a, 30b, 30c, 30d, 30e, 30f provide cloud SaaS 64 services and/or non-cloud application services from general search engine services. A search engine is designed to search for information on a cloud communications network 18 or non-cloud communications network 18′ such as the Internet including World Wide Web servers, HTTP, FTP servers etc. The search results are generally presented in a list of electronic results. The information may consist of web pages, images, electronic information, multimedia information, and other types of files. Some search engines also mine data available in databases or open directories. Unlike web directories, which are maintained by human editors, search engines typically operate algorithmically and/or are a mixture of algorithmic and human input.

In one embodiment, the cloud applications 30, 30a, 30b, 30c, 30d, 30e, 30f provide cloud SaaS 64 services and/or non-cloud application services from general search engine services. In another embodiment, the cloud applications 30, 30a, 30b, 30c, 30d, 30e, 30f provide general search engine services by interacting with one or more other public search engines (e.g., GOOGLE, BING, YAHOO, etc.) and/or private search engine services.

In another embodiment, the cloud applications 30, 30a, 30b, 30c, 30d, 30e, 30f provide cloud SaaS 64 services and/or non-cloud application services from specialized search engine services, such as vertical search engine services by interacting with one or more other public vertical search engines and/or private search engine services.

However, the present invention is not limited to such general and/or vertical search engine services and more, fewer and/or other general search engine services can be used to practice the invention.

### Social Networking Services

In one embodiment, the cloud applications 30, 30a, 30b, 30c, 30d, 30e, 30f provide cloud SaaS 64 services and/or non-cloud application services from one more social networking services including to/from one or more social networking web-sites (e.g., FACEBOOK, YOUTUBE, TWITTER/X, INSTAGRAM, etc.). the social networking web-sites also include, but are not limited to, social couponing sites, dating web-sites, blogs, RSS feeds, and other types of information web-sites in which messages can be left or posted for a variety of social activities.

However, the present invention is not limited to the social networking services described and other public and private social networking services can also be used to practice the invention.

### Security and Encryption

Network devices 12, 14, 16, 20, 22, 24, 26, 31, 33, 35, 37, 106-112 with wired and/or wireless interfaces of the present invention include one or more of the security and encryptions techniques discussed herein for secure communications on the cloud communications network 18 or non-cloud communications network 18′.

Application programs 58 (FIG. 2) include security and/or encryption application programs integral to and/or separate from the applications 30, 30a, 30b, 30c, 30d. Security and/or encryption programs may also exist in hardware components on the network devices (12, 14, 16, 20, 22, 24, 26, 31, 33, 35, 37, 106-112) described herein and/or exist in a combination of hardware, software and/or firmware.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

RC4 is cipher designed by RSA Data Security, Inc. of Bedford, Massachusetts, which can accept encryption keys of arbitrary length, and is essentially a pseudo random number generator with an output of the generator being XORed with a data stream to produce encrypted data.

WEP is used at the two lowest layers of the OSI model, the physical layer and the data link layer, therefore, it does not offer end-to-end security. WEP also uses encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). the IEEE 802.11i draft standard, version 4, completed Jun. 6, 2003, is incorporated herein by reference.

The 802.11i standard is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES).

DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information, the NIST FIPS-197 standard (AES FIPS PUB 197, November 2001) is incorporated herein by reference.

The NIST approved a FIPS for U.S. Federal Government requirements for information technology products for sensitive but unclassified (SBU) communications, the NIST FIPS Security Requirements for Cryptographic Modules (FIPS PUB 140-2, May 2001) is incorporated herein by reference.

RSA is a public key encryption system which can be used both for encrypting messages and making digital signatures. the letters RSA stand for the names of the inventors: Rivest, Shamir and Adleman. For more information on RSA, see U.S. Pat. No. 4,405,829, now expired and incorporated herein by reference.

“Hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” the message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. the MD5 algorithm is intended for digital signature applications, where a large file must be “compressed” in a secure manner before being encrypted with a private (secret) key under a public-key cryptosystem such as RSA. the IETF RFC-1321, entitled “The MD5 Message-Digest Algorithm” is incorporated here by reference.

Providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. the cryptographic strength of HMAC depends on the properties of the underlying hash function. the IETF RFC-2101, entitled “HMAC: Keyed-Hashing for Message Authentication” is incorporated here by reference.

An Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. the Electronic Code Book has the ability to support a separate encryption key for each block type.

Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. the IETF RFC-2631, entitled “Diffie-Hellman Key Agreement Method” is incorporated here by reference.

Perceptual hashing is a method for creating a short digital fingerprint of digital media usually an image, video frame, video clip and/or audio clip, etc. based on how it appears or is perceived, rather than its exact file data. Unlike a cryptographic hash such as SHA-512, perceptual hashes are designed so that visually similar files produce similar hash values.

Perceptual hashes are often compared using Hamming distance, which counts how many bits differ between two hashes. A small Hamming distance means the media items are probably similar. Typical uses include duplicate image detection, copyright monitoring, content moderation, malware-image clustering, and finding altered versions of the same picture.

A Hamming distance is a measure of how many positions differ between two strings of equal length. It is commonly used with binary data, error-correcting codes, and perceptual hashes. In perceptual hashing systems, the Hamming distance is often the primary metric used to determine how visually similar two images are.

For example, aHash, an average perceptual hash, compares pixels to the image's average brightness, dHash, a difference perceptual hash looks at brightness differences between neighboring pixels; pHash, a general perceptual hash uses frequency analysis, often with a discrete cosine transform, to capture the image's visual structure; and wHash, a wavelet perceptual hash uses wavelet transforms to compare broader visual features.

The HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

The SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. the security methods are negotiated between the source and destination at the start of establishing a protocol session. the SSL 2.0 protocol specification, by Kipp E. B. Hickman, 1995 is incorporated herein by reference.

Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, California is supplier of networking hardware and software, including router and security products.

However, the present invention is not limited to such security and encryption methods described herein and more, fewer and/or other types of security and encryption methods can be used to practice the invention. the security and encryption methods described herein can also be used in various combinations and/or in different layers of the protocol stack 38 with each other.

### Cloud Computing Networks

FIG. 4 is a block diagram 60 illustrating an exemplary cloud computing network 18. the cloud computing network 18 is also referred to as a “cloud communications network” 18. However, the present invention is not limited to this cloud computing model and other cloud computing models can also be used to practice the invention. the exemplary cloud communications network includes both wired and/or wireless components of public and private networks.

In one embodiment, the cloud computing network 18 includes a cloud communications network 18 comprising plural different cloud component networks 72, 74, 76, 78. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

This exemplary cloud computing model for electronic information retrieval promotes availability for shared resources and comprises: (1) cloud computing essential characteristics; (2) cloud computing service models; and (3) cloud computing deployment models. However, the present invention is not limited to this cloud computing model and other cloud computing models can also be used to practice the invention.

Exemplary cloud computing essential characteristics appear in Table 2. However, the present invention is not limited to these essential characteristics and more, fewer or other characteristics can also be used to practice the invention.

```
TABLE 2
1. On-demand identification, verification and/or location information
  services. Automatic identification, verification and/or location
  information services can unilaterally provision computing capabilities,
  such as server time and network storage, as needed automatically
  without requiring human interaction with each network server 20, 22,
  24, 26 on the cloud communications network 18.
2. Broadband network access. Automatic identification, verification and/or
  location information services capabilities are available over plural
  broadband communications networks and accessed through standard
  mechanisms that promote use by heterogeneous thin or thick client
  platforms (e.g., network devices, 12, 14, 16, 31, 33, 35, 37, 106-112,
  etc.). The broadband network access includes high speed network
  access such as 3G, 4G and 5G wireless and/or wired and broadband
  and/or ultra-broad band (e.g., WiMAX, etc.) network access.
3. Resource pooling. Automatic identification, verification and/or location
  information services resources are pooled to serve multiple requesters
  using a multi-tenant model, with different physical and virtual resources
  dynamically assigned and reassigned according to demand. There is
  location independence in that a requester of services has no control and/
  or knowledge over the exact location of the provided by the
  identification, verification and/or location information service resources
  but may be able to specify location at a higher level of abstraction (e.g.,
  country, state, or data center). Examples of pooled resources include
  storage, processing, memory, network bandwidth, virtual server
  network device and virtual target network devices.
4. Rapid elasticity. Capabilities can be rapidly and elastically provisioned,
  in some cases automatically, to quickly scale out and rapidly released to
  quickly scale for identification, verification and/or location information
  service collaboration. For automatic identification, verification and/or
  location information services, multi-media collaboration converters, the
  automatic identification, verification and/or location information
  services, collaboration and analytic conversion capabilities available for
  provisioning appear to be unlimited and can be used in any quantity at
  any time.
5. Measured Services. Cloud computing systems automatically control and
  optimize resource use by leveraging a metering capability at some level
  of abstraction appropriate to the type of automatic identification,
  verification and/or location information services (e.g., storage,
  processing, bandwidth, custom electronic content retrieval applications,
  etc.). Electronic Automatic RCS interoperability services collaboration
  conversion usage is monitored, controlled, and reported providing
  transparency for both the automatic RCS interoperability services
  provider and the automatic identification, verification and/or location
  information service requester of the utilized electronic content storage
  retrieval service.
```

Exemplary cloud computing service models illustrated in FIG. 4 appear in Table 3. However, the present invention is not limited to these service models and more, fewer or other service models can also be used to practice the invention.

```
TABLE 3
1. Cloud Computing Software Applications 62 for identification,
  verification and/or location information services (CCSA, SaaS 64).
  The capability to use the provider's applications 30, 30a, 30b,
  30c, 30d, 30e, 30f running on a cloud infrastructure 66. The cloud
  computing applications 62, are accessible from the server network
  device 20, 22, 24, 26 from various client devices 12, 14, 16, 31,
  33, 35, 37, 106-112 through a thin client interface such as a web
  browser, etc. The user does not manage or control the underlying
  cloud infrastructure 66 including network, servers, operating
  systems, storage, or even individual application 30, 30a, 30b,
  30c, 30d, 30e, 30f capabilities, with the possible exception of
  limited user-specific application configuration settings.
2. Cloud Computing Infrastructure 66 for identification, verification and/or
  location information services (CCI 68). The capability provided to the
  user is to provision processing, storage and retrieval, networks 18, 72,
  74, 76, 78 and other fundamental computing resources where the
  consumer is able to deploy and run arbitrary software, which can
  include operating systems and applications 30, 30a, 30b, 30c, 30d, 30e,
  30f. The user does not manage or control the underlying cloud
  infrastructure 66 but has control over operating systems, storage,
  deployed applications, and possibly limited control of select networking
  components (e.g., host firewalls, etc.).
3. Cloud Computing Platform 70 for identification, verification and/or
  location information services (CCP 71). The capability provided to the
  user to deploy onto the cloud infrastructure 66 created or acquired
  applications created using programming languages and tools supported
  servers 20, 22, 24, 26, etc. The user not manage or control the
  underlying cloud infrastructure 66 including network, servers, operating
  systems, or storage, but has control over the deployed applications 30a,
  30b, 30c, 30d, 30e, 30f and possibly application hosting environment
  configurations.
```

Exemplary cloud computing deployment models appear in Table 4. However, the present invention is not limited to these deployment models and more, fewer or other deployment models can also be used to practice the invention.

```
TABLE 4
1. Private cloud network 72. The cloud network infrastructure is operated
  solely for identification, verification and/or location information
  services. It may be managed by the electronic content retrieval or a third
  party and may exist on premise or off premise.
2. Community cloud network 74. The cloud network infrastructure is
  shared by several different organizations and supports a specific
  electronic content storage and retrieval community that has shared
  concerns (e.g., mission, security requirements, policy, compliance
  considerations, etc.). It may be managed by the different organizations
  or a third party and may exist on premise or off premise.
3. Public cloud network 76. The cloud network infrastructure such as the
  Internet, PSTN, SATV, CATV, Internet TV, etc. is made available to
  the general public or a large industry group and is owned by one or
  more organizations selling cloud services.
4. Hybrid cloud network 78. The cloud network infrastructure 66 is a
  composition of two and/or more cloud networks 18 (e.g., private 72,
  community 74, and/or public 76, etc.) and/or other types of public
  and/or private networks (e.g., intranets, etc.) that remain unique entities
  but are bound together by standardized or proprietary technology that
  enables data and application portability (e.g., cloud bursting for load-
  balancing between clouds, etc.)
```

Cloud software 64 for electronic content retrieval takes full advantage of the cloud paradigm by being service oriented with a focus on statelessness, low coupling, modularity, and semantic interoperability for electronic content retrieval. However, cloud software services 64 can include various states.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

In one exemplary embodiment, the cloud application 30, 30a, 30b, 30c, 30d, 30e, 30f offers cloud services for identification verification and/or location information of the desired person 41. The application 30, 30a, 30b, 30c, 30d, 30e, 30f offers the cloud computing Infrastructure 66, 68 as a Service 62 (IaaS), including a cloud software infrastructure service 62, the cloud Platform 70, 71 as a Service 62 (PaaS) including a cloud software platform service 62 and/or offers Specific cloud software services as a Service 64 (SaaS) including one or more specific cloud software services 64 for multi-layer identification verification and fraud prevention purchasing system services for purchases 227 requested by a purchaser 39. The IaaS, PaaS and SaaS include one or more of cloud services 62 comprising networking, storage, server network device, virtualization, operating system, middleware, run-time, data and/or application services, or plural combinations thereof, on the cloud communications network 18.

FIG. 5 is a block diagram 80 illustrating an exemplary cloud storage object 82. One or more server network devices (e.g., 20, 22, 24, 26, etc.) store portions 13′, 15′ of the electronic message content 13, 15 (e.g., electronic identification verification and/or location information, etc.) as cloud storage objects 82 (FIG. 5) as is described herein.

The cloud storage object 82 includes an envelope portion 84, with a header portion 86, and a body portion 88. However, the present invention is not limited to such a cloud storage object 82 and other cloud storage objects and other cloud storage objects with more, fewer or other portions can also be used to practice the invention.

The envelope portion 84 uses unique namespace Uniform Resource Identifiers (URIs) and/or Uniform Resource Names (URNs), and/or Uniform Resource Locators (URLs) unique across the cloud communications network 18 to uniquely specify, location and version information and encoding rules used by the cloud storage object 82 across the whole cloud communications network 18. For more information, see IETF RFC-3305, Uniform Resource Identifiers (URIs), URLs, and Uniform Resource Names (URNs), the contents of which are incorporated by reference.

The envelope portion 84 of the cloud storage object 82 is followed by a header portion 86. the header portion 86 includes extended information about the cloud storage objects such as authorization and/or transaction information, etc.

The body portion 88 includes methods 90 (i.e., a sequence of instructions, etc.) for using embedded application-specific data in data elements 92. the body portion 88 typically includes only one portion of plural portions of application-specific data 92 and independent data 94 so the cloud storage object 82 can provide distributed, redundant fault tolerant, security and privacy features described herein.

Cloud storage objects 82 have proven experimentally to be a highly scalable, available and reliable layer of abstraction that also minimizes the limitations of common file systems. Cloud storage objects 82 also provide low latency and low storage and transmission costs.

Cloud storage objects 82 are comprised of many distributed resources, but function as a single storage object, are highly fault tolerant through redundancy and provide distribution of desired electronic content across public communication networks 76, and one or more private networks 72, community networks 74 and hybrid networks 78 of the cloud communications network 18. Cloud storage objects 82 are also highly durable because of creation of copies of portions of desired electronic content across such networks 72, 74, 76, 78 of the cloud communications network 18. Cloud storage objects 82 includes one or more portions of desired electronic content and can be stored on any of the 72, 74, 76, 78 networks of the cloud communications network 18. Cloud storage objects 82 are transparent to a requester of desired electronic content and are managed by cloud applications 30, 30a, 30b, 30c, 30d, 30e, 30f.

In one embodiment, cloud storage objects 82 are configurable arbitrary objects with a size up to hundreds of terabytes, each accompanied by with a few kilobytes of metadata. Cloud objects are organized into and identified by a unique identifier unique across the whole cloud communications network 18. However, the present invention is not limited to the cloud storage objects described, and more fewer and other types of cloud storage objects can be used to practice the invention.

Cloud storage objects 82 present a single unified namespace or object-space and manages desired electronic content by user or administrator-defined policies storage and retrieval policies. Cloud storage objects includes Representational state transfer (REST), Simple Object Access Protocol (SOAP), Lightweight Directory Access Protocol (LDAP) and/or Application Programming Interface (API) objects and/or other types of cloud storage objects. However, the present invention is not limited to the cloud storage objects described, and more fewer and other types of cloud storage objects can be used to practice the invention.

REST is a protocol specification that characterizes and constrains macro-interactions storage objects of the four components of a cloud communications network 18, namely origin servers, gateways, proxies and clients, without imposing limitations on the individual participants.

SOAP is a protocol specification for exchanging structured information in the implementation of cloud services with storage objects. SOAP has at least three major characteristics: (1) Extensibility (including security/encryption, routing, etc.); (2) Neutrality (SOAP can be used over any transport protocol such as HTTP, SMTP or even TCP, etc.), and (3) Independence (SOAP allows for almost any programming model to be used, etc.)

LDAP is a software protocol for enabling storage and retrieval of electronic content and other resources such as files and devices on the cloud communications network 18. LDAP is a “lightweight” version of Directory Access Protocol (DAP), which is part of X.500, a standard for directory services in a network. LDAP may be used with X.509 security and other security methods for secure storage and retrieval. X.509 is public key digital certificate standard developed as part of the X.500 directory specification. X.509 is used for secure management and distribution of digitally signed certificates across networks.

An API is a particular set of rules and specifications that software programs can follow to communicate with each other. It serves as an interface between different software programs and facilitates their interaction and provides access to automatic identification verification and/or location information of a desired person services in a cloud or non-cloud environment. In one embodiment, the API for RCS interoperability services is available to network devices 12, 14, 16, 20, 22, 24, 26, 31, 33, 35, 37, 98-104 and networks 18, 18′. However, the present invention is not limited to such an embodiment and other embodiments can be used to practice the invention.

### Wearable Devices

Wearable technology” and/or “wearable devices” are clothing and accessories incorporating computer and advanced electronic technologies. Wearable network devices provide several advantages including, but not limited to: (1) Quicker access to notifications. Important and/or summary notifications are sent to alert a user to view the whole message. (2) Heads-up information. Digital eye wear allows users to display relevant information like directions without having to constantly glance down; (3) Always-on Searches. Wearable devices provide always-on, hands-free searches; and (4) Recorded data and feedback. Wearable devices take telemetric data recordings and providing useful feedback for users for exercise, health, fitness, etc. activities.

FIG. 6 is a block diagram with 96 illustrating wearable devices. the wearable devices include one or more processors and include, but are not limited to, wearable digital glasses 98, clothing 100, jewelry 102 (e.g., smart rings, smart earrings, etc.) and/or watches 104. However, the present invention is not limited to such embodiments and more, fewer and other types of wearable devices can also be used to practice the invention.

In one specific embodiment, the application 30, 30a, 30b, 30c, 30d, 30e, 30f interacts with wearable devices 98-104 automatic identification verification and/or location information services for the desired person 41 with the methods described herein. However, the present invention is not limited this embodiment and other embodiments can also be used to practice the invention.

### Artificial Intelligence (AI) and Big Data

“Artificial intelligence” (AI), also known as machine intelligence (MI), is intelligence demonstrated by machines, in contrast to the natural intelligence (NI) displayed by humans and other animals. AI research is defined as the study of “intelligent agents.” Intelligent agents 30c are any software application or hardware device that perceives its environment and takes actions that maximize its chance of successfully achieving its goals. Colloquially, the term “artificial intelligence” is applied when a machine mimics “cognitive” functions that humans associate with human brains, such as learning, problem solving and comparing large number of data points. In one embodiment, the present invention uses one or more AI methods including, but are not limited to, AI knowledge-based methods 57f, 57g, 57h for identification verification and/or location information services for a desired person 41, including but not limited to: providing a plurality of different permissions and at a plurality of different security layers including: (a) a first security layer including authorization for summary only identification verification and location information for a desired person; (b) a plurality of second advanced security layers including: a multi-layer identity verification layer comprising: (1) biometrics layer including: a facial recognition sublayer, eye scan sublayer, and identifying other unique biometric markers sublayer, to verify an identity of a desired person with a pre-determined level of precision, (2) location tracking layer, (3) proximity detection layer, (4) geofencing layer, (5) pattern recognition layer, (6) event recording layer, (7) secure data records layer, (8) data analytics layer (9) electronic chain of custody layer, and (10) law enforcement records layer; However, the present invention is not limited to such an embodiment and more, fewer and/or other AI methods can be used to practice the invention.

In one embodiment, SaaS 64 includes and AI application 30c with the AI methods described herein. In another embodiment, the AI application 30c is a standalone application. However, the present invention is not limited to such an embodiment, and the AI application 30c can be provided in other than the SaaS 64.

“Big Data” refers to the use of predictive analytic methods that extract value from data, and to a particular size of data set. the quantities of data used are very large, at least 100,000 data points and more typically 500,000 to 1 Million+ data points. Analysis of Big Data sets are used to find new correlations and to spot trends. In one embodiment, SaaS 64 includes and Big Data application 30d with the Big Data described herein.

In one embodiment, the AI methods described herein collect data information to create and store (e.g., in cloud storage object 82, etc.) a Big Data that is used to analyze trends find new correlations and to spot trends. However, the present invention is not limited to such an embodiment and the AI methods described herein can be used without Big Data sets.

### Short Message Service (SMS) Messaging

Short Message Service (SMS) is an electronic text messaging service component of phone, Web, or mobile communication systems. It uses standardized communications protocols to allow fixed line or mobile phone devices to exchange short text messages.

SMS messages were defined in 1985 as part of the Global System for Mobile Communications (GSM) series of standards as a means of sending messages of up to 160 characters to and from GSM mobile handsets. Though most SMS messages are mobile-to-mobile text messages, support for the service has expanded to include other mobile technologies as well as satellite and landline networks.

The SMS Internet Engineering Task Force (IETF) Request for Comments (RFC) 5724, ISSN: 2070-1721, 2010, is incorporated herein by reference.

### Direct and Instant Messages

A “direct message” (DM) is a private form of communication between social media users that is only visible to the sender and recipient(s). INSTAGRAM, TWITTER, FACEBOOK and other platforms, allow for direct messages between their users, with varying restrictions by platform.

An “instant message” (IM) is a type of online chat allowing real-time text transmission over the Internet or another computer network. Messages are typically transmitted between two or more parties, when each user inputs text and triggers a transmission to the recipient, who are all connected on a common network.

### Multimedia Messaging Service (MMS)

Multimedia Messaging Service (MMS) is a standard way to send messages that include multimedia content to and from a mobile phone over a cellular network. Users and providers may refer to such a message as a PXT, a picture message, and/or a multimedia message.

The MMS Internet Engineering Task Force (IETF) Request for Comments (RFC) 4355 and 4356, are incorporated herein by reference.

### Rich Communication Suite (RCS)

Rich Communications Suite/Rich Communications System (RCS) is a communication protocol between mobile telephone carriers, between phones and carriers, and between individual devices aiming at replacing SMS messages with a message system that is richer, provides phonebook polling (e.g., for service discovery, etc.), and can transmit in-call multimedia. It is also marketed under the names of Advanced Messaging, Advanced Communications, Chat, joyn, Message+ and SMS+. RCS is also a communication protocol available for device-to-device (D2D) exchanges without using a telecommunications carrier for devices that are in close physical proximity (e.g., between two IoT devices, smart phones, smart phone and electronic tablet, etc.).

One advantage RCS Messaging has over SMS is that RCS enables users to send rich, verified messages including photos, videos and audio messages, group messages, read receipts, indicators to show other users are typing a message, carousel messages, suggested chips, chat bots, barcodes, location integration, calendar integration, dialer integration, and other RCS messaging features. RCS messaging includes person-to-person (P2P), application-to-person (A2P), application-to-application (A2A), application-to-device (A2D) and/or device-to-device (D2D) messaging.

The RCS Interworking Guidelines Version 14.0, 13 Oct. 2017, GSM Association, Rich Communication Suite RCS API Detailed Requirements, version 3.0, Oct. 19, 2017, Rich Communication Suite 8.0 Advanced Communications Services and Client Specification Version 9.0, 16 May 2018, RCS Universal Profile Service Definition Document Version 2.2, 16 May 2018, and Rich Communication Suite Endorsement of OMA CPM 2.2 Conversation Functions Version 9.0, 16 Oct. 2019, are all incorporated herein by reference.

The Rich Communication Suite-Enhanced (RCS-e) includes methods of providing first stage interoperability among Mobile Network Operators (MNOs). RCS-e is a later version of RCS which enables mobile phone end users to use instant messaging (IM), live video sharing and file transfer across any device on any MNO.

The RCS functionality of the present invention includes, but is not limited to, one and two-way, rich, verified, multimedia messages including photos, videos and audio messages, group messages, read receipts, indicators to show other users are typing a message, predefined quick-reply suggestions, rich cards, carousels, action buttons, maps, click-to-call, calendar integration, geo-location, etc. The RCS functionality also includes RCS emulators and/or thin RCS applications that provide full and/or selected features of available RCS functionality. However, the present invention is not limited to such embodiments and other embodiments can be used to practice the invention.

### Identification Verification, Tracking and Location Information Services for a Desired Person or Object

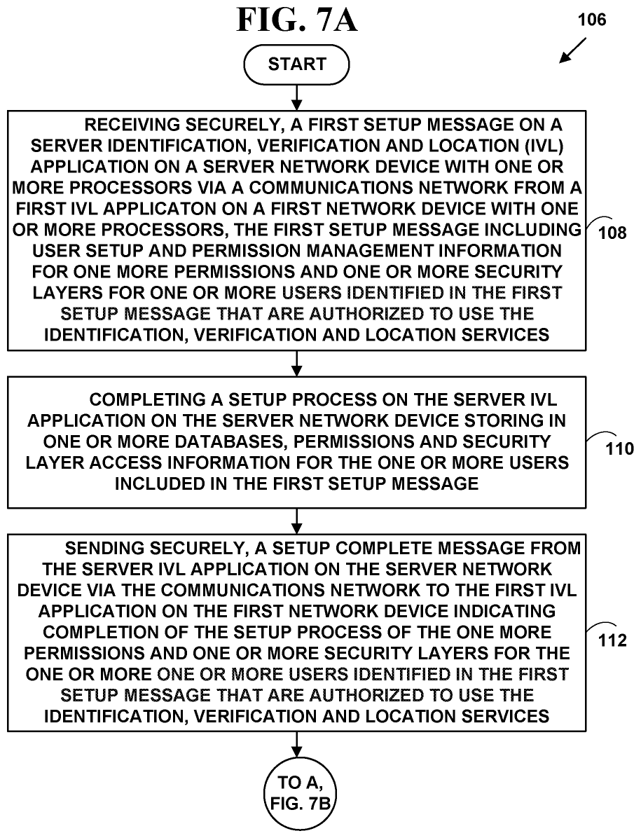

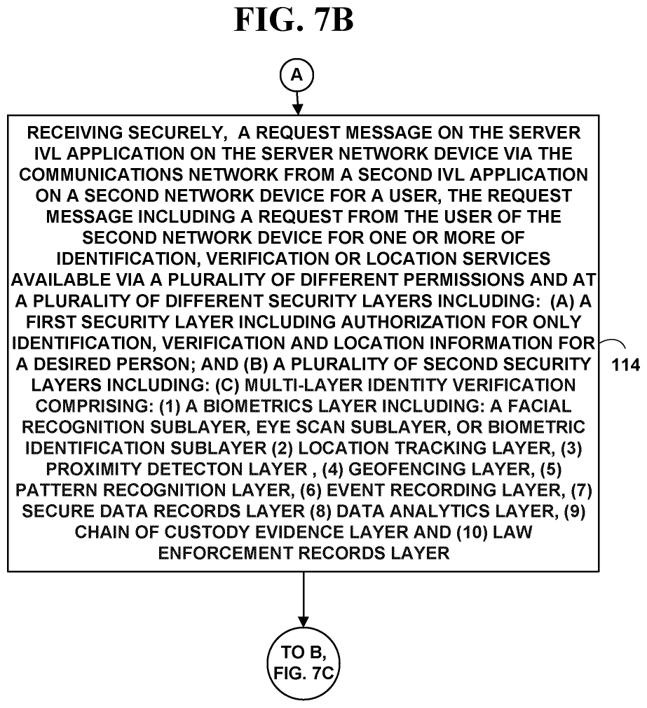

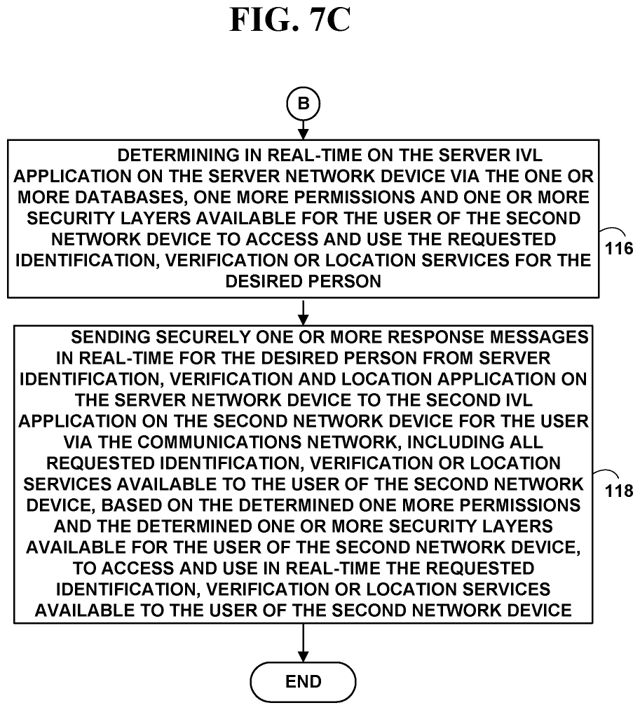

FIGS. 7A, 7B and 7C are a flow diagram illustrating a Method 106 for providing identification verification and location services for a desired person.

In FIG. 7A at Step 108, receiving securely, a first setup message on a server identification verification and location (IVL) application on a server network device with one or more processors via a communications network from a first IVL application on a first network device with one or more processors, the first setup message including user setup and permission management information for one more permissions and one or more security layers for one or more users identified in the first setup message that are authorized to use the identification verification and location services; At Step 110, completing a setup process on the server IVL application on the server network device storing in one or more databases, permissions and security layer access information for the one or more users included in the first setup message; At Step 112, sending securely, a setup complete message from the server IVL application on the server network device via the communications network to the first IVL application on the first network device indicating completion of the setup process of the one more permissions and one or more security layers for the one or more one or more users identified in the first setup message that are authorized to use the identification verification and location services; In FIG. 7B, at Step 114, receiving securely, a request message on the server IVL application on the server network device via the communications network from a second IVL application on a second network device for a user, the request message including a request from the user of the second network device for one or more of identification verification or location services available via a plurality of different permissions and at a plurality of different security layers including: (a) a first security layer including authorization for summary only identification verification and location information for a desired person; (b) a plurality of second advanced security layers including: a multi-layer identity verification layer comprising: (1) a biometrics layer including: a facial recognition sublayer, eye scan sublayer, and identifying other unique biometric markers sublayer, to verify an identity of a desired person with a pre-determined level of precision, (2) location tracking layer, (3) proximity detection layer, (4) geofencing layer, (5) pattern recognition layer, (6) event recording layer, (7) secure data records layer, (8) data analytics layer (9) electronic chain of custody layer, and (10) law enforcement records layer; At Step 116, determining in real-time on the server IVL application on the server network device via the one or more databases, one more permissions and one or more security layers available for the user of the second network device to access and use the requested identification verification or location services for the desired person; and in FIG. 7C at Step 118, sending securely one or more response messages for the desired person in real-time from server IVL application on the server network device to the second IVL application on the second network device for the user via the communications network, including all requested identification verification or location services available to the user of the second network device, based on the determined one more permissions and the determined one or more security layers available for the user of the second network device, to access and use in real-time the requested identification verification or location services available to the user of the second network device for the desired person.

The present invention is illustrated with an exemplary embodiment. However, the present invention is not limited to such an embodiment and other embodiments can be used to practice the invention.

In such an exemplary embodiment in FIG. 7A at Step 108, receiving securely, a first setup message 13s, 15s on a server identification verification and location (IVL) application 30a on a server network device 20, 22, 24, 24 with one or more processors via a communications network 18, 18′ from a first IVL application 30 on the first network device 12, 14, 16, 20, 22, 24, 26, 31, 98-104 with one or more processors, the first setup message including user setup and permission management information for one more permissions and one or more security layers for one or more users 29 identified in the first setup message 13s, 15s that are authorized to use the identification verification and location services.

In one embodiment, the first setup message 13s, 15s is received securely using one or more of the encryption and/or security methods described herein. However, the present invention is not limited to such an embodiment and other encryption and/or security methods can be used to practice the invention.

In one embodiment, the server IVL application 30a an identification verification and location information application 30a, includes a separate identification verification and location information application program interface (API) 30b, an Artificial Intelligence (AI) application 30c and/or other applications 30d, 30e, 30f. In such an embodiment the server IVL application 30a makes calls to the IVL API 30b and AI application 30c to provide the identification verification, tracking and location functionality. In another embodiment, the identification verification and location information application program interface (API) 30b, the Artificial Intelligence (AI) application 30c and/or other applications 30d, 30e, 30f are integral to server IVL application 30a. However, the present invention is not limited to such an embodiment and other embodiments and applications in other configurations can be used to practice the invention.

In one embodiment, the first application 30 on the first network device 12, 14, 16, 20, 22, 24, 26, 31, 98-104 includes IVL application 30 including an identification verification and location information application 30a, identification verification tracking and location information application program interface (API) 30b, an Artificial Intelligence (AI) application 30c and/or other applications 30d, 30e, 30f. However, the present invention is not limited to such an embodiment and more, fewer and/or other applications can be used to practice the invention.

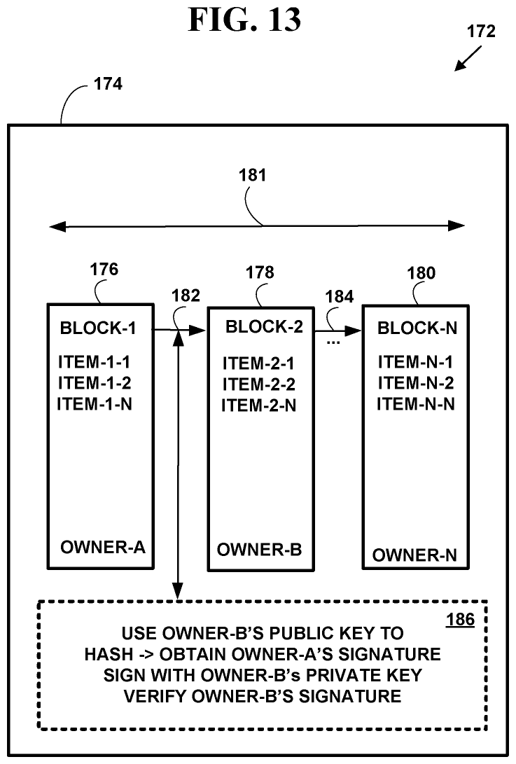

At Step 110, completing a setup process on the server IVL application 30a on the server network device 20, 22, 24, 26 by storing in one or more databases 20′, 22′, 24′, 26′ and/or a block chain 174 (FIG. 13 and Table 6) permissions and security layer access information for the one or more users 29 included in the first setup message 13s, 15s.

In one embodiment, the setup process includes, but is not limited to, user 39 setup and permission management, allowing the server IVL application 30a and/or IVL application 30, to define which individuals are authorized to use the identification verification and location services. The setup process includes setting permissions for access points, actions, and data visibility. However, the present invention is not limited to such an embodiment, and other embodiments with other actions completed in the setup process.

In one embodiment, the setup process includes, but is not limited to, the server IVL application 30a on the server network device 20, 22, 24, 26 setting up one or more user profiles for the one or more users included in the first setup message 13s, 15s in a database 20′, 22′, 24′, 26′ and/or a block chain 174 (FIG. 13). A user profile includes, but is not limited to, a type of user designation (e.g., vendor, employee, manager, law enforcement, military, government, etc.) and a list of a plurality of user permissions. However, the present invention is not limited to such an embodiment and other embodiments with more, fewer and/or other information included in a user profile can be used to practice the invention.

In one embodiment, the server IVL application 30a on the server network device 20, 22, 24, 26 and/or IVL application 30 on the target network device 12, 14, 16, 20, 22, 24, 26, 31, 98-104 provides IVL functionality as one or more SaaS 64 and stores the user setup profile in one or more cloud storage objects 82 in one more cloud storage databases 20′, 22′, 24′, 26′ and/or a block chain 174 (FIG. 13) on a cloud communications network 18. However, the present invention is not limited to such an embodiment and other embodiments without cloud services can be used to practice the invention.

In one embodiment, the server IVL application 30a on the server network device 20, 22, 24, 26 includes the list of the plurality of user permissions in a permission hierarchy, including but not limited to, a data structure comprising a search tree, an array and/or a block chain 174. A search tree is a tree data structure used for locating specific keys within a data set. In order for a tree to function as a search tree, a key for each node must be greater than any keys in subtrees on the left, and less than any keys in subtrees on the right. the advantage of search trees is their efficient search time given the tree is reasonably balanced, which is to say the leaves at either end are of comparable depths. Various search-tree data structures exist, several of which also allow efficient insertion and deletion of elements, which operations then have to maintain tree balance. Search trees are often used to implement an associative array. The search tree algorithm uses the key from the key-value pair to find a location in the tree, and then stores the entire key-value pair at that particular location. However, the present invention is not limited to such an embodiment and hierarchies, data structures and tree data structures can be used to practice the invention.

In one embodiment, the search tree includes a binary search tree data structure. A binary search tree is a node-based data structure where each node contains a key and two subtrees, the left and right. For all nodes, the left subtree's key must be less than the node's key, and the right subtree's key must be greater than the node's key. These subtrees must all qualify as binary search trees. the worst-case time complexity for searching a binary search tree is the height of the tree, which can be as small as Big-O of log₁₀ of n (O(log₁₀(n))) for a binary tree with n elements. Algorithmic complexities are classified according to the type of function appearing in the Big-O notation (e.g., log₁₀(n), etc.). However, the present invention is not limited to such an embodiment and other hierarchies, data structures and tree structures can be used to practice the invention.

In one embodiment, the setup process includes permission management, including, but not limited to, permission management for: (1) Access Points: which identification verification and location service access point a user can enter; (2) Actions: What actions the user is permitted to do with selected identification verification and location services, including: sending data, receiving data, retrieving data, adding data, editing data and/or viewing reports; and (3) Data Visibility: Which data a user can see or not see, so sensitive information is only visible to those who need it and/or are authorized to see it. However, the present invention is not limited to such an embodiment and other embodiments with more, fewer and/or other permissions can be used to practice the invention.

In one embodiment, the setup process includes security layer management, including but not limited to, security layer management with a data structure for: (1) a First Layer of Security—Authorization Features Use: Before users can go further, the server IVL application 30 checks the created user profiles stored in the database 20′, 22′, 24′, 26′ and/or a block chain 174 (FIG. 13) to make sure the users 39 are authorized to use the identification verification and location services. Only authorized users 39 can enter the First Layer of Security—Authorization which provides only identification verification and location information for a desired person 41 (e.g., criminal, terrorist, solider, missing person, professional (e.g., doctor, lawyer, nurse, etc.), student, ride share driver, etc.); and (2) a plurality of Second Layers of Security—Advanced Features Use: Once inside the Second Layers of Security, approved users 39 can access deeper features of the identification verification and location services (e.g., Table 5, etc.), but only if they have permission for each feature. These deeper features are not available to just anyone; they require extra security clearances, making sure only designated users 39 can use them. the security layer management setup helps make sure that only approved users 39 get past the first layer, and only those users 39 with specific permissions can access the more sensitive parts of the identification verification and location services to apply to the desired person 41. This layered security approach keeps everything secure. However, the present invention is not limited to such an embodiment and other embodiments with more, fewer and/or other security layers can be used to practice the invention.

The second advanced security features, include but are not limited to, those illustrated in Table 5. However, the present invention is not limited to such an embodiment and other embodiments with more, fewer and/or other advance security features can be used to practice the invention.

TABLE 5
The second advanced security 128 features, comprising a plurality of different security
layers including, but not limited to:

| | |
|---|---|
| 1. | Multi-layer identity verification layer 129, comprising: a facial recognition |
| | sublayer 130a, eye scan sublayer 130b, or biometric markers identification |
| | sublayer 130c, to verify an identity of a desired person 41 with a pre- |
| | determined level of precision. |
| 2. | Artificial Intelligence (AI) identity verification decision layer 131, for determining and |
| | verifying an identity of a person 41 with biometric data inclduing facial recognition |
| | and other biometric data automatically without human intervention with The AI |
| | identify verification decision layer 131 includes AI models, methods and large |
| | language models (LLMs) for Generative AI 57f and/or predictive AI 57g and/or |
| | Retrieval Augmented Generation (RAG) AI 57h methods and other AI methods and |
| | functions as described in Table 1. |
| 3. | Location tracking layer 132, for tracking physical location of the desired person |
| | 41 including but not limited to The Global Positioning System (GPS), network and/or |
| | other location information. |
| 4. | Proximity detection layer 134, to determine a proximity of the desired person |
| | 41 to other people 41′ or other network devices 12, 14, 16, 20, 22, 24, 26, 31, |
| | 98-104 within a pre-determined range of the desired person and any network |
| | devices (e.g., 12, 14, 16, 20, 22, 24, 26, 31, 98-104) being used by the desired |
| | person 41. |
| 5. | Geofencing layer 136, for creating an electronic geofence around the desired |
| | person 41 and around other devices 12, 14, 16, 20, 22, 24, 26, 31, 98-104. |
| 6. | Pattern recognition layer 138, for determining patterns including current actions |
| | or previously recorded actions and habits of the desired person 41 stored in a |
| | database 20, 22, 24, 26, cloud storage object 82 and/or blockchain 174. |
| 7. | Event recording layer 140, for recording events completed by the desired |
| | person 41 in a database 20, 22, 24, 26, cloud storage object 82 and/or |
| | blockchain 174. |
| 8. | Secure data records layer 142, for creating and storing secure data records for |
| | the desired person 41 in a database 20, 22, 24, 26, cloud storage object 82 |
| | and/or blockchain 174. |
| 9. | Data analytics layer 144, for the desired person 41 including Artificial |
| | Intelligence (AI) methods 30c and non-AI analytic methods for analyzing any |
| | information collected for the desired person 41. |
| 10. | Electronic chain of custody layer 146, for securely collecting and storing |
| | electronic evidence within a chain of custody for the desired person 41 in a |
| | database 20, 22, 24, 26, cloud storage object 82 and/or blockchain 174. |
| 11. | Jurisdictional biometrics and privacy law compliance layer 147, for determining |
| | federal biometric collection laws and privacy laws for the United States and biometric |
| | collection laws and state privacy laws for all states in the United States. |
| 12. | Law enforcement records layer 148, including links for arrests, criminal convictions and |
| | criminal and civil records for the desired person 41. |

In one embodiment, the server IVL application 30a on the server network device 20, 22, 24, stores permissions and security layer access information for the one or more users 29 included in the first setup message 13s, 15s in a block chain 174 (FIG. 13).

In one embodiment, the security layer data structure, includes, but is not limited to a search tree data structure. In one embodiment, the search tree data structure includes a binary search tree data structure. However, the present invention is not limited to such an embodiment and other embodiments with more, fewer and/or other security layer data structures can be used to practice the invention.

At Step 112, sending securely, a setup complete message 13c, 15c from the server IVL application 30a on the server network device 20, 24, 26, 28 via the communications network 18, 18′ to the first IVL application 30 on the first network device 12, 14, 16, 20, 22, 24, 26, 31, 33, 35, 37, 98-104 indicating completion of the setup process of the one more permissions and one or more security layers for the one or more one or more users 29 identified in the first setup message 13s, 15s that are authorized to use the identification verification and location services.

In one embodiment, the setup complete message 13c, 15c is sent securely using one or more of the encryption and/or security methods described herein. However, the present invention is not limited to such an embodiment and other encryption and/or security methods can be used to practice the invention.

In FIG. 7B, at Step 114, receiving securely, a request message 13r, 15r on the server IVL application 30a on the server network device 20, 22, 24, 26 via the communications network 18, 18′ from a second IVL application 30 on a second network device 12, 14, 16, 20, 22, 24, 26, 31, 33, 35, 37, 98-104 for a user 39, the request message 13r, 15r including a request from the user 39 of the second network device 12, 14, 16, 20, 22, 24, 26, 31, 33, 35, 37, 98-104 for one or more of identification verification or location services available via a plurality of different permissions and a plurality of different security layers 122-148 including: (a) a first security layer 124 including authorization for providing summary only identification verification and location information 43, 126 for a desired person; (b) a plurality of second advanced security layers 128-148 including: (c) multi-layer identity verification layer 129 comprising: a biometrics layer 130 including: a facial recognition sublayer 130a, eye scan sublayer 130b, and biometric markers identification sublayer 130c, (2) location tracking layer 132, (3) proximity detection layer 134 (4) geofencing layer 136, (5) pattern recognition layer 138, (6) event recording layer 140, (7) secure data records layer 142, (8) data analytics layer 144, (9) electronic chain of custody layer 146, and (10) law enforcement records layer 148.

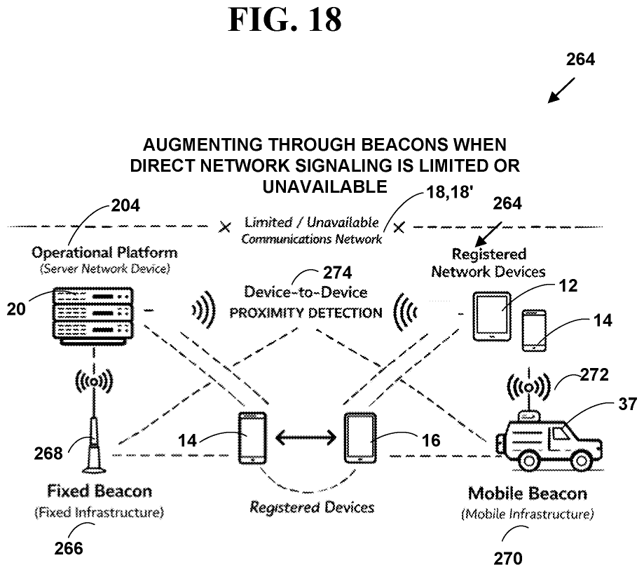

In one embodiment, the first security layer 124 and the plurality of second advanced security layers 128-148 include initialization and monitoring of fixed beacon infrastructures 266 (FIG. 18) with fixed network beacons 268 and mobile beacon infrastructure 270 with mobile beacons 272 on a mobile infrastructure 274 for device-to-device proximity detection 276.

In one embodiment, all message communications between the server IVL application 30a on the server network device 20, 22, 24, 26 and the first IVL application 30 on the first network device 12, 14, 16, 20, 22, 24, 26, 31, 33, 35, 37, 98-104 and the second IVL application 30 on the second network device 12, 14, 16, 20, 22, 24, 26, 31, 33, 35, 37, 98-104 via the communications network 18, 18′ include end-to-end encryption including one or more of the encryption methods described herein. In another embodiment, are completed on secure messaging applications such as WHATSAPP, TELEGRAM, SIGNAL, etc. However, the present invention is not limited to such an embodiment and other embodiments with more, fewer and/or other end-to-end encryption can be used to practice the invention.

In one embodiment, the server IVL application 30a on the server network device 20, 22, 24, 26 and the first IVL application 30 on the first network device 12, 14, 16, 20, 22, 24, 26, 31, 33, 35, 37, 98-104 further include object information in the one or more security layers 122-148 including the first initial security layer 124 allowing access to basic functionality of the identification verification and location services, including summary only identification verification and location information for one or more desired objects 59, and including object information in plurality of second advanced security layers 128-148 including advanced functionality of the identification verification and location services, including the individual security layers 128-148 for accessing the one or more of the plurality of different permissions and at the plurality of different security layers including all available summary identification verification and location information for one or more desired objects 59. However, the present invention is not limited to such an embodiment and other embodiments can be used to practice the invention.

The server IVL application 30a on the server network device 20, 22, 24, 26 creates a continuous feedback cycle that to function as a comprehensive identification, tracking and verification system, adaptable across various, law enforcement, employment, background, goods (e.g., tickets, etc.) and/or services purchases 227 (e.g., medical services, etc.). However, the present invention is not limited to such an embodiment and other embodiments can be used to practice the invention.

The server IVL application 30a on the server network device 20, 22, 24, 26 includes feedback and adaptive learning, including AI neural network training and machine learning to learn and adapt its behavior based on user 39 interactions and IVL requests made for desired persons 39. For example, the server IVL application 30a collects information on car jackings, burglaries, robberies, etc., techniques that are used, time such crimes typically occur, etc. sending alerts to users 39, increasing identity checks of persons 41, flagging potential threats as they happen before a corresponding crime and/or other event may occur. However, the present invention is not limited to such an embodiment and other embodiments can be used to practice the invention.

The server IVL application 30a on the server network device 20, 22, 24, 26 creates and stores contextual triggers for a plurality of different scenarios based on user 39 interactions, requests made for desired persons 41, 41′ and prior and current behaviors of desired persons 41, 41′. For example, an exemplary contextual trigger may include detecting a person is spotted by security camera near an entrance of a building at 2:00 am carry a bag of tools. A facial recognition 130a is triggered and the pattern recognition layer 138 is activated. the contextual trigger may then send alerts to a user 39 who is in charge of security for the building. However, the present invention is not limited to such an embodiment and other embodiments can be used to practice the invention.

The server IVL application 30a on the server network device 20, 22, 24, 26 is in communications with one or more other third-party APIs, databases, other block chains and other systems via the communications network 18, 18′ to expand its IVL functionality. However, the present invention is not limited to such an embodiment and other embodiments can be used to practice the invention.

The server IVL application 30a on the server network device 20, 22, 24, 26 and IVL applications 30 on the network devices 12, 14, 16, 20, 22, 24, 26, 31, 33, 35, 37, 98-104 include a method for conserving device power including battery life on the non-server network devices 12, 14, 16, 31, 33, 35, 37, 98-104, including real-time adaptive scanning intervals, adaptive activation and deactivation, etc. However, the present invention is not limited to such an embodiment and other embodiments can be used to practice the invention.

In one embodiment, one or more of the security layers 122, including the first security layer 124 and the plurality of second advanced security layers 128-148 include a separate encryption key for each layer. However, the present invention is not limited to such an embodiment and other embodiments can be used to practice the invention.

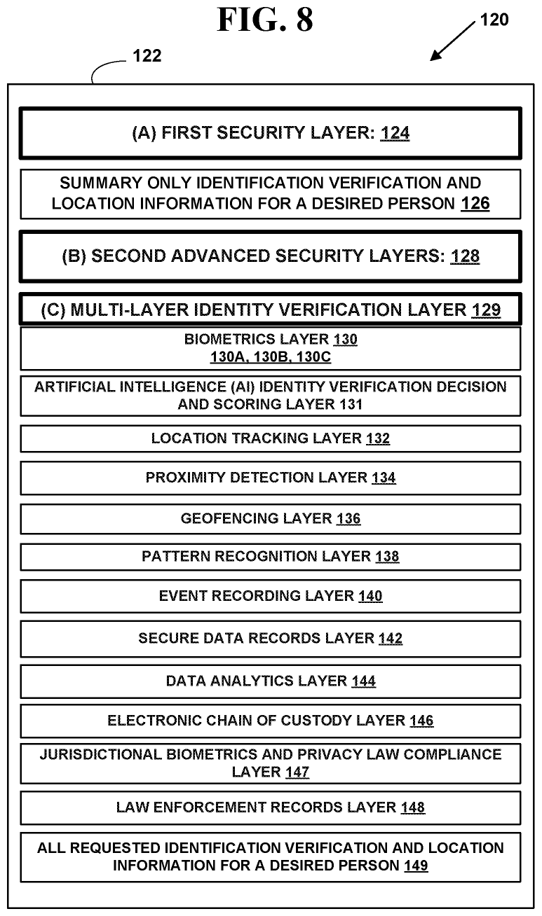

FIG. 8 is a block diagram 120 illustrating a plurality of different security layers 122 available on the server identification verification and location application 30a on the server network device 20, 22, 24, 26.

FIG. 8 illustrates, a first security layer 124 including authorization for providing summary only identification verification and location information 43, 126 for a desired person 41; (b) a plurality of second advanced security layers 128 including: (c) multi-layer identity verification layer 129 comprising: a biometric layer including: a facial recognition sublayer, eye scan sublayer, and identifying other unique biometric markers sublayer, to verify an identity of a desired person with a pre-determined level of precision, (2) location tracking layer 132 (3) proximity detection layer 134, (4) geofencing layer 136, (5) pattern recognition layer 138 (6) event recording layer 140, (7) secure data records layer 142, (8) data analytics layer 144, (9) evidence chain of custody layer 146, and (10) law enforcement records layer 148. Also illustrates all requested identification verification and location information 45, 149 for the desired person 41. However, the present invention is not limited to such an embodiment and other embodiments with more, fewer and/or other security layers can be used to practice the invention.

In one embodiment, the summary identification verification and location information 43, 126 for the desired person 41, includes but is not limited to, name, address, phone number, vehicle and license plate information, email identifiers, social media identifiers, tattoos, digital photograph, location information including real-time current physical location, arrest, conviction, outstanding arrest warrants, outstanding traffic tickets, Be-On-the-LOokout (BOLO) lists, stolen object 59 lists, stolen vehicle 37 lists, dangerous object 59 lists, most wanted lists (e.g., U.S. Marshall, FBI, Interpol, Scotland Yards, etc.) criminal complaint, criminal sentencing, criminal and/or civil judgments, (i.e., for civil legal actions, etc.) and/or other types of law enforcement and/or criminal and/or civil legal information for the desired person 41. However, the present invention is not limited to such an embodiment and other embodiments with more, fewer and/or other summary information items can be used to practice the invention.

In one embodiment, the first and second layers, include, but is not limited to a hierarchy comprising a tree, binary tree and/or an array data structure. An array is a data structure consisting of a collection of elements (e.g., values, variables, cloud services, etc.), of same memory size, each identified by at least one array index or key. An array is stored such that a position of each element can be computed from its index tuple by a mathematical formula. However, the present invention is not limited to such an embodiment and other embodiments with more, fewer and/or other security layer data structures can be used to practice the invention.

Returning to FIG. 7C at Step 114, in one embodiment, the request message 13r, 15r is securely received using one or more of the encryption and/or security methods described herein. However, the present invention is not limited to such an embodiment and other encryption and/or security methods can be used to practice the invention.

The biometric layer 130, includes, but is not limited to, a facial recognition sublayer 130a, eye scan sublayer 130b, and identifying other unique biometric marker sublayer 130c, to verify an identity of a desired person 41 with a pre-determined level of precision (e.g., 80%, 90%, 100%, etc. level of certainty, etc.). However, the present invention is not limited to such embodiments and more, fewer and other sublayers can be used to practice the invention.

The facial recognition sublayer 130a, includes, but is not limited to, technology capable of matching a human face from a digital image or a video frame against a database of faces to confirm an individual's identity. Facial recognition algorithms can be categorized into two main types: feature-based methods and holistic methods. Feature-based facial recognition methods use facial attributes, like jawline, cheek apples, eye sockets, eye focus, mouth shape, lips shape, etc. Using these facial data points, it calculates relative distances between these facial features to build faceprints and uniquely identify individuals. In one embodiment, facial recognition is conducted in real-time using live scanning through front-facing cameras on network devices 12, 14, 16, 20, 22, 24, 26, 31, 33, 35, 37, 98-104. In another embodiment, the feature-based facial recognition is not conducted using live scanning. Holistic face recognition utilizes global information from a large number of different faces to perform face recognition. The global information from faces is fundamentally represented by a small number of features, which are directly derived from pixel information of face images. However, the present invention is not limited to such embodiments and other facial recognition methods can be used to practice the invention.

The eye scan sublayer 130b, includes, but are not limited to, retinal scans, cornea scans and iris scans of a person. A retinal scan is a biometric technique that uses unique patterns on a person's 41 retina blood vessels. An iris scan is an eye vein verification that uses scleral veins in the eye of the person 41. However, the present invention is not limited to such embodiments and other eye scan methods can be used to practice the invention.

The identifying other unique biometric marker sublayer 130c, includes, but are not limited to, collecting, finger prints, DeoxyriboNucleic Acid (DNA), eye color, hear color, tattoos, gait, voice, height, weight, and/or other unique biometric makers. However, the present invention is not limited to these unique biometric markers and more, fewer and/or other biometric markers can be used to practice the invention.

The location tracking layer 132, includes, but is not limited to, context-aware and location tracking services, including GPS or Wi-Fi-based geofencing.

The Global Positioning System (GPS), includes, but is not limited to, GPS data (e.g., time, longitude, latitude, elevation, etc.) about a physical position, movement and time for an object such as the desired person 41, a vehicle 37 the desired person 41 is driving, etc. via GPS satellites. GPS is a space-based radio-navigation system that uses satellites, ground stations, and receivers to calculate an exact physical location of an object such as the desired person 41, a vehicle 37 the desired person 41 is driving, etc. However, the present invention is not limited to such an embodiment and other location tracking components be used to practice the invention.

The server IVL application 30a on the server network device 20, 22, 24, 26 provides via the location tracking layer 132 provides: (1) Location Services: The server IVL application 30a on the server network device 20, 22, 24, 26 uses tools like GPS or Wi-Fi to determine where the desired person 41 is. Boundaries and/or zones are set, including specific streets, buildings and/or rooms; (2) Activating Features by Location: When a desired person 41 enters set boundaries, the server IVL application 30a on the server network device 20, 22, 24, 26 automatically turns on specific advanced security features (e.g., 130, 134, 138, etc.)

For example, if someone is in a secure area, the server IVL application 30a on the server network device 20, 22, 24, 26 activates extra security checks, like the facial recognition sublayer, etc.; and (3) Responding to Events or Security Needs: The server IVL application 30a on the server network device 20, 22, 24, 26 adapts to different security situations based on location of the desired person 41. In an event space, it activates guest check-in features with the multi-layer identification layer 129, the location tracking layer 132 and/or the geofencing layer 136, while in high-security areas, it activates the multi-layer identification layer 129, the location tracking layer 132, the geofencing layer 136 and/or the pattern recognition layer 138, etc.

The AI identify verification decision layer 131, includes but is not limited to, Artificial Intelligence (AI) identity verification decision layer 131, for determining and verifying an identity of a person 41 with biometric data including facial recognition and other biometric data automatically without human intervention. The AI identify verification decision layer 131 includes AI models, methods and large language models (LLMs) for Generative AI 57f and/or predictive AI 57g and/or Retrieval Augmented Generation (RAG) AI 57h.

AI identify verification decision layer 131 includes any software, user interfaces, and accessibility features that enable users to interact with the underlying AI models, methods, LLMs, Big datasets, neural networks and machine learning that power the AI identify verification decision layer 131 with generative AI 57f and/or predictive AI 57g and/or RAG AI 57h.

Generative AI (GenAI, or GAI) 57f is a subset of AI that uses Generative AI models to produce new text, images, videos, and/or other forms of data.

Predictive AI (PredAI or PAI) 57g is also a subset of AI that uses Predictive AI models, machine learning, neural networks and statistical analysis to forecast future events. Machine learning is a field of study in AI concerned with the development and study of statistical algorithms that can learn from data and generalize to unseen data, and thus perform tasks without explicit instructions and/or without human intervention.

Retrieval Augmented Generation AI (RAG or RAG-AI) 57h reduces LLM limitations by grounding AI responses in a defined set of materials (e.g., trusted databases or specific knowledge, e.g., law enforcement, behavior patterns, biometric information, etc.), increasing, accuracy, reducing AI hallucinations, increasing specificity and enabling more current information than the LLM training data alone. An AI RAG method takes the skills of the trained model and tells it to use those skills but limits the library of information to the trusted knowledge base that it is pointed at. RAG-AI also verifies information it provides actually exist and is not an AI hallucination.

An AI hallucination occurs when an AI system generates information that sounds plausible and confident but is actually incorrect, fabricated, misleading, or unsupported by its training data or available evidence. In large language models (LLMs), hallucinations occur because the LLM is fundamentally predicting a most likely next word based on context and association patterns it has learned, rather than retrieving verified facts from a database, a search engine search, etc.

In one embodiment the AI application 30c and/or the AI identify verification decision layer 131, includes but is not limited to, a Generative AI component 57f and/or a Predictive AI component 57g and/or RAG AI component 57h. In one embodiment, the Generative AI 57f component and the Predictive AI component 57h are standalone components of the AI application 30c. In another embodiment, the Generative AI component 57f and/or the Predictive AI component 57f and/or RAG AI component 57h are included as layers in the AI identify verification decision layer 131. However, the present invention is not limited to such embodiments and other embodiments and/or other combinations can be used to practice the invention.

The location tracking layer 132 includes but is not limited to, providing a current physical location of a desired person 41 and helping to determine, define and/or create geographic boundaries where the server IVL application 30a on the server network device 20, 22, 24, 26 activates other advanced security layers, making the system responsive to a desired person's 41 physical location, on a street, on public transportation (e.g., via card swiping for fee payment cards, etc.), in a vehicle 37 (e.g., via electronic toll payment pass, etc.), in restaurants, in event spaces, such as concerts, sports, etc. in secure and un-secure spots in a building, etc.

The proximity detection layer 134, includes but is not limited to, detecting proximity of a desired person 41 to other people 41′ or other network devices 12, 14, 16, 20, 22, 24, 26, 31, 33, 35, 37, 98-104 within a pre-determined range of the desired person 41 and any network devices 12, 14, 16, 20, 22, 24, 26, 31, 33, 35, 37, 98-104 being used by the desired person 41. the proximity detection layer 134 on the server IVL application 30a on the server network device 20, 22, 24, 26 determines with RFID, BLUETOOH, infrared ultra sound, and/or Wi-Fi signals, if the desired person 41 is within a pre-determined distance (e.g., within 3-5 feet) of other people 41′ so other security layers can be activated (e.g., 130, 132, 138, 140, etc.). For example, when teams of people including the desired person 41 are transporting items (e.g., art, currency, jewels, weapons, guns, etc.) the p detection layer 134 is activated.

Ultra sound, includes but is not limited to, technology that uses high-energy sound waves to determine characteristics of a person.

For example, sending out RFID, BLUETOOH, infrared ultra sound, and/or Wi-Fi signals and when the signals are absorbed by the human body of the desired person, determining a location of that person.

The proximity detection layer 134 on the server IVL application 30a on the server network device 20, 22, 24, 26 detects when people or network devices 12, 14, 16, 20, 22, 24, 26, 31, 33, 35, 37, 98-104 are close enough to start an interaction with the desired person 41 including for teams of people transporting valuable items. the proximately detection layer 134 provides: (1) Proximity Detection: When authorized team members or their network devices are within a predetermined range (e.g., three to five feet) of the desired person 41, the proximity detection layer 134 recognizes they are close enough to interact. This recognition also includes using the multi-layer identity layer verification layer 129 and one or more of its sublayers; (2) Identification and Verification: Once team members are within range, the proximity detection layer 134 quickly identifies and verifies each person's identity to ensure they're authorized to handle or transport the valuable items; (3) Enhanced Security for Transport: For teams moving valuable items, this proximity detection ensures that only the right people interacting with the desired person 41 are involved, adding an additional layer of security. If an unauthorized person tries to get close to the desired person, the proximity detection layer 134 on the server IVL application 30a on the server network device 20, 22, 24, 26 takes preventive actions such as alerting the team and/or temporarily locking down access to a vehicle 37, a room in a building, etc.

In one embodiment, when the proximity detection layer 134 on the server IVL application 30a on the server network device 20, 22, 24, 26 detects a person or network device nearby the desired person 41, it checks the person's identity with a biometric scan. For example: (1) Proximity Detection: The proximity detection layer 134 on the server IVL application 30a on the server network device 20, 22, 24, 26 first confirms that a person 41 or network device is within the pre-determined distance; (2) Biometric Verification: Once the proximity detection layer 134 on the server IVL application 30a on the server network device 20, 22, 24, 26 determines other people and/or other network devices are nearby the desired person 14, it automatically triggers a more secure identity check with other advanced security layers (e.g., 130, 132, 138, 140, etc.). However, the present invention is not limited to such an embodiment and other embodiments can be used to practice the invention.

The geofencing layer 136, includes but is not limited to, creating a virtual perimeter for a real-world geographic area for a desired person 41 and network devices 12, 14, 16, 20, 22, 24, 26, 31, 98-104. A geofence is dynamically generated (e.g., as in a radius around a point location) or statically matched to a predefined set of boundaries (e.g., such as school zones, neighborhood boundaries, etc.). The use of a geofence is called geofencing, and one example of use involves a location-aware network device the server IVL application 30a on the server network device 20, 22, 24, 26 of a location-based service (LBS) (e.g., GPS, etc.) for the desired person 41 entering or exiting a geofence. Geofencing is based on the observation that desired persons 41 move from one place to another and then stay at that place for a while. This method combines awareness of the desired persons 41 current location with awareness of the user's proximity to locations that may be of interest. This activity triggers an alert as well as messaging to the geofence operator which includes, but is not limited to, the server IVL application 30a on the server network device 20, 22, 24, 26. This alert information, includes a physical location of the network device 12, 14, 16, 20, 22, 24, 26, 31, 33, 35, 37, 98-104, and can also be sent to a mobile telephone 14, an email account, etc.

The pattern recognition layer 138, includes but is not limited to, recognizing patterns of current actions or previously recorded habits of the desired person 41, and includes a method and process of continuously collecting and storing data and identifying patterns in the data and assigning them to a class or category. Patten recognition is used to analyze data in many forms, including images, text, social media, voice, video, biometrics, etc. Pattern data is continuously by the collected by the server IVL application 30a on the server network device 20, 22, 24, 26 and stored in the databases 20′, 22′, 24′, 26′ and/or in a block chain 174 (FIG. 13) on a plurality of persons and/or the desired person 41, to detect patterns, track high-frequency interactions, and identify unusual and/or potentially suspicious behavior.

The server IVL application 30a on the server network device 20, 22, 24, 26 continuously collects pattern data and analyzes patterns of habits, behaviors, actions and interactions between people. Common patterns, habits, actions or interactions that happen frequently are detected. For example, the desired person 41 may buy a cup of coffee every morning at 7:30 am at a same coffee shop. Then anything unusual or potentially suspicious, like the desired person 41 going to a meeting with another person at 7:30 am is detected.

Pattern recognition is performed by both AI and non-AI methods described herein. there are three main types of pattern recognition server IVL application 30a on the server network device 20, 22, 24, 26, dependent on a desired mechanism used for classifying the pattern data input. These three types are: statistical, structural and/or syntactic, and neural network pattern matching.

Statistical pattern recognition (SPR) is a field of data analysis that uses statistics (e.g., mean, medium, mode, etc.) mathematical models and algorithms to identify patterns from large datasets. It can be used for various tasks, such as handwriting or speech recognition, classification of objects in images, and natural language processing.

Structural and or syntactic pattern recognition is a method used to check a value (e.g., percentage value, certainty value, etc.) against a pattern (e.g. a sequence of words, etc.), extracting parts of the value if the pattern matches.

Neural pattern recognition is a technique that uses AI methods described herein and artificial neural networks (ANNs) to recognize patterns in data. ANNs are computational systems that mimic the human brain's neural network architecture, allowing them to learn to recognize patterns in a variety of data types.

However, the present invention is not limited to these embodiments and other types of pattern recognition can be used to practice the invention.

The event recording layer 140, includes but is not limited to, capturing and storing event data points in an event log on the server IVL application 30a on the server network device 20, 22, 24, 26 including a timestamp, location, verified identity, and any associated network device 12, 14, 16, 31, 33, 35, 37, 98-104 identifiers (e.g., network identifier, smart phone identifier, etc.) for a desired person 41. This event log provides a complete record of interactions, offering transparency and auditability. In one embodiment the event data points are stored in a block chain 174 (FIG. 13).

The server IVL application 30a on the server network device 20, 22, 24, 26 detects and logs usual and unusual events. For example, every time an event occurs, like the desired person 41 entering a secure area, the desire person 41, swiping a key card at a regular and/or unusual time on a subway, etc. the server IVL application 30a on the server network device 20, 22, 24, 26 detects the event and creates an event log entry in the database 20′, 22′ 24′, 26′ and/or a block chain 174 (FIG. 13).

The secure data records layer 142, includes, but is not limited to detecting and recording important details in a secure record for each desired event and action, ensuring secure, reliable records that can be reviewed anytime. The server IVL application 30a on the server network device 20, 22, 24, 26 provides secure data records collection and logging and feeds them directly into the analytics layer 144, allowing the server IVL application 30a on the server network device 20, 22, 24, 26 to build a historical record that directly supports behavior tracking and pattern identification as well the event logs over time create a large set of data and are used by AI and non-AI methods described herein to show behavior and trends of the desired person 41 and/or other persons. However, the present invention is not limited to these embodiments and other embodiments may be used to practice the invention.

The data analytics layer 144, includes, includes but is not limited to, providing Artificial Intelligence (AI) 57f, 57g, 57h methods 30c and non-AI analytic methods for analyzing any information collected for the desired person 41, and providing an electronic data analytics notebook application to organize and analyze all the data the server IVL application 30a on the server network device 20, 22, 24, 26 has collected. Insightful data processing, feedback and system optimization is provided in this layer. The server IVL application 30a on the server network device 20, 22, 24, 26 provides automated insights from the data analytics layer providing broader data analysis operations, leading to refined authorization policies, improved security protocols, and/or improved and/or customized user permissions. The collected data is also used by the data analytics layer to detect patterns, track high-frequency interactions, and/or identify unusual and/or potentially suspicious behavior of the desired person 41 and/or other persons. However, the present invention is not limited to these embodiments and other embodiments may be used to practice the invention.

The electronic chain of custody evidence layer 146, includes but is not limited to, creating and recording a chain of custody record of a chronological handling of electronic evidence (e.g., voice, video, electronic text, etc.), from its collection to its presentation in a court of law for the desired person 41. the server IVL application 30a on the server network device 20, 22, 24, 26 securely collects, stores logs and documents, when and where the evidence was collected, how it was collected, and how it was stored, who handled the evidence and how it transferred via the chain of custody layer. the chain of custody evidence layer provides: (1) Evidence validity: helping prove that evidence is valid and authentic, and that it can be directly linked to a defendant in a criminal and/or civil litigation; (2) Evidence integrity: helping maintain the integrity of the evidence, and protects it from contamination or tampering; and (3) Investigation success: helping achieve success of a criminal investigation. However, the present invention is not limited to these embodiments and other embodiments may be used to practice the invention.

Jurisdictional biometrics and privacy law compliance layer 147, includes but is not limited to, one or more compliance tables including United States federal and state biometrics and privacy laws for all states. the one or more compliance tables include federal statutes, federal code of regulations (CFR), state statutes, state rules for biometrics including facial recognition, and privacy.

The law enforcement records layer 148, includes, but is not limited to, arrest, conviction, warrant and/or other criminal and/or civil records for the desired person 41. This law enforcement records layer includes but is not limited to, providing real-time access via the server IVL application 30a on the server network device 20, 22, 24, 26, to municipal, state, federal and/or international, law enforcement, legal including criminal and/or civil databases, court system docketing and documents for pending and/or concluded cases and/or other databases for a user 39. the server IVL application 30a on the server network device 20, 22, 24, 26 provides this real-time access to allow the user 39 to obtain any arrest, conviction, outstanding arrest warrants, outstanding traffic tickets, vehicle 37 and license plate information, be on the lookout (BOLO) lists, stolen object 59 lists, dangerous object 59 lists, stolen vehicle 37 lists, most wanted lists (e.g., U.S. Marshall, FBI, Interpol, Scotland Yards, etc.) criminal complaint, judgment, (i.e., for civil legal actions, etc.) and/or other types of law enforcement and/or criminal and/or civil legal information for the desired person 41. However, the present invention is not limited to these embodiments and other embodiments may be used to practice the invention.

Returning to FIG. 7C at Step 116, determining in real-time on the server IVL application 30a on the server network device 20, 22, 24, 26 via the one or more databases 20′, 22′, 24′ 26 and/or a block chain 174 (FIG. 13), one or more permissions and one or more security layers available for the user 39 of the second network device 12, 14, 16, 20, 22, 24, 26, 31, 33, 35, 37, 98-104 to access and use the requested identification verification or location services for the desired person 41.

In one embodiment, the server IVL application 30a on the server network device 20, 22, 24, 26 determines at Step 116, the one or more permissions and one or more security layers available for the user 39 from one or more cloud storage objects 82 in one more cloud storage databases 20′, 22′, 24′, 26′ and/or a block chain 174 (FIG. 13) on a cloud communications network 18. However, the present invention is not limited to such an embodiment and other embodiments without cloud services can be used to practice the invention.

In one embodiment, the server IVL application 30a on the server network device 20, 22, 24, 26 uses a user profile previously created for the user 39. However, the present invention is not limited to such an embodiment and other embodiments can be used to practice the invention.

At Step 118, sending securely one or more response messages 13rs, 15rs in real-time for the desired person 41 from server IVL application 30a on the server network device 20, 22, 24, 26 for the desired person 41, to the second IVL application 30 on the second network device 12, 14, 16, 20, 22, 24, 26, 31, 33, 35, 37, 98-104 for the user 39 via the communications network 18, 18′, including all requested identification verification and location services information 45, 149 for the desired person 41 available to the user 39 of the second network device 12, 14, 16, 20, 22, 24, 26, 31, 33, 35, 37, 98-104, based on the determined one more permissions and the determined one or more security layers available for the user 39 of the second network device 12, 14, 16, 20, 22, 24, 26, 31, 33, 35, 37, 98-104, to access and use in real-time the requested identification verification or location services available to the user 39 of the second network device 12, 14, 16, 20, 22, 24, 26, 31, 33, 35, 37, 98-104 for the desired person 41.

In one embodiment, the one or more response messages 13rs, 15rs are sent securely using one or more of the encryption and/or security methods described herein. However, the present invention is not limited to such an embodiment and other encryption and/or security methods can be used to practice the invention.

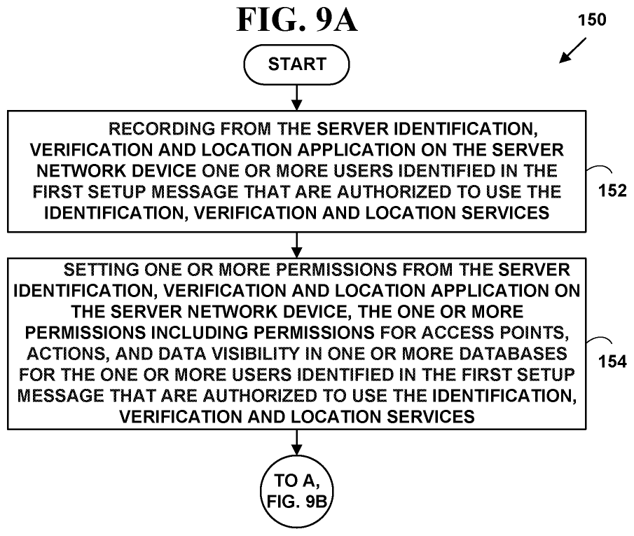

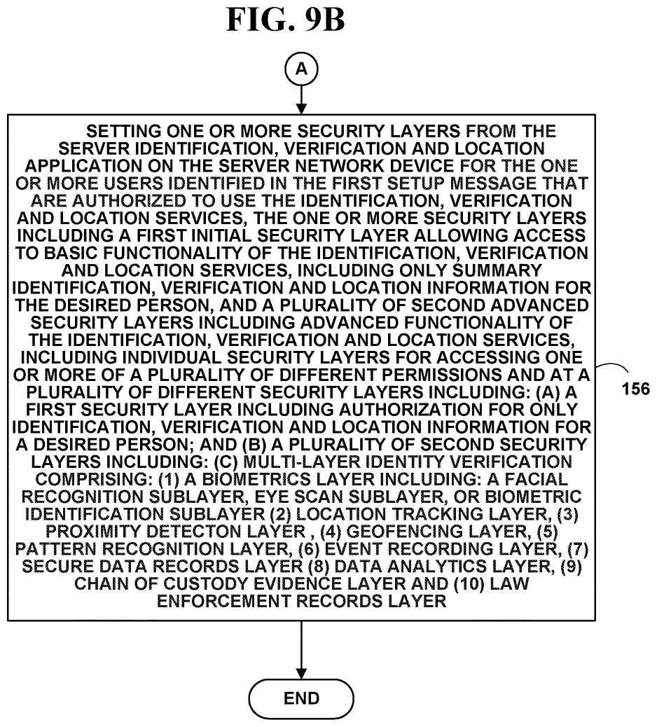

FIGS. 9A and 9B are a flow diagram illustrating a Method 150 for providing identification verification and location services.

In FIG. 9A at Step 152, recording from the server identification verification and location application on the server network device one or more users identified in the first setup message that are authorized to use the identification verification and location services; At Step 154, setting one or more permissions from the server identification verification and location application on the server network device, the one or more permissions including permissions for access points, actions, and data visibility in one or more databases for the one or more users identified in the first setup message that are authorized to use the identification verification and location services; In FIG. 9B, at Step 156, setting one or more security layers from the server identification verification and location application on the server network device for the one or more users identified in the first setup message that are authorized to use the identification verification and location services, the one or more security layers including a first initial security layer allowing access to basic functionality of the identification verification and location services, including summary only identification verification and location information for the desired person, and a plurality of second advanced security layers including advanced functionality of the identification verification and location services, including individual security layers for accessing one or more of a plurality of different permissions and at a plurality of different security layers including: (a) a first security layer including authorization for summary only identification verification and location information for a desired person; (b) a plurality of second security layers including: (1) multi-layer identity verification layer comprising: a facial recognition sublayer, eye scan sublayer, or biometric markers identifier sublayer (2) location tracking layer, (3) proximity layer, (4) geofencing of the desired person, (5) pattern recognition layer, (6) event recording layer, (7) secure data records layer, (8) data analytics layer, (9) electronic chain of custody layer, and (10) law enforcement records layer.

In FIG. 9B at Step 156, setting one or more security layers 122-148 from the server identification verification and location application 30a on the server network device 20, 22, 24, 26 for the one or more users 39 identified in the first setup message 13s, 15s, that are authorized to use the identification verification and location services, the one or more security layers 122-124 including a first initial security layer 124 allowing access to basic functionality of the identification verification and location services, including summary only identification verification and location information 43, 126 for the desired person, and a plurality of second advanced security layers 128-148 including advanced functionality of the identification verification and location services, including individual security layers for accessing one or more of a plurality of different permissions and at a plurality of different security layers including: (a) a first security layer 124 including authorization for summary only identification verification and location information 126 for a desired person 41; (b) a plurality of second security layers plurality of different security layers 122-148 including: (a) a first security layer 124 including authorization for providing summary only identification verification and location information 43, 126 for a desired person; (b) a plurality of second advanced security layers 128-148 including: (1) multi-layer identity verification layer 129 comprising: a biometric layer 130 including: a facial recognition sublayer 130a, eye scan sublayer 130b, and biometric markers identification sublayer 130c, (2) location tracking layer 132, (3) proximity detection layer 134 (4) geofencing layer 136, (5) pattern recognition layer 138, (6) event recording layer 140, (7) secure data records layer 142, (8) data analytics layer 144, (9) electronic chain of custody layer 146, and (10) law enforcement records layer 148.

The present invention is illustrated with an exemplary embodiment. However, the present invention is not limited to such an embodiment and other embodiments can be used to practice the invention.

In such an exemplary embodiment in FIG. 9A at Step 160, recording from the server identification verification and location application 30a on the server network device 20, 22, 24, 26, one or more users 39 identified in the first setup message 13s, 15s that are authorized to use the identification verification and location services.

At Step 154, setting one or more permissions from the server identification verification and location application 30a on the server network device 20, 22, 24 26, the one or more permissions including permissions for access points, actions, and data visibility in one or more databases 20′, 22′, 24′, 26′ and/or a block chain 174 (FIG. 13) for the one or more users 39 identified in the first setup message 13s, 15s that are authorized to use the identification verification and location services.

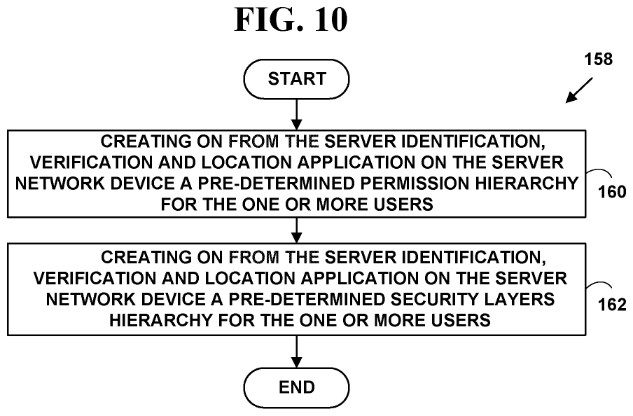

FIG. 10 is a flow diagram illustrating a Method 158 for providing identification verification and location services.

In FIG. 10, at Step 160 creating on from the server identification verification and location application on the server network device a pre-determined permission hierarchy for the one or more users; and at Step 162 creating on from the server identification verification and location application on the server network device a pre-determined security layers hierarchy for the one or more users.

The present invention is illustrated with an exemplary embodiment. However, the present invention is not limited to such an embodiment and other embodiments can be used to practice the invention.

In such an exemplary embodiment in FIG. 10 at Step 160, creating on from the server identification verification and location application 30a on the server network device 20, 22, 24, 26 a pre-determined permission hierarchy for the one or more users 39.

At Step 162, creating on from the server identification verification and location application 30a on the server network device 20, 22, 24, 26 a pre-determined security layers hierarchy for the one or more users 39.

In one embodiment, the pre-determined permission hierarchy and the pre-determined security layers hierarchy, include, but is not limited to a hierarchy comprising a tree, binary tree and/or an array data structure. An array is a data structure consisting of a collection of elements (e.g., values, variables, cloud services, etc.), of same memory size, each identified by at least one array index or key. An array is stored such that a position of each element can be computed from its index tuple by a mathematical formula. However, the present invention is not limited to such an embodiment and other embodiments with more, fewer and/or other security layer data structures can be used to practice the invention.

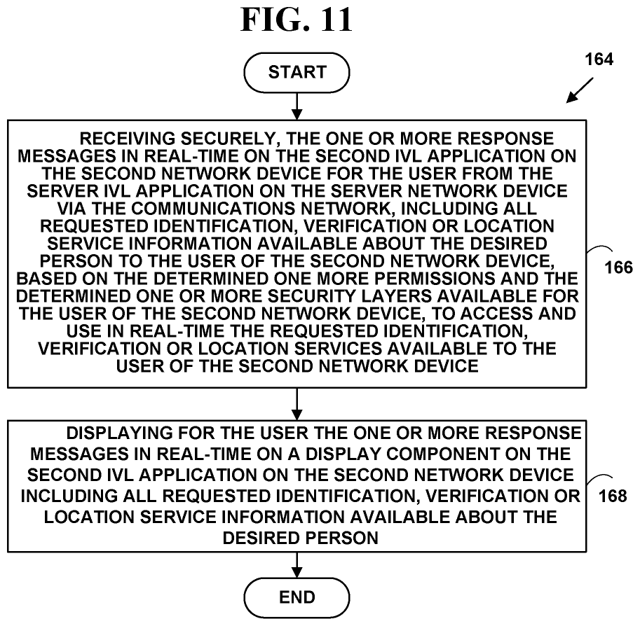

FIG. 11 is a flow diagram illustrating a Method 164 for providing identification verification and location services.

In FIG. 11 at Step 166, receiving securely, the one or more response messages in real-time on the second IVL application on the second network device for the user from the server IVL application on the server network device via the communications network, including all requested identification verification or location service information available about the desired person to the user of the second network device, based on the determined one more permissions and the determined one or more security layers available for the user of the second network device, to access and use in real-time the requested identification verification or location services available to the user of the second network device; and at Step 168, displaying for the user the one or more response messages in real-time on a display component on the second IVL application on the second network device including all requested identification verification or location service information available about the desired person.

The present invention is illustrated with an exemplary embodiment. However, the present invention is not limited to such an embodiment and other embodiments can be used to practice the invention.

In such an exemplary embodiment in FIG. 11 at Step 166, receiving securely, the one or more response messages 13rs, 15rs in real-time on the second IVL application 30 on the second network device 12, 14, 16, 20, 22, 24, 26, 31, 33, 35, 37, 98-104 for the user from the server IVL application 30a on the server network device 20, 22, 24, 26 via the communications network, 18, 18′ including all requested identification verification or location service information 45, 149 available about the desired person 41 to the user 39 of the second network device 12, 14, 16, 20, 22, 24, 26, 31, 33, 35, 37, 98-104, based on the determined one more permissions and the determined one or more security layers 124-148 available for the user of the second network device 12, 14, 16, 20, 22, 24, 26, 31, 33, 35, 37, 98-104, to access and use in real-time the requested identification verification or location services available to the user 39 of the second network device 12, 14, 16, 20, 22, 24, 26, 31, 33, 35, 37, 98-104.

At Step 168, displaying for the user the one or more response messages 13rs, 15rs in real-time on a display component 24 via the second IVL application 30 on the second network device 12, 14, 16, 20, 22, 24, 26, 31, 33, 35, 37, 98-104 including all requested identification verification or location service information 45, 149 available about the desired person 41.

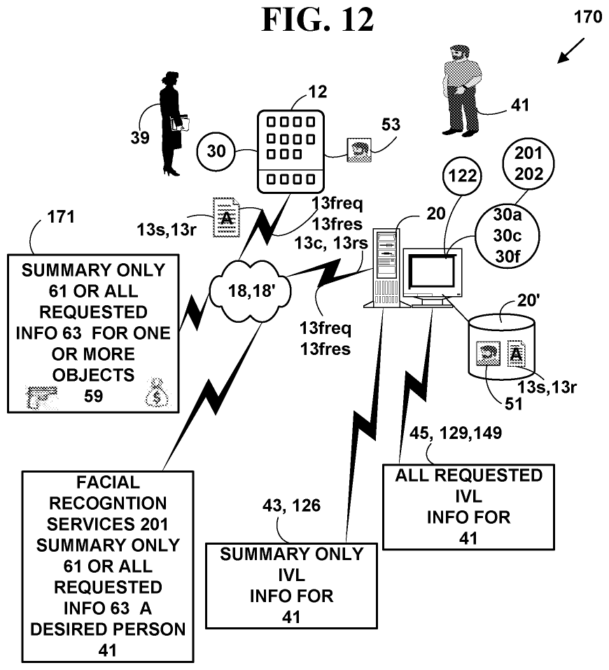

FIG. 12 is a block diagram illustrating a data flow 170 for providing identification verification and location services.

In FIG. 12 a selected user 39 (e.g., law enforcement officer, etc.) is only authorized and/or only requests IVL summary information 43, 126 for a desired person 41 (e.g., a criminal offender, etc.) and/or is authorized and receives all requested IVL information 45, 149 for the desired person. However, the present invention is not limited to such an embodiment and other embodiments can be used to practice the invention.

In one embodiment, Methods 106, 150, 154, 158, 164 further include creating IVL information 171 including authorized information 61 and/or summary IVL information collected 63 for one or more objects 59 (e.g., ticket, valuable object, dangerous object, financial object, e-commerce object, food object, machine object, etc.) instead of a desired person 41. However, the present invention is not limited to such an embodiment and other embodiments can be used to practice the invention.

FIG. 12 also illustrates IVL information 171 including authorized information 61 and summary IVL information collected 63 for the one or more objects 59 (e.g., ticket, valuable object, dangerous object, financial object, e-commerce object, food object, machine object, etc.) However, the present invention is not limited to such an embodiment and other embodiments can be used to practice the invention.

### Block Chains

A “block chain” is a public ledger of all transactions that have ever been executed. It is constantly growing as completed blocks are added to it with a new set of recordings. The blocks are added to the block chain in a linear, chronological order. Block chains are used on P2P networks and other networks such as cloud communications networks. Each P2P node gets a copy of the block chain, which gets downloaded automatically upon joining P2P. The block chain has complete information about the block owners and block content right from the first block to the most recently completed block.

A “block chain is also a digital ledger that records every transaction that has ever occurred. Block chains and transactions on block chains are typically protected by cryptography. More importantly, though, the block chain does not reside in a single server, but across a distributed network of servers and computer such as a cloud computing network and a P2P computing network. Accordingly, whenever new transactions occur, a new block chain is authenticated across this distributed network, then the transaction is included as a new “block” on the “chain.” A block chain implementation comprises of two kinds of records: transactions and blocks.

“Transactions” are the content to be stored in the block chain (e.g., financial transactions, etc.). Transactions are created by participants using the system. In the case of cryptocurrencies, a transaction is created any time a cryptocurrency owner sends cryptocurrency to someone.

A transaction is also a transfer of value between digital wallets that gets included in the block chain. Digital wallets, including the cryptocurrency BITCOIN wallets, store a secret piece of data called a “private key” or, which is used to digitally sign transactions, providing a mathematical proof that the digital signature has actually come from the owner of the digital wallet.

System users create transactions that are passed from node to node on a best-effort basis. The system implementing the block chain defines a valid transaction. In cryptocurrency applications, a valid transaction must be digitally signed, spend one or more unspent outputs of previous transactions, and the sum of transaction outputs must not exceed the sum of inputs.

Blocks record and confirm when and in what sequence transactions enter and are logged in the block chain. Blocks are created by users known as “miners” who use specialized software or equipment designed specifically to create blocks.

In a cryptocurrency system, miners are incentivized to create blocks to collect two types of rewards: a pre-defined per-block award, and fees offered within the transactions themselves, payable to any miner who successfully confirms the transaction.

Block chains are decentralized and do not require a “central authority” or “middleman.” Every node in a decentralized system has a copy of the block chain. This avoids the need to have a centralized database managed by a trusted third party. Block chain transactions are broadcast to a network using software applications. Network nodes can validate transactions, add them to their copy and then broadcast these additions to other nodes. To avoid the need for a trusted third party to timestamp transactions, decentralized block chains use various timestamping schemes, such as proof-of-work.

The core advantages of the block chain architecture include, but are not limited to those described in Table 6.

```
TABLE 6
  The ability for independent nodes to converge on a consensus of the
latest version of a large data set such, as a ledger, even when the nodes are
run anonymously, have poor interconnectivity and have operators who are
dishonest or malicious.
  The ability for any well-connected node to determine, with reasonable
certainty, whether a transaction does or does not exist in the data set.
  The ability for any node that creates a transaction to, after a
confirmation period, determine with a reasonable level of certainty
whether the transaction is valid, able to take place and become final
(i.e., that no conflicting transactions were confirmed into the blockchain
elsewhere that would invalidate the transaction, such as the same
currency units “double-spent” somewhere else).
  A prohibitively high cost to attempt to rewrite or alter transaction
history.
  Automated conflict resolution that ensures that conflicting
transactions (such as two or more attempts to spend the same balance in
different places) never become part of the confirmed data set.
```

A “digital wallet” is a software program where block chains are stored. A digital wallet stores a private encryption key for every block chain address that is saved in the digital wallet of the person who owns the balance. Digital wallets facilitate sending and receiving block chains and gives ownership of the block chain balance, if it includes financial information such as cryptocurrency (e.g., BITCOINS, etc.) to a user.

A digital wallet stored on a communications network, allows a user to use block chains from anywhere, on any browser and/or any mobile network device and/or any smart network device and/or any wearable network device. Storing a digital wallet must be done carefully since it stores private encryption keys for the block chains online.

FIG. 13 is a block diagram 172 illustrating an exemplary block chain 174.

In FIG. 13, the block chain 174 includes plural blocks 176, 178, 180 (only three of which are illustrated) which include one or more items, and plural transactions 182, 184 (only two of which are illustrated). Exemplary transaction 182 includes, for example, includes taking Owner-B's public key 186 for block 176 in block chain 174, running it through a hash algorithm (e.g., SHA-256, etc.) and obtaining Owner-A's digital signature, Owner-B signs the block 176 with its private key and Owner-B's signature is verified on the next block 178, etc. Transaction 184 includes identical steps as was illustrated in transaction 182. However, the present invention is not limited to this embodiment and more, fewer or other exemplary block chain transactions can be used to practice the invention.

In one embodiment, the summary identification verification and location information 43, 126 for the desired person 41 and/or all requested identification verification location services information 45, 149 for the desired person 41 are stored in block chain blocks, 176, 178, 180, in a block chain 174. However, the present invention is not limited to such an embodiment and other embodiments, with and/or without block chains can be used to practice the invention.

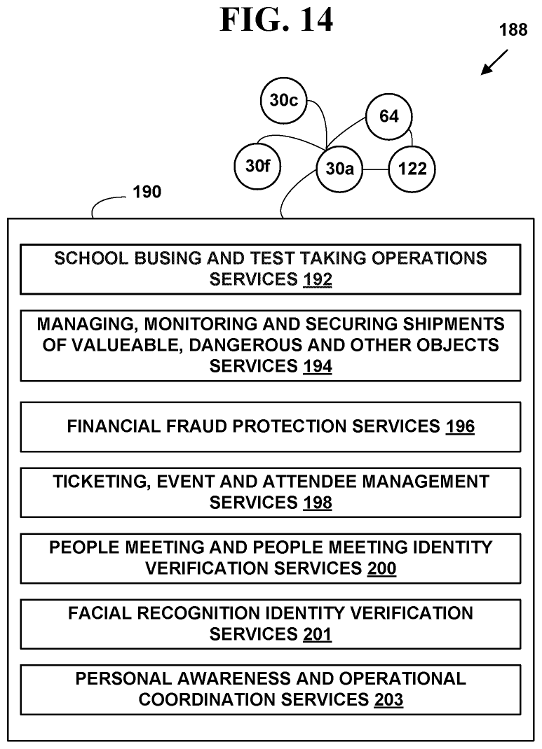

FIG. 14 is a block diagram 188 illustrating plural different services available on the server identification verification and location application on the server network device.

FIG. 14 illustrates the server identification verification and location application 30a on the server network device 20, 22, 24, 26, providing plural real-time services 190 for: (1) school, busing and testing operations 192; (2) identification verification, tracking and location information for valuable and/or dangerous objects 59 and/or other types of objects; (3) financial fraud protection for merchants, financial institutions, law enforcement and consumers 196; (4) ticketing, event and attendee management 198; (5) people meeting and people verification management services 200; (6) facial recognition identify verification services 201 available to verify an identity of desired persons 41 within all services 192-203; (7) personal awareness and operational coordination services 203.

### School, Busing and Test Taking Operation Services 192

The server identification verification and location (IVL) application 30a on the service network device 20, 22, 24, 26 and/or the IVL application 30 on the target network device 12, 14, 16, 31, 33, 35, 37, 106-112 with the plurality of different security layers 122-148 provides real-time services 192 for school, bussing and test taking operations 192. the services 192 include cloud SaaS 64 services and non-cloud services.

The services 192 includes summary identification verification and location information 43, 126 for a desired person 41 and/or all requested identification verification and location services information 45, 149 for the desired person 41 including secure critical school and test-related processes, including child drop-offs and pickups, bus operations, and test-taking activities.

The IVL application 30a/30 uses as facial recognition, block chain, real-time notifications, and data analytics to provide a comprehensive and a user-friendly platform for schools, parents, bus companies, and testing organizations. The server IVL application 30a ensures accountability, security, and efficiency for school, busing and test taking operations.

Some advantages of using the IVL application 30a with the plurality of different security layers 122-148 for school, busing and testing operations services 192 include, but are not limited to those described in Table 7.

```
TABLE 7
1. School Operations:
  Provides facial recognition and GPS tracking of students.
  Manages secure student drop-offs and pickups at school, day care, after care,
  sports practice, music practice, drama practice, sports games, music and drama
  performances, etc.
  Provides real-time notifications to parents, guardians, grandparents and other
  authorized individuals.
  Tracks access points, timestamps, and authorized individuals.
2. Bus Operations:
  Provides facial recognition and GPS tracking for buses and students on buses.
  Logs student pickups and drop-offs with identity verification.
  Notifies parents of bus arrivals, departures, and completed drop-offs.
3. Testing Operations:
  Facilitates test registration, payment, and identity verification for students for
  every day academic testing, college and professional license testing.
  Provides facial recognition and GPS tracking of test takers.
  Allows proctors to securely manage test sessions, attendance, and
  accommodations.
  Provides testing organizations (e.g., Advance Placement, (AP), ACT, SAT,
  LSAT, MCAT, insurance licensing, financial professional licensing, medical
  licensing, medical board certifications, dental licensing, law licensing, certified
  public accountant (CPA), general securities representative exams (GSRE) (e.g.,
  Series 7, etc.) real-estate licensing, etc.) with comprehensive analytics and
  reporting.
4. Parent and Guest Access:
  Provides facial recognition and GPS tracking.
  Parents manage authorized pickup persons, receive notifications, and access
  records.
  Guests use electronic links (e.g., SMS, DM, email, etc.) for secure, temporary
  or permanent pickup authorizations.
5. Continuing Education:
  Facilitates registration, payment, and identity verification for individuals taking
  professional continuing education classes (e.g., law, medical, insurance,
  accounting, etc.).
```

### Managing, Monitoring, Tracking and Securing Shipments of Valuable or Dangerous Object Services 194

The server identification verification and location (IVL) application 30a on the service network device 20, 22, 24, 26 and/or the IVL application 30 on the target network device 12, 14, 16, 31, 33, 35, 37, 106-112 with the plurality of different security layers 122-148 provides real-time services 194 for, summary identification verification, tracking and location information for valuable and/or dangerous objects 59 and other types of objects 59 such as food shipments, machinery, etc. The services 194 include cloud SaaS 64 services and non-cloud services.

The server identification verification and location (IVL) application 30a as AI 30c, block chain 174, and IoT 33 technologies for high-value objects 59 (e.g., physical currencies and cryptocurrencies, stock certificates, bond certificates, gems, such diamonds, rubies, etc., metals such as gold, silver, platinum, etc.) and sensitive shipments (e.g., guns, military arms, ammunitions, munitions, military equipment, radio-active materials, etc.) from e-commerce to government and military operations, ensuring security, tracking, transparency, location verification, delivery verification and operational flexibility.

Some advantages of using the IVL application 30a/30 with the plurality of different security layers 122-148 for providing real-time services 194 for summary identification verification, tracking and location information for valuable and/or dangerous objects 59, include, but are not limited to those described in Table 8.

```
TABLE 8
1. AI 30c Integration for Predictive and Proactive Risk Mitigation
    Dynamic Risk Assessment: Leverages AI 30c to continuously analyze real-time
  and historical data, assigning dynamic risk scores to shipments based on factors
  like
  route conditions, package value, and security features. This allows for proactive
  adjustments to mitigate theft, delays, or tampering risks.
    Route Optimization: AI 30c driven algorithms optimize delivery routes in real
  time,
  accounting for traffic, weather, and security risks to ensure timely and efficient
  shipments.
    Anomaly Detection: AI 30c monitors handler behavior, package movement, and
  geofence compliance to detect unusual activity, triggering alerts and automated
  protective measures when necessary, including for food shipments when listeria
  and/or salmonella outbreaks are detected.
2. Blockchain 174 Security for Immutable Transparency
    Chain-of-Custody Logging: Shipment interaction, from creation to final delivery,
  is immutably logged on the blockchain 174. This ensures a transparent, tamper-
  proof
  record of all events including serial numbers, other identifiers, including handoffs,
  tampering alerts, and manual overrides.
    Dispute Resolution and Accountability: Blockchain 174 logs provide indisputable
  evidence for resolving disputes, verifying chain-of-custody, and maintaining
  regulatory compliance.
    Dedicated Blockchain 174 Architecture: For high-security applications, such as
  government
  or military operations, Customizable, dedicated blockchains 174 to ensure
  data isolation and enhanced security.
3. Payments and Financial Management:
    Processes payments for shipments, including customizable security tiers and
  premium features.
    Tracks payment history, invoices, and outstanding balances.
    Provides revenue analytics to monitor financial performance.
4. Incident Management and Overrides:
    Allows administrators to respond to incidents, such as tampering alerts or
  recipient
  verification failures.
    Offers manual override tools for situations requiring customer support
  intervention.
    Logs all overrides and incident resolutions on the blockchain for transparency.
5. Mapping System:
    Provides an interactive map showing shipment locations, routes, and geofences.
    Displays event markers for incidents like tampering or geofence breaches.
    Allows administrators to modify geofences and optimize delivery routes in real-
  time.
6. Adaptability Across Industries
    Modular Design: The applications 30a modular architecture allows
    shippers, receivers, vendors/partners, and government/military entities, ensuring a
    tailored user experience for each stakeholder.
    Scalability: designed to handle everything from small business shipments
    to enterprise-level logistics, with multi-language support and global integration
    capabilities.
    Cross-Sector Applications: The application 30a supports diverse industries,
    including:
      E-commerce: Secure, trackable deliveries with biometric recipient
      verification.
      Healthcare: Temperature-controlled tracking for sensitive medical shipments.
      Government and Military: Secure logistics with geofencing, encrypted data,
      and
      capabilities for classified operations.
7. Operational Flexibility and Reliability
    Manual Override Systems: Built-in override protocols allow administrators to
    resolve issues like verification failures, geofence breaches, or tampering alerts
    without disrupting shipment progress.
    Offline Mode: Critical shipment data and actions remain accessible during
    connectivity outages, with automatic syncing upon restoration.
    Multi-Modal Tracking: Redundant tracking technologies, including GPS, cellular
    triangulation, and RFID, ensure reliable location monitoring even in challenging
    environments.
8. Advanced Security and Compliance
    Biometric and electronic link verification: Ensures only authorized personnel
  handle to send or receive packages, with logs stored immutably on the blockchain
  174.
    Tamper-Proof Packaging: IoT 33-enabled lockboxes and tamper-evident seals
  provide real-time alerts for potential breaches.
    Regulatory Compliance: The application 30a adheres to global data privacy and
  security standards, such as the European Union (EU) General Data Protection
  Regulation (GDPR) and the United States Health Insurance Portability and
  Accountability Act (HIPAA), making it ideal for handling sensitive
  shipments.
```

### Financial Fraud Protection Services 196

The server identification verification and location (IVL) application 30a on the service network device 20, 22, 24, 26 and/or the IVL application 30 on the target network device 12, 14, 16, 31, 33, 35, 37, 106-112 with the plurality of different security layers 122-148 provides real-time services 196 for financial fraud protection for merchants, financial institutions, securities instructions, law enforcement and consumers. The services 196 include cloud SaaS 64 services and non-cloud services.

Some advantages of using the IVL application 30a/30 with the plurality of different security layers 122-148 for providing real-time services 196 for financial fraud protection include, but are not limited to those described in Table 9.

```
TABLE 9
1. Real-Time Fraud Detection and Prevention for Merchants
  Provides merchants cutting-edge fraud detection tools to protect
  businesses and institutions from losses.
  AI 30cPowered Fraud Scoring:
  Identifies suspicious behavior in real time using machine learning algorithms
  and dynamic risk profiling.
  Transaction Monitoring:
  Alerts merchants immediately about high-risk or flagged transactions.
  Enables instant manual overrides with identity verification tools, including live
  photo capture and ID matching.
  Employee Accountability:
  Tracks employee-related fraud patterns, identifying specific registers or
  individuals with unusually high fraudulent activity.
  Provides analytics for merchants to mitigate internal risks effectively.
2. Financial Institution and Securities Institutions Integration
  Banks, brokers, and credit card issuers benefit from robust fraud prevention
  capabilities.
  Dynamic Safety Features:
  Allows banks to toggle security features (e.g., facial recognition, spending
  limits) for each cardholder based on risk profiles.
  Fraud History Analysis:
  Enables banks to query individuals for prior grand larceny or fraud incidents
  before issuing new credit cards or adjusting credit limits.
  Dispute Management:
  Streamlines chargeback workflows, ensuring swift and accurate resolutions
  between banks, merchants, and consumers.
3. Law Enforcement Dashboard and Collaboration
  Provides law enforcement with a powerful, user-friendly dashboard designed
  to streamline investigations:
  Accusatory Instrument Generation:
  Automatically compiles detailed reports, including purchaser photos,
  transaction details, and fraud likelihood scores, for use in grand larceny cases.
  Geographic Focus Tools:
  Allows officers to analyze flagged transactions in specific areas to identify
  fraud hotspots.
  Cross-Merchant Collaboration:
  Enables law enforcement to connect fraud patterns across multiple merchants
  for broader investigations.
4. Vehicle and Vessel Fraud Prevention
  High-value purchases, such as vehicles 37, trucks, aircraft and boats, are a key
  focus area.
  Dedicated Purchase Tab:
  Tracks VINs, hull identification numbers, and other unique identifiers for
  vehicles and vessels.
  Identity Verification:
  Ensures purchaser legitimacy through real-time ID checks and biometric tools
  like facial recognition.
  Post-Sale Monitoring:
  Tracks high-value items to prevent fraudulent resales and aids in recovering
  stolen property.
5. Consumer Protection
  Prioritizes consumer trust and safety with features tailored for cardholders:
  Real-Time Alerts:
  Notifies users of every transaction, including flagged purchases with photo
  verification.
  User-Friendly Dispute Resolution:
  Allows cardholders to confirm or deny transactions instantly, triggering fraud
  investigations if necessary.
  Educational Tools:
  Provides cardholders with tips and resources for spotting and preventing fraud.
6. Scalable Design for Global Reach
  Built to handle massive transaction volumes, leveraging:
  Cloud-Native and Blockchain 174 architecture:
  Ensures elastic scalability for growing user bases.
  Secondary System:
  Provides operational continuity during blockchain or network downtime.
  International Integration:
  Enables cross-border fraud detection and global database cross-referencing for
  stolen goods.
```

### Ticketing, Event and Attendee Management Services 198

The server identification verification and location (IVL) application 30a on the service network device 20, 22, 24, 26 and/or the IVL application 30 on the target network device 12, 14, 16, 31, 33, 35, 37, 106-112 with the plurality of different security layers 122-148 provides real-time services 198 for ticketing, event and attendee management. The services 198 include cloud SaaS 64 services and non-cloud services.

Some advantages of using the IVL application 30a/30 with the plurality of different security layers 122-148 for providing real-time services 198 for financial fraud protection include, but are not limited to those described in Table 10.

```
TABLE 10
1. Biometric-Based Ticketing:
  Eliminates the need for phones or physical tickets by providing biometric based
  ticketing relying on facial recognition, gait analysis and/or other biometrics
  (e.g., voice, finger prints, iris scanning, retinal scan, vein scan, tattoos, etc.) for
  event access.
2. Geofencing:
  Enables real-time attendee monitoring and dynamic venue management.
3. Wearable 98-102 Safety Devices:
  Provides enhanced safety for children and special needs individuals through
  real-time tracking and notifications via wearable devices 98-102.
4 Advanced Analytics:
  Offers event organizers actionable insights, including demographic
  breakdowns, behavioral patterns, and payment trends.
5. Fraud Prevention Mechanisms:
  Validates ticket authenticity and prevents unauthorized access through
  biometric and geofence-linked systems.
6. Post-Event Tools:
  Features user-generated content sharing and memorabilia integration to enhance
  the attendee experience and drive engagement.
7. Augmented Reality (AR)/Virtual Reality (VR) Navigation:
  Provides AR/VR overlays to guide users in physical venues.
8. Crowd-Aware Navigation:
  Uses live crowd density data to dynamically adjust AR navigation paths,
  optimizing attendee movement and preventing congestion.
  Provides real-time route changing based on foot traffic and predicted movement
  trends.
9. User-Centric Customization:
  Allows attendees to personalize their AR interface, choosing overlays for
  different needs
  (e.g., food stalls, restrooms, family areas, or accessibility paths).
  A customizable AR navigation system tailored to individual attendee
  preferences.
10: AI 30c Powered Wayfinding:
  AI applications 30 c to predict attendee destinations based on behavior (e.g.,
  seat location, event schedule) and proactively display directions.
  An attendee walking toward the food court sees suggested paths with wait times
  and nearby deals.
11. Dynamic Ticket Pricing:
  Uses machine learning to adjust prices based on demand.
12. Predictive Behavioral Pricing:
  Ticket Use a hybrid approach combining historical data and real-time behavior
  (e.g., how long a user views specific tickets) to calculate dynamic pricing.
  Behavioral pricing algorithms that predict willingness to pay based on in-app
  interactions.
13. Sharing and Group Discounts:
  Provides dynamic group pricing where discounts scale based on the size of the
  group and proximity of their seats.
  Adjacent seat bundling discounts for families or friends booking together.
14. Gamified Pricing Models:
  Enable users to participate in time-sensitive games (e.g., “beat the clock”
  discounts or challenges) to secure dynamic pricing offers.
  Gamification of ticket pricing tied to real-time engagement.
15. Integration into a Unified Platform:
  Independent User Profiles Across Events:
  Uses of decentralized user profile system where attendee data is stored locally
  and shared temporarily with venues only for specific events.
  Profiles can be deleted or reset after events, ensuring no long-term storage of
  personal information by venues- if the user wants their data deleted.
  Unified Dashboard with Predictive Analytics:
  Provides venues with a dashboard that predicts attendee behavior across events,
  using anonymized behavioral patterns rather than direct user data.
  Provides predictive attendee analytics based on anonymized cross-event
  behavior.
16. Tokenized Ticketing System:
  Replaces traditional ticketing with a blockchain-based system that creates
  unique, event-specific tokens for each attendee.
  Tokens are transferred securely and can include embedded AR features for
  post-event engagement.
17. Dynamic Event-Specific Smart Contracts
  Self-Updating Tickets: Use blockchain smart contracts to create tickets that
  adapt dynamically:
  Changes access levels (e.g., general admission upgrades to VIP based on
  availability or user engagement).
  Unlocks perks or features (e.g., special discounts for frequent attendees or free
  merchandise).
  Automates refunds if events are canceled, ensuring trust.
18. Non-Fungible Token (NFT) Tickets with Evolving Features
  Each ticket is minted as a unique NFT that evolves:
  After the event, tickets can convert into collectibles with exclusive perks like
  access to event
  photos, videos, or signed memorabilia.
  Embeds gamified elements, such as unlocking rare, tradable NFT items only
  available to attendees.
  Offers limited-edition, themed ticket NFTs for special events to drive
  exclusivity.
19. Provenance and Ownership Tracking
  Showcases the entire history of a ticket:
  Buyers can view the ticket's origin, price changes, and ownership transfers
  directly on the Blockchain 174.
  Transparency builds trust and discourages scalping.
20. Interoperable Ticketing Ecosystem
  Leverage cross-event compatibility:
  Tickets purchased for one event grant access to another partner event or
  discounts,
  creating a unified ecosystem of experiences.
  Tokenized tickets integrate with loyalty programs or enable cross-platform use
  (e.g., in gaming, music, or travel).
21. Anti-Scalping and Secure Resale Markets
  Includes resale control mechanisms:
  Resale prices are governed by smart contracts to cap scalping.
  Blockchain verifies authenticity and ownership of tickets in the secondary
  market, preventing counterfeiting.
  Uses identity-linked NFTs to ensure tickets cannot be sold without proper
  verification, reducing fraud.
22. Decentralized Ticket Wallets
  Instead of centralized storage, attendees store their tickets in decentralized
  wallets:
  This ensures attendees own their tickets outright, increasing trust and user
  autonomy.
  Enables seamless ticket management across multiple devices and platforms.
23. Blockchain Analytics and Audience Insights
  Uses blockchains 174 to provide transparent, anonymized data to event
  organizers:
  Views attendance patterns, resale trends, and engagement metrics on-chain.
  Offers event-specific tokens or badges based on user behavior (e.g., frequent
  attendee rewards).
23. Revenue Sharing via Tokenomics
  Provides revenue-sharing models:
  A portion of ticket sales is redistributed to artists, event staff, or even loyal
  attendees using blockchain 174 tokens.
  Implements royalty features so creators or organizers receive a percentage of
  resale profits on
  the blockchain 174.
24. Token-Gated Experiences
  Uses blockchain to create exclusive, token-gated experiences:
  Only attendees with a specific NFT ticket can access certain event features,
  AR/Virtual Reality (VR).
  experiences, or post-event content.
  Allows NFT holders to vote on event-related decisions, creating a decentralized
  fan-driven event.
25. Blockchain for Reputation and Trust
  Establishes a reputation system for attendees:
  Tracks attendance history and engagement using blockchain tokens.
  Rewards frequent attendance with priority access to future events or discounted
  tickets.
  Builds trust with event partners by providing an immutable ledger of ticket
  sales, revenue splits, and attendance data.
26. Sustainable and Transparent Ticketing
  Uses eco-friendly blockchains to reduce the carbon footprint of ticketing.
  Includes detailed, blockchain-verified reporting of sustainability initiatives tied
  to the event (e.g.,
  funds donated to green causes).
27. Universal Blockchain 174 Integration
  Integrates with multiple blockchain 174 networks:
  Allow attendees to choose their preferred blockchain for ticket storage.
```

### People Identification and People Identity Verification Management Services 200

The server identification verification and location (IVL) application 30a on the service network device 20, 22, 24, 26 and/or the IVL application 30 on the target network device 12, 14, 16, 31, 33, 35, 37, 106-112 with the plurality of different security layers 122-149 provides real-time services 200 for people meeting and people meeting identity verification services 200. The services 200 include cloud SaaS 64 services and non-cloud services.

The services 200 include people meeting identity verification services for identifying and verifying identifies of people at schools, day-care, dating sites, employment interviews, professional meetings, networking events, professional appointments (e.g., medical, legal, real-estate, accounting, etc.) goods pick-up and drop-off, goods transport, taxi drivers, baby sitters, contractors, repair people, rideshare drivers, rideshare vehicles, curriers, messengers, concerts, sporting events, movies, community events, banks, hospitals, medical clinics, urgent care clinics, automated teller machines (ATM), doorbell cameras, security cameras, trail cameras, traffic cameras, airport security screening, etc.

Some advantages of using the IVL application 30a/30 with the plurality of different security layers 122-149 for providing real-time services 200 for people meeting and people identity verification include, but are not limited to those described in Table 11.

```
TABLE 11
1. Automatic Biometric Recognition and Identify verification:
  Automatic real-time facial recognition, voice, finger prints, iris scanning,
  retinal scan, vein scanning, gait analysis, tattoos, etc. to verify an identity of a
  desired person 41 with a pre-determined level of precision.
2. Automated Identity Verification for On-Line Meetings:
  Automatic real-time facial recognition, voice, finger prints, iris scanning,
  retinal scan, vein scanning, gait analysis, tattoos, etc.to verify an identity of a
  desired person 41 with a pre-determined level of precision for personal on-line
  meetings, video chats, professional on-line meetings (e.g., telemedicine, legal,
  etc.).
3. Automatic Collection and Linking of Social Media Profiles and Social Media Posts:
  Use of AI 30c and blockchains 174 to collect and analyze, pictures, user
  profiles social media posts, for comprehensive insights.
4. Automated Search Engine Analysis:
    Use of AI 30c and blockchains 174 to collect and analyze search engine
  information including information from news articles, professional meetings,
  family events, community events, etc.
5. Automated Behavioral analysis:
  Use of AI 30c and blockchains 174 for user-driven flagging and pattern
  recognition to aid in the identification of individuals and the determination of if
  the individual(s) is/are dangerous, have a prior criminal record, have a negative
  dating history, dating site complaints, have been cited in a negative way in a
  news article, social media post, etc.
6. Automated Collection Analysis of Law Enforcement and Legal Databases:
  Use of AI 30c and blockchains 174 to collect and analyze arrest, conviction and
  criminal records, arrest warrants, BOLOs, most wanted information and/or civil
  records.
7. Automated Collection and Analysis of Credit Information:
    Use of AI 30c and blockchains 174 to collect and analyze credit information
  including credit reports, loan information, etc.
8. Automated Collection and Analysis of Prior Employment Information:
  Use of AI 30c and blockchains 174 to collect and analyze prior employment
  information.
```

The methods and systems described herein have been described with respect to people 41 and objects 59. However, the methods and systems are not limited to such embodiments and the methods and system can be used to identify, locate, track, secure and verify animals such as pets, livestock, wild animals, and other objects 59 such as construction equipment, sports equipment and/other types of objects 59. However, the present invention is not limited to such embodiments sand other embodiments can be used to practice the invention.

### Personal Awareness and Operational Coordination System Services 203

The personal awareness and operation coordination system services 203 extends its proximity awareness beyond phone-to-phone signals by using fixed city infrastructure such as streetlamps, buses, fire trucks, sanitation vehicles and building-mounted nodes as environmental beacons and environmental mesh network points. These building-mounted nodes create a broader, more reliable urban awareness grid, allowing the system to maintain precise positioning even when devices cannot directly detect each other.

For the military, that means every soldier's position, movement, spacing, and team formation can be accurately tracked even in terrain where devices can't directly see each other, creating a continuous operational picture across the entire battlespace.

The personal awareness and operation coordination system services 203 operates not only as a real-time awareness platform but as an artificial intelligence (AI) predictive intelligence engine, with Predictive AI 57f, Generative AI 57g, RAG AI 57h wherein continuously updated operational state data is used to forecast future movements, behaviors, interactions, and risk events prior to their occurrence, enabling preemptive intervention.

The personal awareness and operational coordinated system services 203 are designed for dual deployment across law multiple contexts. In addition to law enforcement, military, fire, and EMS applications, the system serves civilian commercial use cases including rideshare safety, dating app identity verification, short-term rental host and guest safety, childcare authorization and child safety monitoring, workplace security, elder care and/or other areas. In all civilian deployments, identity verification and alert functions operate within a consent-based framework in which individuals have enrolled their biometric and device data through participating civilian applications.

The unified personal awareness and operational coordination system services 203 is designed to merge five core components: (1) device-to-device recognition, (2) geofencing, (3) real-time location tracking, (4) AI prediction analytics, and (5) identity verification into a single, continuous operational platform. The services 203 enable police departments, fire agencies, EMS units, military organizations, and civilian commercial operators to maintain persistent situational awareness across predefined operational areas and active deployment zones.

In a typical configuration, the services 203 operate through two primary interfaces: a field-level mobile application and a command-level workbench. Each authorized user carries a mobile device that is registered to their identity and a role. When a user activates duty status, the network device becomes part of the operational network and begins broadcasting proximity network signals to nearby authorized devices. These network signals allow the system to determine relative positioning between personnel, even in low-connectivity or off-grid environments.

Operational areas are structured as pre-defined geofenced zones, which may include police sectors, fire districts, military patrol corridors, staging areas, buildings, or mission-specific boundaries. When a geofence is active, the services 203 continuously monitors all registered network devices for entries, exits, dwell time, and zone transitions. The field devices communicate these transitions automatically, enabling the command workbench to maintain an accurate real-time map of personnel within and around each defined area.

The services 203 collects secure location updates from each field network device and overlays them on the command-level map. The service 203 also maintains a history of movement paths, allowing for incident reconstruction, performance evaluation, and post-event analysis. By combining geofenced boundaries with real-time location data, the services display operational coverage, spacing between units, and the presence of unauthorized devices.

In addition to positional information, the services 203 incorporate an analytics layer capable of evaluating movement patterns, proximity dynamics, clustering, separation, and behavioral indicators. These analytics provide agencies with insight into how personnel respond during routine operations as well as high-pressure situations. Abnormalities, such as unexpected stops, unusual movement paths, or prolonged inactivity, are recorded automatically to improve safety and situational awareness.

Where legally permitted, the services 203 include a biometric identity-verification layer, which allows the services to confirm personnel identity using facial recognition and/or equivalent biometric methods. This layer may be used for access control within secure perimeters, controlled zones, or high-risk environments, and is governed by jurisdictional rules and policies.

The command-level workbench within the services 203 synthesizes all received data into a unified operational view, including optional integration of passive surveillance feeds from external video sources such as fixed cameras, body-worn cameras, aerial platforms, and privately owned video infrastructure, correlating those feeds with active personnel coordination data from all modules to produce a unified operational picture that combines passive environmental awareness with active personnel identification and coordination.

The services 203 enhance situational awareness through fine-grained spatial subdivision within existing geofenced areas. Rather than treating a physical location as a single uniform zone, the services 203 recognize and operate across smaller internal sections, such as barricaded areas, street segments, venue sections, corridors, and/or crowd cells that more accurately reflect how people actually occupy space. These internal subdivisions allow the services 203 to track movement, dwell, and transitions at a meaningful human scale, particularly during large public events or dense urban environments.

In addition, the services 203 prioritize relational proximity over rigid zone boundaries. Network devices (e.g., cell phones, wearables, etc.) carried by people in close physical proximity naturally move together and remain co-present; the services recognize these devices as relationally interlocked clusters rather than isolated points. As individuals or groups transition between adjacent subdivisions, their relational association persists, allowing the system to maintain continuity of awareness instead of resetting context at arbitrary grid edges. This relational logic enables accurate understanding of group behavior, shared movement, and co-presence in real-world scenarios such as New Year's Eve-style events, concerts, and citywide gatherings.

The services 203 are not limited to law enforcement, military, fire, and/or EMS deployment. The services 203 architecture supports a full range of civilian commercial applications in which safety-relevant identity verification and persistent alert functions are deployed within a consent-based framework.

The services 203 provide a comprehensive, integrated framework that replaces multiple disconnected tools. By unifying device-to-device signaling, sector-based geofencing, real-time location tracking, data analytics, and identity verification, the system delivers a continuous operational picture that enhances coordination, safety, and efficiency for multi-agency field operations and civilian commercial deployments alike.

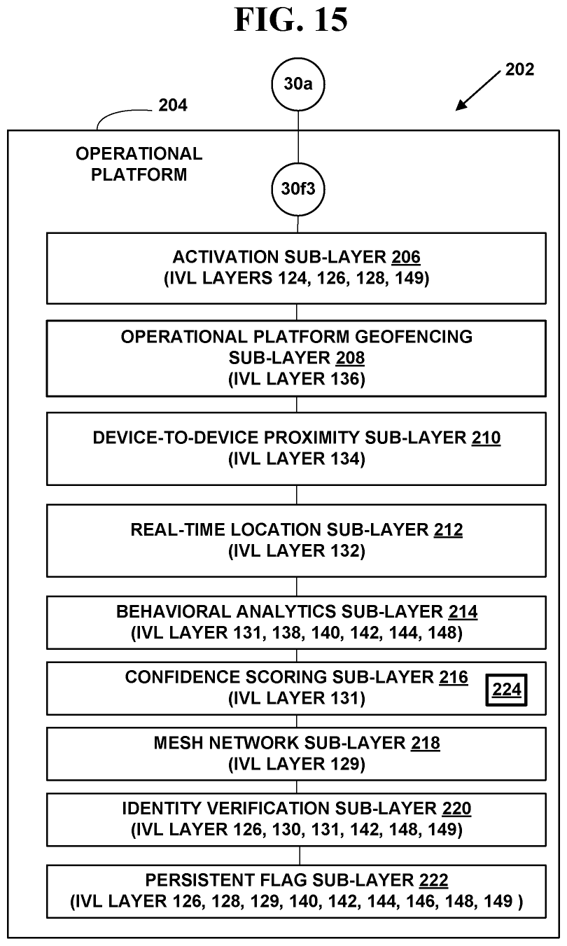

FIG. 15 is a block diagram 202 illustrating an exemplary multi-layer personnel awareness and operational coordination system application 30f3.

In FIG. 15, the multi-layer personnel awareness and operational coordination system application 30f3 provides the multi-layer personnel awareness and operational coordination services 203. The services 203 include cloud SaaS 64 services and/or non-cloud services. However, the present invention is not limited to such embodiments and other layers, sub-layers, applications and services can be used to practice the invention.

In FIG. 15, the multi-layer personnel awareness and operational coordination system application 30f3 includes an operational platform 204 including the multi-layer IVL application 30a on the server network device 20, 22, 24, 26 and connected to the communications network 18, 18′, the operational platform 204 including a plurality of sub-layers comprising: (a) an activations sub-layer 206 within the multi-layer IVL application 30a on the server network device 20, 22, 24, 26 configured for registering a plurality of authorized field network devices 12, 14, 16, 31, 33, 35, 37, 106-112 each with one or more processors, to a plurality of verified user 39 identities, activating operational roles and permissions included in an active-duty status, wherein the plurality of authorized field network devices 12, 14, 16, 31, 33, 35, 37, 106-112 become active mobile network nodes on the communications network 18, 18′ within the operational platform 204; (b) an operational platform geofencing sub-layer 208 within the multi-layer IVL application 30a on the server network device 20, 22, 24, 26 configured for defining one or more operational zones comprising primary geofenced boundaries and fine-grained internal spatial subdivisions within the primary geofenced boundaries, and for continuously monitoring the active registered plurality of authorized field network devices 12, 14, 16, 31, 33, 35, 37, 106-112 for entry time, exit time, dwell time, directional movement and geofence zone transition events across both the primary geofenced boundaries and the fine-grained internal spatial subdivisions; (c) a device-to-device proximity sub-layer 210 within the multi-layer IVL application 30a on the server network device 20, 22, 24, 26 configured for performing decentralized peer-to-peer network signaling between the active registered plurality of authorized field network devices 12, 14, 16, 31, 33, 35, 37, 106-112 operable in regular signal, low signal and weak signal communications network 18, 18′ environments, wherein the device-to-device proximity sublayer 210 determines proximity relationships, clustering patterns, formation, movement, and relational continuity between the active registered plurality of authorized field network devices 12, 14, 16, 31, 33, 35, 37, 106-112 that remain in a pre-determined physical proximity (e.g., feet to miles in distance) and wherein relational associations between the active registered plurality of authorized field network devices 12, 14, 16, 31, 33, 35, 37, 106-112 persist across the fine-grained internal spatial subdivisions within the primary geofenced boundaries in the operational platform geofencing sub-layer 208 without contextual reset; (d) a real-time location sub-layer 212 within the multi-layer IVL application 30a on the server network device 20, 22, 24, 26 configured for collecting and overlaying secure positional location data from the active registered plurality of authorized field network devices 12, 14, 16, 31, 33, 35, 37, 106-112 onto a unified operational map, maintaining movement path histories for incident reconstruction and post-event analysis and for detecting the presence of and/or unauthorized and/or unregistered network devices, (e.g., 16′, FIG. 1, etc.) each with one or more processors, within the one or more operational zones within the communications network 18, 18′; (e) a behavioral analytics sub-layer 214 within the multi-layer IVL application 30a on the server network device 20, 22, 24, 26 configured for evaluating and combining data from the activation sub-layer 206, the operational platform geofencing sub-layer 208, the device-to-device proximity sub-layer 210 and/or the real-time location sub-layer 212 to identify movement patterns, proximity dynamics, clustering and separation events, response timing, operational zone behavior, environmental interactions, behavioral anomalies, and predictive routing indicators based on detected movement trajectories of the active registered plurality of authorized field network devices 12, 14, 16, 31, 33, 35, 37, 106-112 and unauthorized or unregistered network devices 16′; (f) a confidence scoring sub-layer 216 within the multi-layer IVL application 30a on the server network device 20, 22, 24, 26 configured for calculating and continuously updating a confidence level value 224 (FIGS. 1, 15) to each positional and relational determination of the active registered plurality of authorized field network devices 12, 14, 16, 31, 33, 35, 37, 106-112 and/or unauthorized or unregistered network devices 16′ based on Artificial Intelligence (AI) analysis 131 of proximity duration, dwell time, movement consistency and environmental corroboration from a fixed network beacon and/or a mobile network beacon infrastructure on the communications network, wherein determined confidence level values strengthen over time with a presence within a pre-determined detection range from the device-to-device proximity layer 210 and/or degrade over time upon an absence from the pre-determined detection range from the device-to-device proximity layer 210; (g) a mesh network 276 (FIG. 19) sub-layer 218 within the multi-layer IVL application 30a on the server network device 20, 22, 24, 26 comprising a plurality of network addresses (e.g., Wi-Fi, IP, MAC, cell number, etc.) of fixed and mobile infrastructure nodes and building-mounted nodes, configured for augmenting device-to-device proximity detection with the fixed network beacon and/or mobile network beacon infrastructure when direct network signaling for the active registered authorized field network devices 12, 14, 16, 31, 33, 35, 37, 106-112 and unauthorized or unregistered network devices 16′ is strong, limited, weak or unavailable and extend operational awareness across blind spots and off-grid environments; (h) an identity verification sub-layer 220 within the multi-layer IVL application 30a on the server network device 20, 22, 24, 26 configured for determining an exact biometric identity confirmation of users 39 of the operational platform, users 39 of active registered authorized field network devices 12, 14, 16, 31, 33, 35, 37, 106-112 and other users 41 of an unauthorized or unregistered network devices, exact biometric identity confirmation of authorized and unauthorized users 39, 41 upon geofence entry, analytics-detected anomaly, behavior patterns, command-level authorization, secure area access requirements and other detected events; and (i) a persistent flag sub-layer 222 within the multi-layer IVL application 30a on the server network device 20, 22 24, 26 configured for calculating on the operational platform 204 on the server network device 20, 22, 24, 26, persistent flags 237 to desired vehicles 37, desired persons 41 or desired objects 59 at a request of an authorized agency or authorized person. Upon detection of a desired vehicle 37, a desired person 41 or desired object 59 with a persistent flag 237 by any of the registered plurality of authorized network devices 12, 14, 16, 31, 33, 35, 37, 106-112, the operational platform 204 on the server network device 20, 22, 24, 26 securely sending an alert message via communications network 18, 18′ to the authorized agency or the authorized person that requested the persistent flag 237. The alert message including a detection timestamp, geographic coordinates, and identity of a registered authorized network device 12, 14, 16, 31, 33, 35, 37, 106-112 detecting the desired vehicle 37, the desired person 41 or the desired object including persistent flag 237. However, the present invention is not limited to such an embodiment and other sub-layers, layers and other embodiments may be used to practice the invention.

In one embodiment, persistent flags 237 are assigned based on arrests, criminal convictions, outstanding arrest warrants, outstanding traffic tickets, be on the lookout (BOLO) lists, dangerous objects 59 lists, stolen objects 59 lists, stolen vehicle 35 lists, most wanted lists, criminal complaints, criminal sentencing, or civil legal judgment information. However, the present invention is not limited to such an embodiment and other embodiments may be used to practice the invention.

In FIG. 15, the multi-layer identification verification and location (IVL) application 30a with plural layers (FIG. 8) includes, but is not limited to: (a) a first security layer 124 including authorization for providing summary only identification verification and location information 126 for a desired person 39; (b) a plurality of second advanced security layers 128 including: (c) multi-layer identity verification layer 129 comprising: a (1) biometrics layer 130 including: a facial recognition sublayer 130a, eye scan sublayer 130b, and biometric markers identification sublayer 130c, (2) Artificial Intelligence (AI) identity verification decision layer 131, (3) location tracking layer 132, (4) proximity detection layer 134 (5) geofencing layer 136, (6) pattern recognition layer 138, (7) event recording layer 140, (8) secure data records layer 142, (9) data analytics layer 144, (10) electronic chain of custody layer 146, (11) jurisdictional biometrics and privacy law compliance layer 147, (12) law enforcement records layer 148, and (13) all requested identification verification and location information layer 149. However, the present invention is not limited to such an embodiment and the IVL application 30a can include more, fewer and/or other layers.

In one embodiment, the activations sub-layer 206 has components included within the layers 124, 126, 128, 149 in the multi-layer IVL application 30a on the server network device 20, 22, 24, 26. However, the present invention is not limited to such an embodiment and other layers and other embodiments may be used to practice the invention.

In one embodiment, the operational platform geofencing sub-layer 208 has component included within layer 136 in the multi-layer IVL application 30a on the server network device 20, 22, 24, 26. However, the present invention is not limited to such an embodiment and other layers and other embodiments may be used to practice the invention.

In one embodiment, the device-to-device proximity sub-layer 210 has components included within layer 134 within the multi-layer IVL application 30a on the server network device 20, 22, 24, 26.

In the device-to-device proximity sub-layer 210 a contextual reset refers to clearing or reinitializing state, permissions, or behavior when context changes (e.g., location, session, environment, etc.) and the operational platform 204 continues operating with its existing state, permissions, logic, etc. without reinitializing or re-evaluating context when a geofence boundary is crossed. However, the present invention is not limited to such an embodiment and other layers and other embodiments may be used to practice the invention.

In one embodiment, the real-time location sub-layer 212 has components included within layer 132 within the multi-layer IVL application 30a on the server network device 20, 22, 24, 26. However, the present invention is not limited to such an embodiment and other layers and other embodiments may be used to practice the invention.

In one embodiment, the behavioral analytics sub-layer 214 has components included within layers 131, 138, 140, 142, 144, 148 within the multi-layer IVL application 30a on the server network device 20, 22, 24, 26. However, the present invention is not limited to such an embodiment and other layers and other embodiments may be used to practice the invention.

In one embodiment, the confidence scoring sub-layer 216 has components included within layer 131, within the multi-layer IVL application 30a on the server network device 20, 22, 24, 26. However, the present invention is not limited to such an embodiment and other layers and other embodiments may be used to practice the invention.

Within the confidence scoring sub-layer 216, proximity duration includes, but is not limited to, a total elapsed time an active registered authorized field network devices 12, 14, 16, 31, 33, 35, 37, 106-112 and/or unauthorized or unregistered network devices 16′ are detected within a defined spatial threshold of a beacon and/or network reference point.

A beacon, includes, but is not limited to, is a transmitting device and/or signal source that periodically broadcasts identifiable information to nearby active registered authorized field network devices 12, 14, 16, 31, 33, 35, 37, 106-112 and/or unauthorized or unregistered network devices 16′, enabling detection, proximity estimation, or positioning within a communications network 18 18′.

A fixed beacon 268 (e.g., Wi-Fi, BLE, UWA, cellular tower, RSRP, RSRQ, etc.) includes a stationary transmitting device and/or signal source with a known, stable physical location on a fixed beacon infrastructure 266, used as a reference point for detecting, positioning, and validating nearby active registered authorized field network devices 12, 14, 16, 31, 33, 35, 37, 106-112 and/or unauthorized or unregistered network devices 16′, within the communications network 18, 18′.

A mobile beacon 270 (e.g., RFID, RFID, tags, GPS, NFC, M2M, BLE, UWB, 802.11x, law enforcement radio, military radio, etc.) includes, but is not limited to, a beacon transmitter that is not fixed in location, but instead moves with an active registered authorized field network devices 12, 14, 16, 31, 33, 35, 37, 106-112 and/or unauthorized or unregistered network devices 16′, vehicles 37 person 39, 41 and/or object 59, continuously broadcasting identifiable signals within the communications network 18,18′.

Mobile beacons 272 are categorized by radio signal technology (BLE, UWB, cellular, 802.11x, etc.), functional role (e.g., identity, telemetry, positioning, etc.), mobility pattern (e.g., human 39, 41, object 59, vehicle 37, etc.), and trust level (e.g., unverified to cryptographically secured, etc.), each affecting how their mobile signals on a mobile beacon infrastructure 270 are interpreted within a communications network 18, 18′.

A spatial threshold includes, includes but is not limited to, a quantitative boundary condition in space, defined by distance, signal characteristics, or region geometry used to determine whether a device or event is considered “inside,” “outside,” or “near” a specified physical and/or geofence location.

Dwell time includes, but is not limited to, a continuous, uninterrupted duration an active registered authorized field network device 12, 14, 16, 31, 33, 35, 37, 106-112 and/or unauthorized or unregistered network device 16′ remains within a pre-determined proximity or geofenced region.

Movement consistency includes, but is not limited to, a degree to which an active registered authorized field network device 12, 14, 16, 31, 33, 35, 37, 106-112 and/or unauthorized or unregistered network device 16′ motion pattern (e.g., trajectory, velocity, signal transitions, etc.) is stable, coherent, and/or physically plausible over time.

Environmental corroboration includes but is not limited to, a process of validating an active registered authorized field network device 12, 14, 16, 31, 33, 35, 37, 106-112 and/or unauthorized or unregistered network device 16′ location or presence by cross-referencing multiple independent network signals and/or environmental indicators from the communications network 18, 18′ infrastructure.

Sources of environmental collaboration include, but are not limited to, fixed beacons (e.g., Wi-Fi access points (AP), BLUETOOTH® Low Energy (BLE), Ultra-Wideband (UWB) anchors, etc.) cellular measurements (Reference Signal Received Power (RSRP), Reference Signal Received Quality (RSRQ), timing advance, cell ID, etc.), network metadata (e.g., handover logs, timing, sectorization, etc.) and/or active registered authorized field network device 12, 14, 16, 31, 33, 35, 37, 106-112 and/or unauthorized or unregistered network device 16′ sensors (e.g. RFID, BLUETOOTH®, NFC, M2M, etc.).

BLUETOOTH® Low Energy (BLE) includes a short-range wireless communication protocol designed for low power consumption and intermittent data exchange over the 2.4 GHz Industrial, Scientific, Medical (ISM) band.

Ultra-Wideband (UWB) is a wireless communication technology that uses very short pulses across a wide frequency spectrum to enable highly precise distance and positioning measurements.

NFC and BLE answer the question: “Is a network device nearby?” and UWB answers the question: “Exactly where is a network device?” BLE is typically used for coarse proximity signals, while UWB is used for high-confidence spatial validation and anti-spoofing.

Reference Signal Received Power (RSRP) includes an average received power of specific reference signals transmitted by a cellular base station.

Reference Signal Received Quality (RSRQ) includes a quality metric that combines signal strength with interference and communication network load.

In one embodiment, the mesh network 276 (FIG. 19) sub-layer 218 has components included within layer 192 within the multi-layer IVL application 30a on the server network device 20, 22, 24, 26. However, the present invention is not limited to such an embodiment and other layers and other embodiments may be used to practice the invention.

A mesh network 276 (FIG. 19) includes, but is not limited to, a mesh network architecture in which nodes (e.g. network devices 12, 14, 16, 31, 33, 35, 37, 106-112, server network devices 20, 22, 24, 26 etc.) are interconnected in a non-hierarchical, peer-to-peer topology, allowing data to be routed dynamically across multiple paths between any two points.

Building-mounted nodes include fixed network and/or beacon devices physically installed on structures (e.g., walls, ceilings, rooftops, light poles, utility powers, cell towers, etc.) that act as stationary reference points or communication endpoints within a wireless or sensor mesh network 276 and/or communication network 18, 18′.

In one embodiment the identity verification sub-layer 220 has components included within layers 126, 130, 131, 142, 148, 149 of the multi-layer IVL application 30a on the server network device 20, 22, 24, 26. However, the present invention is not limited to such an embodiment and other layers and other embodiments may be used to practice the invention.

In one embodiment, the persistent flag sub-layer 222 has components included within layers 128, 129, 140, 142, 144, 146, 148, 149 of the multi-layer IVL application 30a on the server network device 20, 22, 24, 26. However, the present invention is not limited to such an embodiment and other layers and other embodiments may be used to practice the invention.

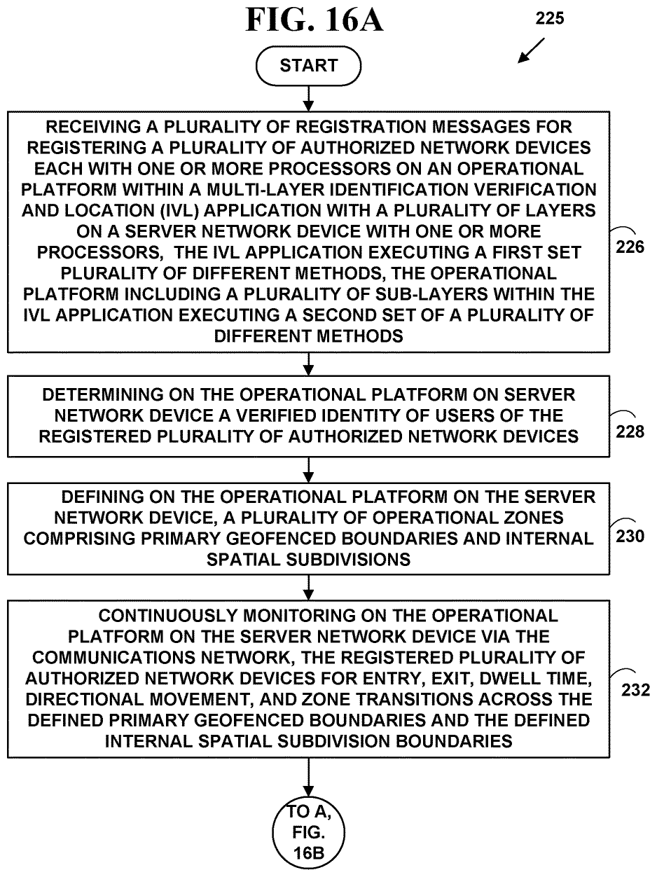

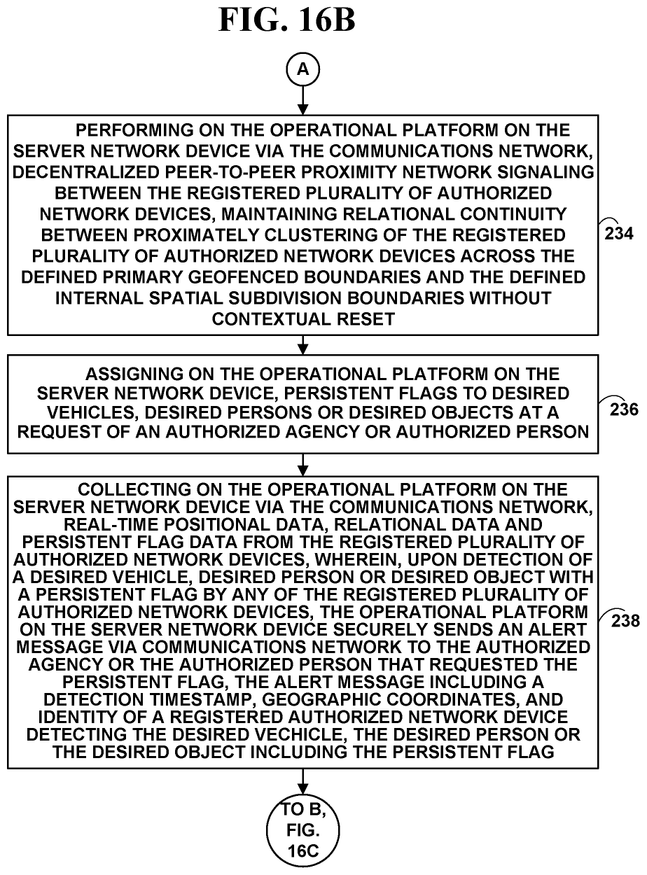

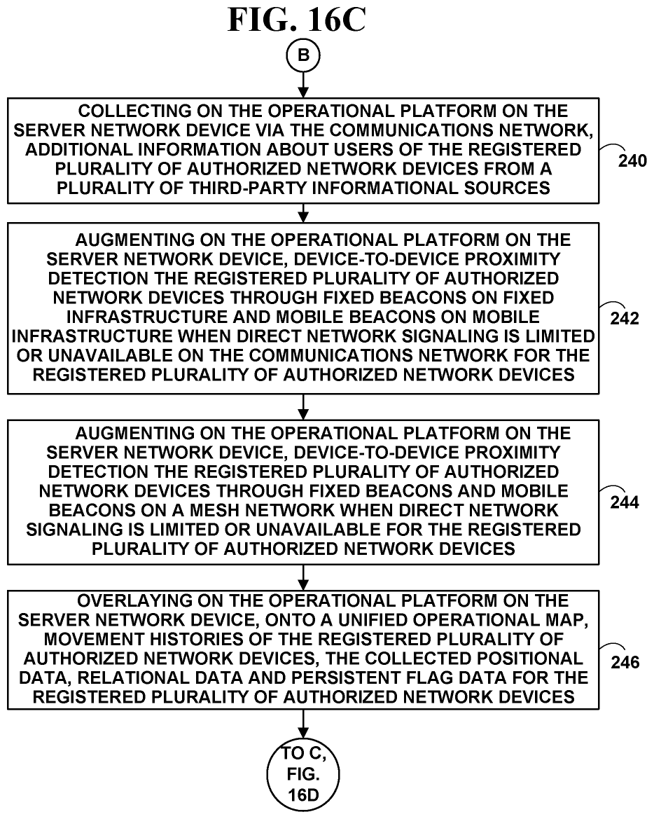

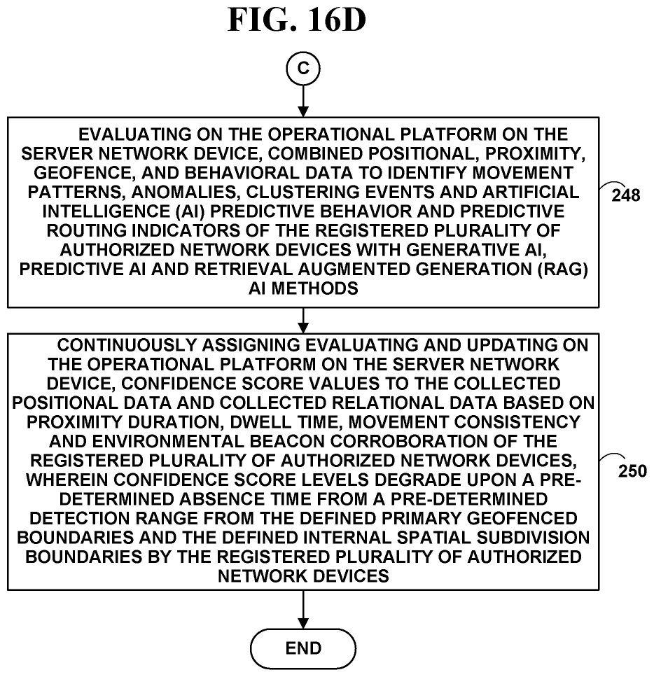

FIGS. 16A, 16B, 16C and 16D are a flow diagram including Method 225 for providing personal awareness and operational coordination.

In FIG. 16A at Step 226, receiving a plurality of registration messages for registering a plurality of authorized network devices each with one or more processors on an operational platform within a multi-layer identification verification and location (IVL) application with a plurality of layers on a server network device with one or more processors, the IVL application executing a first set plurality of different methods, the operational platform including a plurality of sub-layers within the IVL application executing a second set of a plurality of different methods. At Step 228, determining on the operational platform on server network device a verified identity of users of the registered plurality of authorized network devices. At Step 230, defining on the operational platform on the server network device, a plurality of operational zones comprising primary geofenced boundaries and internal spatial subdivisions. At Step 232, continuously monitoring on the operational platform on the server network device via the communications network, the registered plurality of authorized network devices for entry, exit, dwell time, directional movement, and zone transitions across the defined primary geofenced boundaries and the defined internal spatial subdivision boundaries. In FIG. 16B, at Step 234, performing on the operational platform on the server network device via the communications network, decentralized peer-to-peer proximity network signaling between the registered plurality of authorized network devices, maintaining relational continuity between proximately clustering of the registered plurality of authorized network devices across the defined primary geofenced boundaries and the defined internal spatial subdivision boundaries without contextual reset. At Step 236, assigning on the operational platform on the server network device, persistent flags to desired vehicles, desired persons or desired objects at a request of an authorized agency or authorize person. At Step 238, collecting on the operational platform on the server network device via the communications network, real-time positional data, relational data and persistent flag data from the registered plurality of authorized network devices, wherein, upon detection of the desired vehicle, the desired person or the desired object with a persistent flag by any of the registered plurality of authorized network devices, the operational platform on the server network device securely sends and alert message via communications network to the authorized agency or the authorized person that requested the persistent flag, the alert message including a detection timestamp, geographic coordinates, and identity of a registered authorized network device detecting the desired person or desired object including persistent flag; In FIG. 16C at Step 240, collecting on the operational platform on the server network device via the communications network, additional information about users of the registered plurality of authorized network devices from a plurality of third-party informational sources. At Step 242, augmenting on the operational platform on the server network device, device-to-device proximity detection of the registered plurality of authorized network devices through fixed beacons on a fixed infrastructure and mobile beacons on a mobile infrastructure when direct network signaling is limited or unavailable on the communications network for the registered plurality of authorized network devices. at Step 244, augmenting on the operational platform on the server network device, device-to-device proximity detection the registered plurality of authorized network devices through fixed beacons and mobile beacons on a mesh network when direct network signaling is limited or unavailable for the registered plurality of authorized network devices. At Step 246, overlaying and displaying on the operational platform on the server network device, onto a unified operational map, movement histories of the registered plurality of authorized network devices, the collected positional data, relational data and persistent flag data for the registered plurality of authorized network devices. In FIG. 16D, at Step 248, evaluating on the operational platform on the server network device, combined positional, proximity, geofence, and behavioral data to identify movement patterns, anomalies, clustering events and artificial intelligence (AI) predictive behavior and predictive routing indicators of the registered plurality of authorized network devices with Generative AI, Predictive AI and Retrieval Augmented Generation (RAG) AI methods. At Step 250, continuously calculating, evaluating and updating on the operational platform on the server network device, confidence score values to the collected positional data and collected relational data based on proximity duration, dwell time, movement consistency and environmental beacon corroboration of the registered plurality of authorized network devices, wherein confidence score levels degrade upon a pre-determined absence time from a pre-determined detection range from the defined primary geofenced boundaries and the defined internal spatial subdivision boundaries by the registered plurality of authorized network devices.

The present invention is illustrated with an exemplary embodiment. However, the present invention is not limited to such an embodiment and other embodiments can be used to practice the invention.

In such an exemplary embodiment, in FIG. 16A at Step 226, receiving a plurality of registration messages for registering a plurality of authorized network devices 12, 14, 16, 31, 33, 35, 37, 106-112, each with one or more processors on an operational platform 204 within a multi-layer identification verification and location (IVL) application 30a with a plurality of layers 124-128, 129, 130, 131, 132-146, 147, 148, 149 on a server network device 20, 22, 24, 26 with one or more processors, the IVL application 30a executing a first set plurality of different methods, the operational platform 204 including a plurality of sub-layers 206-220 within the IVL application 30a executing a second set of a plurality of different methods.

In one embodiment, Step 226 includes, but is not limited to, activation sub-layer 208 on the operational platform 204 and IVL layers 124, 126, 128, 149 of the IVL application 30a. However, the present invention is not limited to such an embodiment and other layers, sub-layers and embodiments can be used to practice the invention.

At Step 228, determining on the operational platform 204 on the server network device 20, 22, 24, 26, a verified identity of users of the registered plurality of authorized network devices 12, 14, 16, 31, 33, 35, 37, 106-112.

In one embodiment, Step 228 includes, but is not limited to, identify verification sub-layer 220 on the operation platform 204 on the server network device 20, 22, 24, 26, and IVL layers 126, 130, 131, 147, 149 of the IVL application 30a. However, the present invention is not limited to such an embodiment and other layers, sub-layers and embodiments can be used to practice the invention.

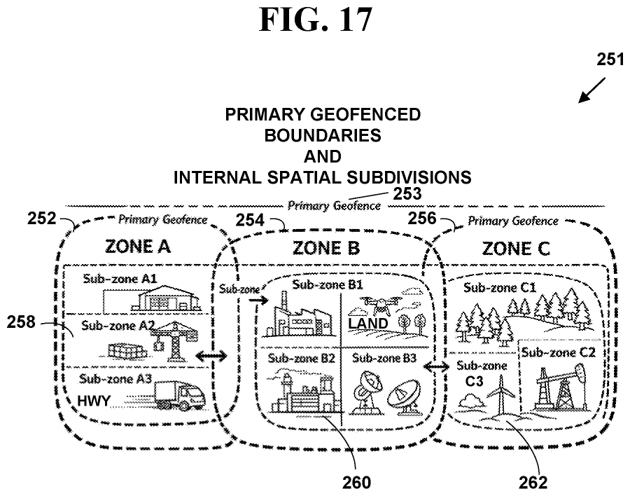

FIG. 17 is a block diagram 251 illustrating exemplary primary geofenced boundaries and internal spatial subdivisions.

FIG. 17 illustrates a primary geofence 253, a plurality of operational zones A,B,C comprising primary geofenced boundaries 252, 254, 256 and internal spatial subdivisions 258, 260, 262, sub-zones A1-A3, B1-B3 and C1-C3.

Returning to FIG. 16A at Step 230, defining on the operational platform 204 on the server network device 20, 22, 24, 26, a plurality of operational zones comprising primary geofenced boundaries 252, 254, 256 and internal spatial subdivisions 258, 260, 262.

In one embodiment, Step 230 includes, but is not limited, operational platform geofencing layer 208 on the operation platform 204 on the server network device 20, 22, 24, 26, and IVL layer 136 the IVL application 30a. However, the present invention is not limited to such an embodiment and other layers, sub-layers and embodiments can be used to practice the invention.

At Step 232, continuously monitoring on the operational platform 204 on the server network device 20, 22, 24, 26 via the communications network 18, 18′, the registered plurality of authorized network devices 12, 14, 16, 31, 33, 35, 37, 106-112 for entry, exit, dwell time, directional movement, and zone transitions across the defined primary geofenced boundaries 252-256 and the defined internal spatial subdivision boundaries 258-262.

In one embodiment, Step 232 includes operational platform geofencing layer 208 and real-time location sub-layer 212 on the operation platform 204 on the server network device 20, 22, 24, 26, and IVL layers 136, 132 of the IVL application 30a. However, the present invention is not limited to such an embodiment and other layers, sub-layers and embodiments can be used to practice the invention.

In FIG. 16B, at Step 234, performing on the operational platform 204 on the server network device 20, 22, 24, 26 via the communications network 18, 18′, decentralized peer-to-peer proximity network signaling between the registered plurality of authorized network devices 12, 14, 16, 31, 33, 35, 37, 106-112, maintaining relational continuity between proximately clustering of the registered plurality of authorized network devices 12, 14, 16, 31, 33, 35, 37, 106-112 across the defined primary geofenced boundaries and the defined internal spatial subdivision boundaries without contextual reset.

In one embodiment, Step 234 includes, but is not limited to, operational platform geofencing layer 208, device-to-device proximity sub-layer 210 and real-time location sub-layer 212 on the operation platform 204 on the server network device 20, 22, 24, 26, and IVL layers 136, 134, 132 of the IVL application 30a. However, the present invention is not limited to such an embodiment and other layers, sub-layers and embodiments can be used to practice the invention.

At Step 236, assigning on the operational platform 204 on the server network device 20, 22, 24, 26, persistent flags 237 to desired vehicles 37, desired persons 41, desired objects 59 at a request of an authorized agency 39′ or authorized person 39.

In one embodiment, persistent flags 237 are assigned based on arrests, criminal convictions, outstanding arrest warrants, outstanding traffic tickets, be on the lookout (BOLO) lists, dangerous objects 59 lists, stolen objects 59 lists, stolen vehicle 35 lists, most wanted lists, criminal complaints, criminal sentencing, or civil legal judgment information. However, the present invention is not limited to such an embodiment and other embodiments may be used to practice the invention.

In one embodiment, Step 236 includes, but is not limited to persistent flag sub-layer 222, on the operation platform 204 on the server network device 20, 22, 24, 26, and IVL layers 126, 128, 129, 140, 142, 144, 148, 149 of the IVL application 30a. However, the present invention is not limited to such an embodiment and other layers, sub-layers and embodiments can be used to practice the invention.

Step 238, collecting on the operational platform 204 on the server network device 20, 22, 24, 26 via the communications network 18, 18′, real-time positional data, relational data and persistent flag 237 data from the registered plurality of authorized network devices 12, 14, 16, 31, 33, 35, 37, 106-112, wherein, upon detection of a desired person 41 or desired object 59 with a persistent flag by any of the registered plurality of authorized network devices 12, 14, 16, 31, 33, 35, 37, 106-112, the operational platform 204 on the server network device 20, 22, 24, 26 generates an alert message via communications network 18, 18′ to the authorized agency 39′ or the authorized person 39 that requested the persistent flag 237, the alert message including a detection timestamp, geographic coordinates, and identity of a registered authorized network device detecting the desired vehicle 37, desired person 41 or desired object 59 including the persistent flag 237.

In one embodiment, Step 238 includes, but is not limited to, operational platform geofencing layer 208, device-to-device proximity sub-layer 210, real-time location sub-layer 212, behavioral analytics sub-layer 214 and persistent flag sub-layer 222, on the operation platform 204 on the server network device 20, 22, 24, 26, and IVL layers 126, 136, 134, 132, 131, 138, 140, 142, 144, 148, 149 of the IVL application 30a. However, the present invention is not limited to such an embodiment and other layers, sub-layers and embodiments can be used to practice the invention.

At Step 240, collecting on the operational platform 204 on the server network device 20, 22, 24, 26 via the communications network 18, 18, additional information about users of the registered plurality of authorized network devices 12, 14, 16, 31, 33, 35, 37, 106-112 from a plurality of third-party informational sources.

In one embodiment, the plurality of third-party informational sources, including but is not limited to, the Internet, public and private intranets, social media, search engines, public databases, private databases, public and private information services, and/or other third-party information sources.

In one embodiment, Step 240 includes, but is not limited to, operational platform geofencing layer 208, device-to-device proximity sub-layer 210, real-time location sub-layer 212 and behavioral analytics sub-layer 214 on the operation platform 204 on the server network device 20, 22, 24, 26, and IVL layers 136, 134, 132, 131, 138, 140, 142, 144, 148 of the IVL application 30a. However, the present invention is not limited to such an embodiment and other layers, sub-layers and embodiments can be used to practice the invention.

FIG. 18 is a block diagram 264 illustrating exemplary augmenting through beacons when direct network signaling is limited or not available on the communications network.

FIG. 18 illustrates a fixed beacon infrastructure 266 with fixed network beacons 268 include network access points (e.g., Wi-Fi access points (AP), BLUETOOTH® Low Energy (BLE), Ultra-Wideband (UWB), etc.), network anchor points, cell towers, light pole sensors, utility pole sensors, observation cameras, traffic cameras, doorbell cameras, etc.) only one of which is illustrated for simplicity, a mobile beacon infrastructure 270 with mobile beacons 272 ((e.g., RFID, RFID, tags, GPS, NFC, M2M, BLE, UWB, 802.11x, law enforcement radio, military radio, law enforcement, fire, EMS, military vehicles, 37, etc.) on a mobile infrastructure 274 for device-to-device proximity detection 276.

Returning to FIG. 16B at Step 242, augmenting on the operational platform 204 on the server network device 20, 22, 24, 26, device-to-device proximity detection 276 of the registered plurality of authorized network devices 12, 14, 16, 31, 33, 35, 37, 106-112 through fixed beacons 268 on a fixed infrastructure 270 and mobile beacons 272 on a mobile infrastructure 274 when direct communications network signaling is limited or unavailable on the communications network 18, 18′ for the registered plurality of authorized network devices 12, 14, 16, 31, 33, 35, 37, 106-112.

In one embodiment, Step 242 includes, but is not limited to, operational platform geofencing layer 208, device-to-device proximity sub-layer 210, real-time location sub-layer 212 and behavioral analytics sub-layer 214 on the operation platform 204 on the server network device 20, 22, 24, 26, and IVL layers 136, 134, 132, 131, 138, 140, 142, 144, 148, 124, 128, 129 of the IVL application 30a. However, the present invention is not limited to such an embodiment and other layers, sub-layers and embodiments can be used to practice the invention.

FIG. 19 is a block diagram 274 illustrating exemplary augmenting through mesh network beacons on a mesh network when direct network signaling is limited or not available on the communications network.

FIG. 19 illustrates a mesh network 276, a mesh network fixed beacon infrastructure 278 with fixed mesh network beacons 280 (e.g., Wi-Fi access points (AP), BLUETOOTH® Low Energy (BLE) access points, Ultra-Wideband (UWB) anchor points, cell towers, light poles sensors, utility poles sensors, observation cameras, traffic cameras, doorbell cameras, etc.) only one of which is illustrated for simplicity, a mobile mesh beacon infrastructure 282 with mobile beacons 284 ((e.g., RFID, RFID, tags, GPS, NFC, M2M, BLE, UWB, 802.11x, law enforcement radio, military radio, law enforcement, fire, EMS, military vehicles, 37, etc.) for device-to-device proximity detection 286 on the mesh network 276.

Returning to FIG. 16C, at Step 244, augmenting on the operational platform 204 on the server network device 20, 22, 24, 26, device-to-device proximity detection the registered plurality of authorized network devices 12, 14, 16, 31, 33, 35, 37, 106-112 through fixed beacons and mobile beacons on a mesh network 276 when direct network signaling is limited or unavailable for the registered plurality of authorized network devices 12, 14, 16, 31, 33, 35, 37, 106-112.

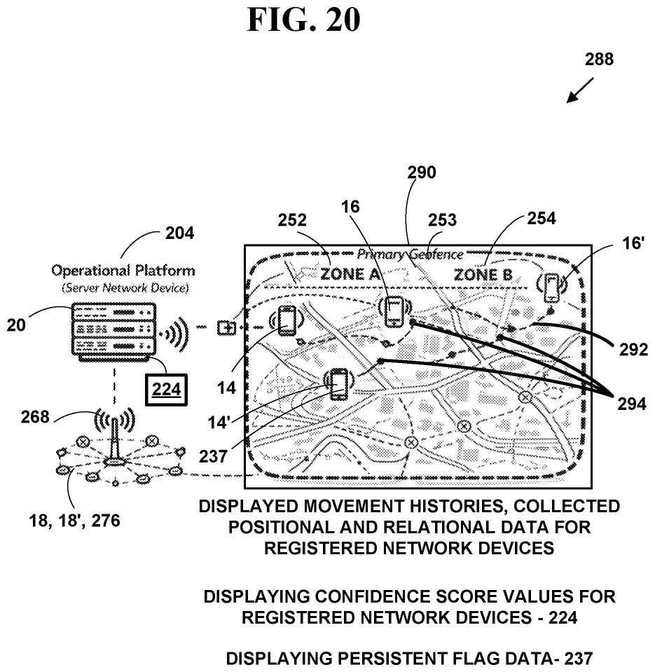

FIG. 20 is a block diagram 288 illustrating a unified operational map, including movement histories of the registered plurality of authorized network devices, the collected positional data and relational data for the registered plurality of authorized network devices.

FIG. 20 illustrates the unified operational map 290, including movement histories 292 of the registered plurality of authorized network devices, the collected positional data and relational data 294 and persistent flag 237 data for the registered plurality of authorized network devices 12, 14, 14′, 16, 16′, 31, 33, 35, 37, 106-112.

In one embodiment, Step 244 includes but is not limited to, operational platform 204 geofencing layer 208, device-to-device proximity sub-layer 210, real-time location sub-layer 212, behavioral analytics sub-layer 214 and mesh network sub-layer 218 on the operation platform 204 on the server network device 20, 22, 24, 26, and IVL layers 136, 134, 132, 131, 138, 140, 142, 144, 148, 124, 128, 129 of the IVL application 30a. However, the present invention is not limited to such an embodiment and other layers, sub-layers and embodiments can be used to practice the invention.

Returning to FIG. 16C at Step 246, overlaying and displaying on the operational platform 204 on the server network device 20, 22, 24, 26, onto a unified operational map 290, movement histories 292 of the registered plurality of authorized network devices 12, 14, 16, 31, 33, 35, 37, 106-112, the collected positional data and relational data 294 and persistent flag 237 data for the registered plurality of authorized network devices 12, 14, 16, 31, 33, 35, 37, 106-112.

In one embodiment, Step 246 includes but is not limited to, operational platform 204 geofencing layer 208, device-to-device proximity sub-layer 210, real-time location sub-layer 212, behavioral analytics sub-layer 214 on the operation platform 204 on the server network device 20, 22, 24, 26, and IVL layers 136, 134, 132, 131, 138, 140, 142, 144, 148, 124, 128, 129 of the IVL application 30a. However, the present invention is not limited to such an embodiment and other layers, sub-layers and embodiments can be used to practice the invention.

In FIG. 16D at Step 248, evaluating on the operational platform 204 on the server network device 20, 22, 24, 26, combined positional, proximity, geofence, and behavioral data to identify movement patterns, anomalies, clustering events and artificial intelligence (AI) predictive routing indicators of the registered plurality of authorized network devices 12, 14, 16, 31, 33, 35, 37, 106-112 with Generative AI, Predictive AI and Retrieval Augmented Generation (RAG) AI methods.

In one embodiment, Step 248 includes but is not limited to, operational platform 204 geofencing layer 208, device-to-device proximity sub-layer 210, real-time location sub-layer 212, behavioral analytics sub-layer 214 on the operation platform 204 on the server network device 20, 22, 24, 26, and IVL layers 136, 134, 132, 131, 138, 140, 142, 144, 148, 124, 128, 129 of the IVL application 30a. However, the present invention is not limited to such an embodiment and other layers, sub-layers and embodiments can be used to practice the invention.

At Step 250, continuously calculating, evaluating and updating on the operational platform 204 on the server network device 20, 22, 24, 26, confidence score values 224 to the collected positional data and collected relational data based on proximity duration, dwell time, movement consistency and environmental beacon corroboration of the registered plurality of authorized network devices 12, 14, 16, 31, 33, 35, 37, 106-112, wherein confidence score levels 22 degrade upon a pre-determined absence time from a pre-determined detection range from the defined primary geofenced boundaries and the defined internal spatial subdivision boundaries by the registered plurality of authorized network devices 12, 14, 16, 31, 33, 35, 37, 106-112.

In one embodiment, Step 250 includes but is not limited to, operational platform 204 geofencing layer 208, device-to-device proximity sub-layer 210, real-time location sub-layer 212, behavioral analytics sub-layer 214 and confidence scoring sub-layer 216 on the operation platform 204 on the server network device 20, 22, 24, 26, and IVL layers 136, 134, 132, 131, 138, 140, 142, 144, 148, 124, 128, 129 of the IVL application 30a. However, the present invention is not limited to such an embodiment and other layers, sub-layers and embodiments can be used to practice the invention.

Exemplary civilian scenarios for using the operation platform 204 with Method 224 include, but are not limited to, those described in Table 13.

```
TABLE 13
OPERATIONAL PLATFORM 204, 224, 30a
Law Enforcement, Government, Military, First Responder Operations
  The operation platform 204 with Method 224 and use of IVL application 30a and
  services 203 enable police departments, federal law enforcement agencies, fire
  agencies, EMS units, military organizations and other government organizations to
  maintain persistent situational awareness across predefined operational areas and
  active deployment zones.
Civilian Operations
  The operation platform 204 with Method 224 and use of IVL application 30a is not
  limited to law enforcement, military, fire, or EMS deployment. The system's
  architecture supports a full range of civilian commercial applications in which safety-
  relevant identity verification and persistent alert functions are deployed within a
  consent-based framework. The following civilian use cases are exemplary
  embodiments of the invention:
Rideshare Safety
  When a passenger requests a ride, the passenger's authorized registered network
  device silently verifies the driver's identity in real-time, matching the drive's live face
  against their biometric profile and cross-referencing against relevant safety databases.
  The passenger receives a silent confirmation or alert before the ride begins, without
  any confrontation or delay.
Dating App Identity Verification
  Before two enrolled users meet in person, the operational platform 204 and each
  other's authorized registered network devices silently verifies each party's identity
  against their biometric profiles and queries relevant safety databases including but not
  limited to registered sex offender registries, domestic violence restraining order
  registries, and violent crime records. The verification occurs passively through the
  operational platform 204 without requiring either party to take any action beyond their
  initial enrollment consent.
Short-Term Rental Safety
  Before a guest enters a host's property, or before a host welcomes a guest, both parties
  are silently verified through their authorized registered network devices via the
  operational platform 204. Hosts receive silent confirmation of guest identity and any
  relevant safety alerts before granting access. Guests receive equivalent host
  verification. The operational platform operates entirely within the consent framework
  established at enrollment.
Childcare and Child Safety
  Parents and guardians establish authorized pickup lists through their authorized
  registered network device. When an individual approaches a child's location, the
  operational platform silently verifies whether that individual is on the authorized list.
  Unauthorized individuals trigger silent alerts to the parent, guardian, and facility
  operator. The operational platform also supports child location monitoring, triggering
  alerts when a child carrying an authorized registered network device moves outside an
  authorized geofenced area.
Workplace Security
  Employers maintain enrolled personnel lists and threat assessment records within the
  operational platform 204. When a terminated employee, a subject of a workplace
  restraining order, or an individual flagged in a threat assessment enters proximity of the
  workplace, including before they reach the building's own security cameras, the
  operational platform204 generates a silent alert to designated security personnel. The
  alert propagates across all authorized registered network devices in the area, not only the
  employer's own infrastructure.
Elder Care and Wandering Prevention
  Enrolled elder care facilities and family members receive silent alerts when a
  monitored individual moves outside an authorized geofenced area. The alert includes
  real-time location derived from proximity detection across any authorized registered
  network devices in the environment including a mesh network environment, enabling
  rapid location even in areas without dedicated tracking network infrastructure.
```

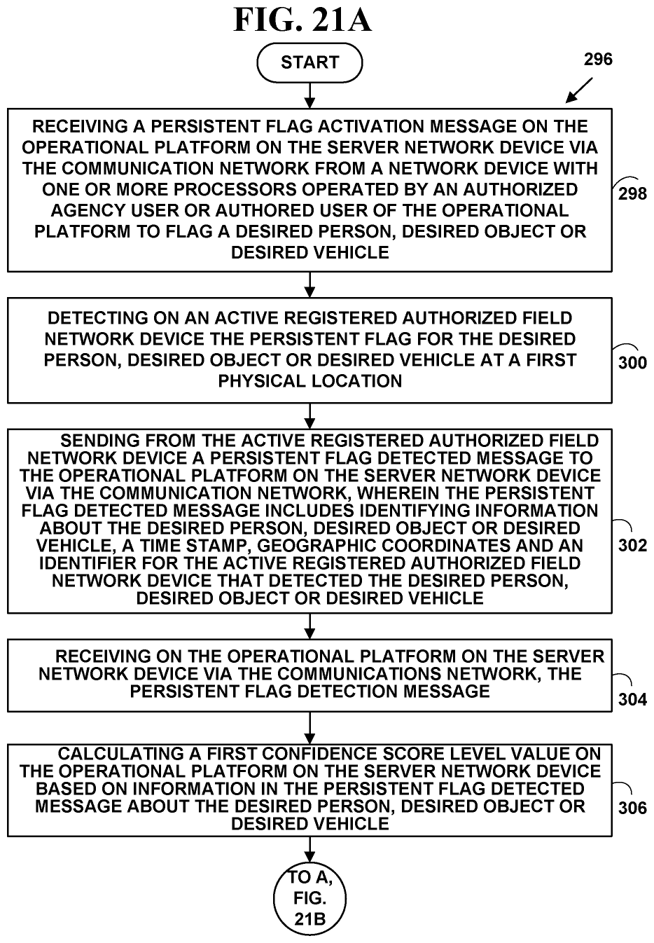

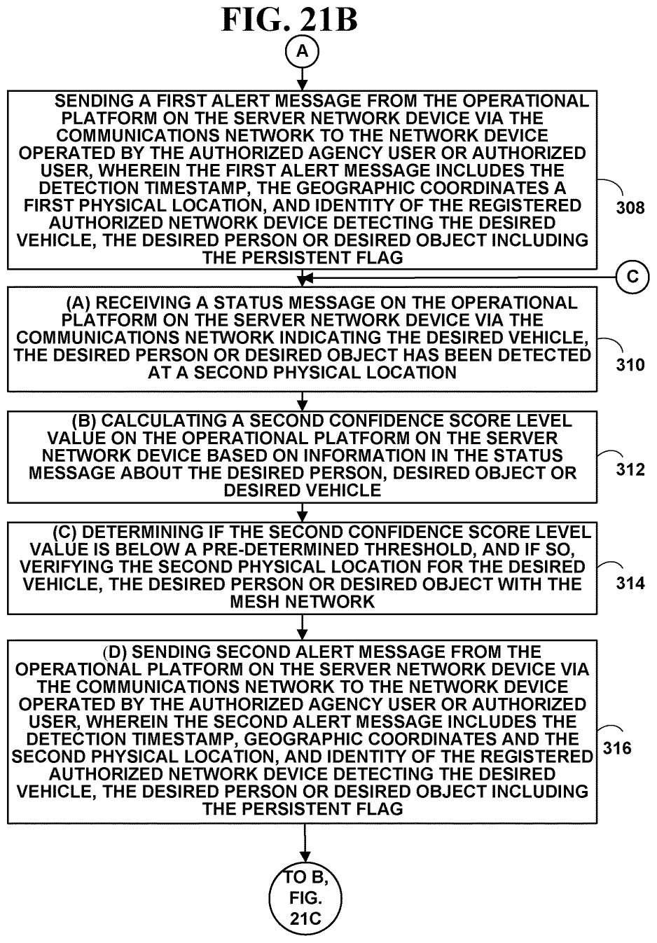

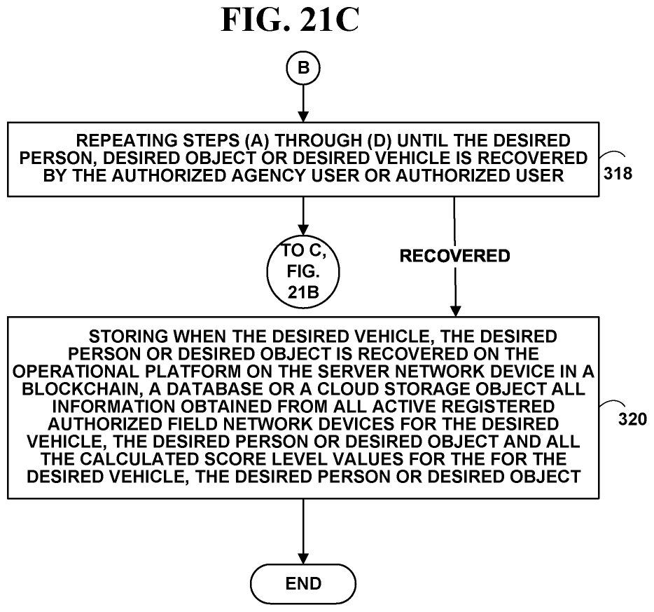

FIGS. 21A, 21B and 21C are a flow diagram including a Method 296 for providing a multi-layer personal awareness and operational coordination system.

In FIG. 21A at Step 298, receiving a persistent flag activation message on the operational platform on the server network device via the communication network from a network device with one or more processors operated by an authorized agency user or authored user of the operational platform to flag a desired person, desired object or desired vehicle; at Step 300, detecting on an active registered authorized field network device the persistent flag for the desired person, desired object or desired vehicle at a first physical location; at Step 302, sending from the active registered authorized field network device a persistent flag detected message to the operational platform on the server network device via the communication network, wherein the persistent flag detected message includes identifying information about the desired person, desired object or desired vehicle, a time stamp, geographic coordinates and an identifier for the active registered authorized field network device that detected the desired person, desired object or desired vehicle; at Step 304, receiving on the operational platform on the server network device via the communications network, the persistent flag detection message; at Step 306, calculating a first confidence score level value on the operational platform on the server network device based on information in the persistent flag detected message about the desired person, desired object or desired vehicle; In FIG. 21B at Step 308, sending a first alert message from the operational platform on the server network device via the communications network to the network device operated by the authorized agency user or authorized user, wherein the first alert message includes the detection timestamp, the geographic coordinates a first physical location, and identity of the registered authorized network device detecting the desired vehicle, the desired person or desired object including the persistent flag; at Step 310, (a) receiving a status message on the operational platform on the server network device via the communications network indicating the desired vehicle, the desired person or desired object has been detected at a second physical location; at Step 312 (b) calculating a second confidence score level value on the operational platform on the server network device based on information in the status message about the desired person, desired object or desired vehicle; at Step 314 (c) determining if the second confidence score level value is below a pre-determined threshold, and if so, verifying the second physical location for the desired vehicle, the desired person or desired object with the mesh network; at Step 316 (d) sending second alert message from the operational platform on the server network device via the communications network to the network device operated by the authorized agency user or authorized user, wherein the second alert message includes the detection timestamp, geographic coordinates and the second physical location, and identity of the registered authorized network device detecting the desired vehicle, the desired person or desired object including the persistent flag; and in FIG. 21C at Step 318 repeating steps (a) through (d) 310-316 until the desired person, desired object or desired vehicle is recovered by the authorized agency user or authorized user. At Step 320, storing when the desired vehicle, the desired person or desired object is recovered the on the operational platform on the server network device in a blockchain, a database or a cloud storage object all information obtained from all active registered authorized field network devices for the desired vehicle, the desired person or desired object and all the calculated score level values for the for the desired vehicle, the desired person or desired object.

The present invention is illustrated with an exemplary embodiment. However, the present invention is not limited to such an embodiment and other embodiments can be used to practice the invention.

In such an exemplary embodiment, in FIG. 21A at Step 298, receiving a persistent flag 237 activation message on the operational platform 204 on the server network device 20, 22, 24, 26 via the communication network 18, 18′ from a network device with one or more processors 12, 14, 16, 31, 33, 35, 37, 106-112 operated by an authorized agency user 39′ or authored user 39 of the operational platform 204 to flag a desired person 41, desired object 59 or desired vehicle 37.

At Step 300, detecting on an active registered authorized field network device 12, 14, 16, 31, 33, 35, 37, 106-112 the persistent flag 237 for the desired person 41, desired object 45 or desired vehicle 37 at a first physical location.

At Step 302, sending from the active registered authorized field network device 12, 14, 16, 31, 33, 35, 37, 106-112 a persistent flag 237 detected message to the operational platform 204 on the server network device 20, 22, 24, 26 via the communication network 18, 18′, wherein the persistent flag 237 detected message includes identifying information about the desired person 41, desired object 59 or desired vehicle 37, a time stamp, geographic coordinates and an identifier for the active registered authorized field network device 12, 14, 16, 31, 33, 35, 37, 106-112 that detected the desired person 41, desired object 59 or desired vehicle 37.

At Step 306, calculating a first confidence score level value on the operational platform 204 on the server network device 20, 22, 24, 26 based on information in the persistent flag 237 detected message about the desired person 41, desired object 59 or desired vehicle 37.

In FIG. 21B at Step 308, sending a first alert message from the operational platform 204 on the server network device 20, 22, 24, 26 via the communications network 18, 18′ to the network device 12, 14, 16, 31, 33, 35, 37, 106-112 operated by the authorized agency user 39′ or authorized user 39, wherein the first alert message includes the detection timestamp, the geographic coordinates a first physical location, and identity of the registered authorized network device 12, 14, 16, 31, 33, 35, 37, 106-112 detecting the desired vehicle 37, the desired person 41 or desired object 59 including the persistent flag 237.

At Step 310, (a) receiving a status message on the operational platform 204 on the server network device 20, 22, 24, 26 via the communications network 18 18′ indicating the desired vehicle 37, the desired person 41 or desired object 59 has been detected at a second physical location.

At Step 312 (b) calculating a second confidence score level value on the operational platform 204 on the server network device 20, 22, 24, 26 based on information in the status message about the desired person 41, desired object 59 or desired vehicle 37.

At Step 314 (c) determining if the second confidence score level value is below a pre-determined threshold, and if so, verifying the second physical location for the desired vehicle 37, the desired person 41 or desired object 59 with the mesh network 276.

At Step 316 (d) sending second alert message from the operational platform 204 on the server network device 20, 22, 24, 26 via the communications network 18, 18′ to the network device 12, 14, 16, 31, 33, 35, 37, 106-112 operated by the authorized agency user 39′ or authorized user 39, wherein the second alert message includes the detection timestamp, geographic coordinates and the second physical location, and identity of the registered authorized network device 12, 14, 16, 31, 33, 35, 37, 106-112 detecting the desired vehicle 37, the desired person 41 or desired object 59 including the persistent flag 237.

Aat Step 316 (d) sending second alert message from the operational platform 204 on the server network device 20, 22, 24, 26 via the communications network 18, 18′ to the network device 12, 14, 16, 31, 33, 35, 37, 106-112 operated by the authorized agency user 39′ or authorized user 39, wherein the second alert message includes the detection timestamp, geographic coordinates and the second physical location, and identity of the registered authorized network device 12, 14, 16, 31, 33, 35, 37, 106-112 detecting the desired vehicle 37, the desired person 39 or desired object 59 including the persistent flag 237.

In FIG. 21C at Step 318 repeating steps (a) through (d) 310-316 until desired vehicle 37, the desired person 39 or desired object 59 is recovered by the authorized agency user 39′ or authorized user 39.

At Step 320, storing when the desired person 39 or desired object 59 is recovered on the operational platform 204 on the server network 20, 22, 24, 24 device in a blockchain 174, database 20′, 22′, 24′, 24′ or cloud storage object 82, all information obtained from all active registered authorized field network devices 12, 14, 16, 31, 33, 35, 37, 106-112 for the desired vehicle 37, the desired person 41 or desired object 59 and all the calculated score level values for the for the desired vehicle 37, the desired person 41 or desired object 59.

In one embodiment, at Step 320, a sealed tamper-evident electronic evidentiary package is created and stored a blockchain 174, database 20′, 22′, 24′, 24′ or cloud storage object 82 operational platform 204 for direct submission as evidence in federal and state judicial criminal and civil proceedings. However, the present invention is not limited to such an embodiment and other embodiments with and/or without a sealed tamper-evident electronic evidentiary package.

Exemplary criminal scenario for using the operation platform 204 with Methods 296 include, but are not limited to, those described in Table 14. However, the present invention is not limited to such an embodiment and other embodiments, with more, fewer or other operating details and methods can be used to practice the invention.

TABLE 14
A detective 39 with a registered authorized network devices 12, 14, 16, 31, 33, 35, 37, 106-112
assigned to a homicide investigation and a bank robbery activates a persistent flag 237 on the
operational platform 204 for a suspect who is a desired person of interest 41. The persistent
flag 237 is attached to three identifiers simultaneously: the suspect's 41 verified facial
biometric profile derived from booking photographs, the device identifier associated with the
suspect's known mobile phone, and a GPS tracking chip embedded in a cash bundle taken
during the crime. The persistent flag 237 is assigned a law enforcement authorization code, a
jurisdictional compliance profile governing which enrolled nodes may respond and under what
legal authority, and a minimum alert confidence score level value threshold of 85%. The
persistent flag 237 is propagated silently and automatically across all registered authorized
network devices 12, 14, 16, 31, 33, 35, 37, 106-112 within a few seconds of activation.
Forty-seven minutes after persistent flag activation, a rideshare driver in a rideshare vehicle 37
with a registered authorized network device 12, 14, 16, 31, 33, 35, 37, 106-112 picks up a
passenger in a target neighborhood. The driver's registered authorized network device 12, 14,
16, 31, 33, 35, 37, 106-112 passively scans ambient device signals from the passenger's
registered authorized network device 12, 14, 16, 31, 33, 35, 37, 106-112 (e.g., mobile phone,
etc.) and transmits them to the operational platform 204. The suspect's mobile phone identifier
is detected. The operational platform 204 assigns an initial confidence score of 61%, above a
detection threshold but below an alert threshold, because device detection alone without
biometric corroboration does not satisfy a pre-determined confidence score level value of 85%,
a minimum alert confidence score level value requirement. The operational platform 204 does
not immediately send an alert message. Instead, it logs the detection event, timestamps it,
records the geographic coordinates, and initiates a background biometric corroboration request
to the vehicle's enrolled dashboard camera system.
The rideshare vehicle's 37 camera system captures a facial image of the passenger 41. The
operational platform 204 processes the image against the suspect's 41 flagged biometric
profile. Facial recognition returns a confidence score level value of 91%. The operational
platform 204 combines the device detection confidence score level value score value 61% with
a facial recognition confidence score level value of 91% and the geofence proximity
corroboration confidence score level value of 78% and the suspect is within the geofenced
search area established by the detective producing a combined confidence score level value of
88%. This exceeds the 85% minimum alert confidence score level value threshold.
The operational platform 204 generates a silent alert message. The alert message is transmitted
simultaneously to the originating detective's 39 registered authorized network device 12, 14,
16, 31, 33, 35, 37, 106-112, the precinct command workbench 39', and the nearest two patrol
units whose duty activation profiles place them within the operational zone. The alert message
includes the detection timestamp, the geographic coordinates of the rideshare vehicle 37, the
rideshare vehicle's license plate and the combined confidence score level value score of 88%,
the facial recognition match image, and the real-time location thread showing the suspect's 41
movement over the preceding 47 minutes across all prior detection events. The rideshare driver
receives no notification. The suspect 41 receives no notification. The alert message is entirely
silent at this point of detection.
As the rideshare vehicle 37 moves, the operational platform 204 continuously receives updates
on suspect's 41 persistent flag identity information thread. The suspect's 41 persistent flag
identity information thread is updated and synchronized across registered authorized network
device 12, 14, 16, 31, 33, 35, 37, 106-112 in real-time such that each subsequent detection,
query, or alert event modifies a shared state accessible to all registered authorized network
device 12, 14, 16, 31, 33, 35, 37, 106-112, thereby enabling cross-platform to 3rd party
platforms and continuity of identification, tracking, and alert propagation without requiring
independent re-querying of each registered authorized network device 12, 14, 16, 31, 33, 35,
37, 106-112.
The operation platform 204 tracks the rideshare vehicle's 37 movement through defined
geofencing operational zone subdivisions, detects the presence of other registered authorized
network devices, unauthorized and registered network devices 12, 14, 16, 31, 33, 35, 37, 106-
112 within or near the rideshare vehicle 37 and conditionally records associated identifiers in
accordance with system permissions and investigative relevance.
The operational platform 204 processes the vehicle's real-time movement data against stored
historical movement patterns associated with the suspect 41 and generates a probabilistic route
prediction, identifying a confidence score level value score of 73% likelihood that the rideshare
vehicle 37 is traveling toward a known criminal associate's address based on prior behavioral
correlations.
The operational platform 204 dynamically displays the suspect's 41 real-time position,
predicted route trajectory, associated confidence score level value, and a recommended
intercept point generated by the predictive routing module, thereby enabling informed
decision-making by authorized personnel 39'.
The suspect 41 exits the rideshare vehicle 37 and enters a building. The device signal is lost for
the suspect's 41 network device 12, 14, 16, 31, 33, 35, 37, 106-112. The operational platform
204 applies a temporal decay function including a network device detection confidence score
level value that degrades at a rate of 8% per minute and uses a mesh network 276 to improve
the confidence score level value. After four minutes without detection the network device
confidence score level value falls to 28%. The combined confidence score level value drops to
64%, below the alert threshold. The operational platform 204 does not generate a new alert
message but maintains the identity thread in a pending re-verification state.
Six minutes later a facial recognition camera enrolled through a building security application in
the same block detects a face matching the suspect's 41 biometric profile at 87% confidence
score level value. Because this detection is through an independent pathway. facial recognition
rather than network device detection, it satisfies the re-verification protocol. The confidence
score level value is recalculated using the new independent detection data and returns to 86%
confidence score level value. The identity thread is restored to active status. A second alert
message is generated updating the detective and patrol units with the suspect's 41 new second
physical location.
As patrol units' approach, the GPS tracking chip embedded in the cash bundle transmits a
signal from within the building. The operational platform matches the persistent flag for the
chip's signal against the active flag. A third detection event is logged, corroborating the
suspect's 41 presence in the building with a physical evidence link to the crime. The combined
confidence score level value rises to 94%.
The suspect is arrested in the building. At the moment of arrest operational platform 204
automatically seals the complete operational record, all detection events, the confidence score
history, the identity thread, the facial recognition match images, the device detection logs, the
tagged object signal history, the geographic coordinates of each detection event, the alert
transmission records and associated activity log into a cryptographically sealed tamper-evident
electronic evidentiary package.
The operational platform 204 records every access event from persistent flag activation
through arrest. The sealed tamper-evident electronic evidentiary package is formatted by the
operational platform for direct submission as evidence in federal and state judicial proceedings.

Additional details and advantages of the functional layers 206-222 of personal awareness and operation coordination system services 203 are included in Table 15. However, the present invention is not limited to such embodiments and more, fewer and/or other embodiments can be used to practice the invention.

```
TABLE 15
OPERATIONS AND OPERATIONAL PLATFORM 203, 204, 129, 146
  Rideshare safety - silent driver identity verification and database cross-reference
  before a passenger enters a vehicle.
  Dating app identity verification - passive biometric verification and safety database
  query before two enrolled users meet in person.
  Short-term rental safety - silent host and guest verification before property access.
  Childcare authorization and child safety monitoring - authorized pickup list
  enforcement and geofence-based alerts for enrolled children.
  Workplace security - silent alert when a terminated employee or threat-assessed
  individual enters proximity of an enrolled workplace node.
  Elder care and wandering prevention - geofence-based alerts to enrolled family
  members and facilities when a monitored individual moves outside an authorized area.
OPERATIONAL PLATFORM 204
  Shared real-time state dependency - all modules share a single unified operational
  state object with no transmission delay or API translation overhead.
  Cross-module interdependency - the behavioral analytics module cannot produce
  accurate predictive routing without simultaneous real-time input from all other
  modules on a shared data substrate.
  Confidence score propagation - confidence values derived from externally connected
  systems on separate data substrates cannot achieve the corroboration depth required for
  operationally reliable determinations.
  Persistent identity thread integrity - cross-ecosystem identity threading requires
  continuous uninterrupted data flow between modules on a shared real-time state; any
  latency or translation breaks the identity thread.
DESIRED PERSON 41 QUERIES 129, 146
  Direct device query - real-time communication with a third-party civilian application
  on a device physically present in the operational zone.
  Centralized database query - query to a remote server or cloud database maintained
  by a third-party civilian application for enrolled biometric data.
  Facial recognition independent of any device - identification through camera
  infrastructure integrated with enrolled civilian applications, requiring no device carried
  by the subject
  Persistent flag alert propagation - flag attached to a verified biometric profile, device
  identifier, or trackable physical object signal, propagating automatically across all
  enrolled civilian app nodes with silent alerts at each detection point.
  Persistent identity threading - a continuous shared state across enrolled nodes that is
  updated at each detection event without requiring independent re-querying by each
  node
  Flag lifecycle state management - activation, escalation, de-escalation, and
  termination conditions governed by confidence thresholds, elapsed time, geographic
  parameters, or automated system determinations.
  Adaptive alert sensitivity - detection events at any enrolled node dynamically
  influence query prioritization and monitoring intensity across all other enrolled nodes.
BIOMETRICS 130, 131 AND WEARABLES 98-104
  Raw biometric templates and irreversibly transformed identity tokens including IT2
  tokens.
  Privacy-preserving biometric representations and neural-network-derived face
  embeddings.
  Smart glasses facial recognition data and augmented reality headset environmental
  scan data.
  Smart watch biometric signatures including heart rate variability patterns and galvanic
  skin response profiles.
  Electroencephalographic signatures, brainwave pattern identifiers, and neural
  oscillation profiles.
  Brain-computer interface data from implanted neural interface devices, externally
  worn neurological interface headsets, and any present or future BCI technology
  whether invasive or non-invasive.
BIOMETRICS 130 DEEP FAKE DETECTION 130, 131
  Distinguishing live biometric presentations from deepfake video, AI-generated facial
  imagery, synthetic voice prints, photograph-based spoofing, and replay attacks.
  Rejection of identity verification attempts based on detected synthetic or manipulated
  biometric presentations.
  Logging of all detected synthetic presentation attempts as security events in the
  operational record for evidentiary purposes.
DATA SOVEREIGNTY 140-144
  All biometric, identity, movement, proximity, and event data stored exclusively on
  infrastructure physically located within and legally subject to the jurisdiction of the
  deploying agency or operator.
  Prohibition on transmission to foreign governments, foreign-owned commercial
  entities, or unauthorized third parties.
  Auditable compliance log documenting all data storage locations, access events, and
  transmission activities for each operational deployment.
  Automatic data purge schedules enforced per jurisdiction in compliance with
  applicable federal, state, and local data retention laws.
RESULTS CONFIDENCE LEVELS 126, 149
  Temporal decay function - confidence scores degrade at defined rates upon loss of
  signal, with automatic re-verification triggers at predefined thresholds.
  Alert confidence gating - no operational alert generated below a configurable
  minimum threshold, configurable per deployment and per-use case, logged in the
  auditable compliance record.
  False positive detection - internal consistency monitoring across all modules; any
  determination contradicted by corroborating inputs from two or more modules is
  automatically flagged and escalated.
  Re-verification protocol - independent re-verification using a different detection
  modality than the one that produced the original determination.
  Dispute and correction mechanism - any individual may formally dispute a system
  determination, triggering automatic suspension of active flags pending human review,
  with outcome propagated to all enrolled nodes.
  Misidentification logging and accountability - tamper-evident misidentification
  record maintained separately from the operational event log, available to oversight
  authorities, legal counsel, and affected individuals as required by applicable law.
COMMUNICATION PATHWAY RESLIENCE 18, 18'
  Automatic pathway selection and switching without interruption to active monitoring
  or loss of confidence score data.
  Multi-pathway combination for redundancy on critical operational data types.
  Degraded operation mode when all external pathways are denied - preserving
  geofence monitoring, proximity detection, confidence scoring, and identity flag
  matching using locally cached data and direct peer-to-peer communication.
  Satellite detection integration for tracking flagged subjects through areas with no
  ground-level enrolled nodes.
EVIDENCE COLLECTION AND CHAIN OF CUSTODY LAW ENFORCMENT 146,
148
  Collecting, timestamping, and cryptographically sealing all operational data into a
  tamper-evident evidentiary record.
  Maintaining an unbroken chain of custody log documenting every access,
  modification, transmission, and storage event from collection through presentation.
  Generating evidentiary packages formatted for admissibility in federal, state, and local
  judicial proceedings.
  Preserving evidentiary records in compliance with applicable federal and state rules of
  evidence and law enforcement data retention requirements.
RETROACTIVE EVENT RECONSTRUCTION 206-212, 144-149
  Upon flag activation, the system retroactively threads the subject's device identifier
  through all enrolled civilian application nodes that detected it during a preceding time
  window.
  The behavioral analytics module searches retroactively for devices whose movement
  patterns match a composite suspect description - dwell patterns, route surveying
  behavior, proximity to the event location, and timing of departure.
  The reconstructed pre-event behavioral record constitutes independently corroborated
  evidence of premeditation, assembled by the system before any flag was active and
  therefore untainted by any investigative action that could be challenged as pretextual.
```

It should be understood that the architecture, programs, processes, methods and systems described herein are not related or limited to any particular type of computer or network system (hardware and/or software and/or firmware, etc.), unless indicated otherwise. Various types of computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware and/or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended.

Therefore, all embodiments that come within the scope and spirit of the following claims and equivalents thereto are claimed as the invention.

I claim:

1. A multi-layer, personal awareness and operational coordination system, comprising in combination:
a multi-layer identification verification and location (IVL) application with a plurality of layers on a server network device with one or more processors, executing a plurality of different methods, wherein the plurality of different layers include:
(a) a first security layer including authorization for providing summary only identification verification and location information for a desired person; (b) a plurality of second advanced security layers including: (c) multi-layer identity verification layer comprising: a (1) biometrics layer including: a facial recognition sublayer, eye scan sublayer, and biometric markers identification sublayer, (2) Artificial Intelligence (AI) identity verification decision and scoring layer, (3) location tracking layer, (4) proximity detection layer (5) geofencing layer, (6) pattern recognition layer, (7) event recording layer, (8) secure data records layer, (9) data analytics layer, (10) electronic chain of custody layer, (11) jurisdictional biometrics and privacy law compliance layer, (12) law enforcement records layer, and (13) all requested identification verification and location information layer;
a communications network;
an operational platform including the multi-layer IVL application on the server network device and connected to the communications network including a plurality of sub-layers, comprising:
(a) an activations sub-layer within the multi-layer IVL application on the server network device configured for registering a plurality of authorized field network devices each with one or more processors, to a plurality of verified user identities, activating operational roles and permissions included in an active-duty status, wherein the plurality of authorized field network device becomes active mobile network nodes on the communications network within the operational platform;
(b) an operational platform geofencing sub-layer within the multi-layer IVL application on the server network device configured for defining one or more operational zones comprising primary geofenced boundaries and fine-grained internal spatial subdivisions within the primary geofenced boundaries, and for continuously monitoring the active registered plurality of authorized field network devices for entry time, exit time, dwell time, directional movement and geofence zone transition events across both the primary geofenced boundaries and the fine-grained internal spatial subdivisions;
(c) a device-to-device proximity sub-layer within the multi-layer IVL application on the server network device configured for performing decentralized peer-to-peer network signaling between the active registered plurality of authorized field network devices operable in regular signal, low signal and weak signal communications network environments, wherein the device-to-device proximity sublayer determines proximity relationships, clustering patterns, formation movement, and relational continuity between the active registered plurality of authorized field network devices that remain in a pre-determined physical proximity distance and wherein relational associations between the active registered plurality of authorized field network devices and persist across the fine-grained internal spatial subdivisions within the primary geofenced boundaries in the operational platform geofencing sub-layer without contextual reset;
(d) a real-time location sub-layer within the multi-layer IVL application on the server network device configured for collecting and overlaying secure positional location data from the active registered plurality of authorized field network devices onto a unified operational map, maintaining movement path histories for incident reconstruction and post-event analysis and detecting the presence of unauthorized or unregistered network devices, each with one or more processors, within the one or more operational zones within the communications network;
(e) a behavioral analytics sub-layer within the multi-layer IVL application on the server network device configured for evaluating and combining data from the activations sub-layer, the operational platform geofencing sub-layer, the device-to-device proximity sub-layer and the real-time location sub-layer to identify movement patterns, proximity dynamics, clustering and separation events, response timing, operational zone behavior, environmental interactions, behavioral anomalies, and predictive routing indicators based on detected movement trajectories of the active registered plurality of authorized field network devices and unauthorized or unregistered network devices;
(f) a confidence scoring sub-layer within the multi-layer IVL application on the server network device configured for calculating and continuously updating a confidence level value to each positional and relational determination of the active registered plurality of authorized field network devices and unauthorized or unregistered network devices based on Artificial Intelligence (AI) including Generative AI, Predictive AI and Retrieval Augmented Generation (RAG) AI analysis of proximity duration, dwell time, movement consistency, and environmental corroboration from a fixed network beacon or mobile network beacon infrastructure on the communications network, wherein confidence level values strengthen over time with a presence in a pre-determined detection range from the device-to-device proximity layer and degrade over time upon an absence from the pre-determined detection range from the device-to-device proximity layer;
(g) a mesh network sub-layer within the multi-layer IVL application on the server network device comprising a plurality of network addresses of fixed and mobile infrastructure nodes and building-mounted nodes, configured for augmenting device-to-device proximity detection with the fixed network beacon or mobile network beacon infrastructure when direct network signaling for the active registered authorized field network devices and unauthorized or unregistered network devices is strong, limited, weak or unavailable and extend operational awareness across blind spots and off-grid environments;
(h) an identity verification sub-layer within the multi-layer IVL application on the server network device configured for determining an exact biometric identity confirmation of users of the operational platform, users of the active registered authorized field network devices and other users of an unauthorized or unregistered network devices, exact biometric identity confirmation of authorized and unauthorized users upon geofence entry, analytics-detected anomaly, behavior patterns, command-level authorization, secure area access requirements and other detected events; and
(i) a persistent flag sub-layer within the multi-layer IVL application on the server network device configured for assigning on the operational platform on the server network device, persistent flags to desired vehicles, desired persons or desired objects at a request of an authorized agency or authorized person. Upon detection of a desired vehicle, a desired person or desired object with a persistent flag by any of the registered plurality of authorized network devices, the operational platform on the server network device securely sending an alert message via communications network to the authorized agency or the authorized person that requested the persistent flag. The alert message including a detection timestamp, geographic coordinates, and identity of a registered authorized network device detecting the desired vehicle, the desired person or the desired object including the persistent flag.

2. A method for providing personal awareness and operational coordination, comprising:
receiving a plurality of registration messages for registering a plurality of authorized network devices each with one or more processors on an operational platform within a multi-layer identification verification and location (IVL) application with a plurality of layers on a server network device with one or more processors,
the IVL application executing a first set plurality of different methods,
the operational platform further including a plurality of sub-layers within the IVL application executing a second set of a plurality of different methods;
determining on the operational platform on the server network device a verified identity of users of the registered plurality of authorized network devices;
defining on the operational platform on the server network device, a plurality of operational zones comprising primary geofenced boundaries and internal spatial subdivisions;
continuously monitoring on the operational platform on the server network device via the communications network, the registered plurality of authorized network devices for entry, exit, dwell time, directional movement, and zone transitions across the defined primary geofenced boundaries and the defined internal spatial subdivision boundaries;
performing on the operational platform on the server network device via the communications network, decentralized peer-to-peer proximity network signaling between the registered plurality of authorized network devices, maintaining relational continuity between proximately clustering of the registered plurality of authorized network devices across the defined primary geofenced boundaries and the defined internal spatial subdivision boundaries without contextual reset;
assigning on the operational platform on the server network device, persistent flags to desired vehicles, desired persons or desired objects at a request of an authorized agency or authorized person;
collecting on the operational platform on the server network device via the communications network, real-time positional data, relational data and persistent flag data from the registered plurality of authorized network devices,
wherein, upon detection of a desired vehicle, a desired person or desired object with a persistent flag by any of the registered plurality of authorized network devices, the operational platform on the server network device securely sending an alert message via communications network to the authorized agency or the authorized person that requested the persistent flag,
the alert message including a detection timestamp, geographic coordinates, and identity of a registered authorized network device detecting the desired vehicle, the desired person or desired object including persistent flag;
collecting on the operational platform on the server network device via the communications network, additional information about users of the registered plurality of authorized network devices from a plurality of third-party informational sources;
augmenting on the operational platform on the server network device, device-to-device proximity detection of the registered plurality of authorized network devices through fixed beacons on a fixed infrastructure and mobile beacons on a mobile infrastructure when direct network signaling is limited or unavailable on the communications network for the registered plurality of authorized network devices;
augmenting on the operational platform on the server network device, device-to-device proximity detection the registered plurality of authorized network devices through fixed beacons and mobile beacons on a mesh network when direct network signaling is limited or unavailable for the registered plurality of authorized network devices;
overlaying and displaying on the operational platform on the server network device, onto a unified operational map, movement histories of the registered plurality of authorized network devices, the collected positional data and relational data for the registered plurality of authorized network devices;
evaluating on the operational platform on the server network device, combined positional, proximity, geofence, and behavioral data to identify movement patterns, anomalies, clustering events, and Artificial Intelligence (AI) predictive behavior and predictive routing indicators of the registered plurality of authorized network devices with Generative AI, Predictive AI and Retrieval Augmented Generation (RAG) AI methods; and
continuously, calculating, evaluating and updating on the operational platform on the server network device, confidence score values to the collected positional data and collected relational data based on proximity duration, dwell time, movement consistency and environmental beacon corroboration of the registered plurality of authorized network devices,
wherein confidence score level values degrade upon a pre-determined absence time from a pre-determined detection range from the defined primary geofenced boundaries and the defined internal spatial subdivision boundaries by the registered plurality of authorized network devices.

3. The method of claim 2 wherein, the operational platform includes a plurality of sub-layers, comprising:
(a) an activations sub-layer within the multi-layer IVL application on the server network device;
(b) an operational platform geofencing sub-layer within the multi-layer IVL application on the server network device;
(c) a device-to-device proximity sub-layer within the multi-layer IVL application on the server network device;
(d) a real-time location sub-layer within the multi-layer IVL application on the server network device;
(e) a behavioral analytics sub-layer within the multi-layer IVL application on the server network device;
(f) a confidence scoring sub-layer within the multi-layer IVL application on the server network device;
(g) a mesh network sub-layer within the multi-layer IVL application on the server network device;
(h) an identity verification sub-layer within the multi-layer IVL application on the server network device; and
(i) a persistent flag sub-layer within the multi-layer IVL application on the server network device.

4. The method of claim 2 wherein, the step of determining on the operational platform on the server network device a verified identity of users of the registered plurality of authorized network devices includes determining: a name, address, current geographic physical location, current GPS location information, phone number, driver license number, vehicle information and license plate information, email identifiers, social media identifiers, tattoos, finger prints, DeoxyriboNucleic Acid (DNA) information, eye color, hair color, gait, voice, height, weight, digital photographs or law enforcement information, for the users of users of the registered plurality of authorized network devices.

5. The method of claim 2 wherein, persistent flags are assigned based on arrests, criminal convictions, outstanding arrest warrants, outstanding traffic tickets, be on the lookout (BOLO) lists, most wanted lists, stolen vehicle lists, stolen item lists, dangerous item lists, criminal complaints, criminal sentencing, or civil legal judgment information.

6. The method claim 2 wherein, the plurality of authorized field network devices, the unauthorized or unregistered network devices and the server network device include one or more wireless communications interfaces comprising one or more of: a cellular telephone, 802.11a, 802.11b, 802.11g, 802.11n, 802.11ac, 802.11ax, 802.11be, 802.15.4 (ZigBee), Wireless Fidelity (Wi-Fi), Wi-Fi Aware, Worldwide Interoperability for Microwave Access (WiMAX), ETSI High Performance Radio Metropolitan Area Network (HIPERMAN), Near Field Communications (NFC), Machine-to-Machine (M2M), 802.15.1 (BLUETOOTH®), RFID, or infra data association (IrDA), wireless communication interfaces.

7. The method of claim 2, wherein, the plurality of authorized field network devices and the unauthorized or the unregistered network devices include: desktop and laptop computers, tablet computers, mobile phones, non-mobile phones with displays, smart phones, Internet phones, Internet appliances, personal digital/data assistants (PDA), portable, handheld and desktop video game devices, cable television (CATV), satellite television (SATV) and Internet television set-top boxes, digital televisions including high definition television (HDTV), three-dimensional (3DTV) televisions, smart speakers, Internet of Things (IoT) devices, Radio Frequency Identifier (RFID) devices, wearable network devices, Point of Sale (PoS) network devices, or air, water or land vehicles, with wireless or wired network interfaces, connectable to the communications network.

8. The method of claim 2 wherein, the alert message includes: an email message, voice message, video message, RCS message, Short Message Service (SMS) message, Direct Message (DM), Instant Message (IM), Multimedia Messaging Service (MMS) message, GOOGLE Business Message, APPLE iMessage, instant message, direct message, Short Message Peer-to-Peer (SMPP) message, social media message, REpresentational State Transfer (REST) message, data link protocol message, network protocol message, Simple Object Access Protocol (SOAP) message, or Lightweight Directory Access Protocol (LDAP) message.

9. The method of claim 2 wherein, the alert message is securely sent by the operational platform on the server network device via the communications network with one or more of: a Wireless Encryption Protocol (WEP), Advanced Encryption Standard (AES), Data Encryption Standard (DES), RSA encryption, Secure Hash Algorithm (SHA), Message Digest-5 (MD-5), Perceptual Hashing, Keyed Hashing for Message Authentication Codes (HMAC), Electronic Code Book (ECB) or Diffie and Hellman (DH) or Secure Sockets Layer (SSL), encryption or security methods including end-to-end encryption methods.

10. The method of claim 2 wherein, server network device includes a plurality of cloud applications and one or more cloud databases communicating with a cloud communications network, the plurality of cloud applications providing a plurality of cloud identification verification and location services including: a cloud computing Infrastructure as a Service (IaaS), a cloud computing Platform as a Service (PaaS) and one or more real-time, multi-layer identification and location verification and operational platform services as Software as a Services (SaaS).

11. The method of claim 10 wherein, the one or more cloud databases include one or more cloud storage objects comprising one or more of: a REpresentational State Transfer (REST) or Simple Object Access Protocol (SOAP), Lightweight Directory Access Protocol (LDAP) cloud storage objects, portions thereof, or combinations thereof, stored in the one or more cloud databases.

12. The method of claim 2 wherein, the fixed beacons include a stationary transmitting device or a signal source with a known, stable physical location on the fixed beacon infrastructure used as a reference point for detecting, positioning, and validating nearby active registered authorized field network devices or unauthorized or unregistered network devices within the communications network.

13. The method of claim 2, wherein the fixed beacons include, network access points, network anchor points, cell towers, light pole sensors, utility pole sensors, observation cameras, observation cameras, traffic cameras or doorbell cameras.

14. The method of claim 2 wherein, the mobile beacons include a beacon transmitter that is not fixed in location, but instead moves with an active registered authorized field network devices or unauthorized or unregistered network devices, vehicles, persons or objects, continuously broadcasting identifiable wireless signals within the communications network.

15. The method of claim 2 wherein, the mobile beacons are categorized by radio signal technology functional role, including identity, telemetry, positioning, mobility pattern and trust level, each affecting how mobile signals on the mobile beacon infrastructure are interpreted within the communications network.

16. The method of claim 2 wherein, the mesh network includes, a mesh network architecture in which a plurality of nodes including the active registered authorized field network devices, server network device and other nodes that are interconnected in a non-hierarchical, peer-to-peer topology, allowing data to be routed dynamically across multiple paths between any two points.

17. The method of claim 16 wherein, the other nodes in the mesh network include fixed mesh network devices or mesh network beacons physically installed on structures such as walls, ceilings, rooftops, light poles, utility poles, cell towers, and other physical locations that act as stationary reference points or communication endpoints within a wireless mesh network or sensor mesh network.

18. The method of claim 2, wherein the operational platform performs operations with:
(1) the multi-layer identification verification and location (IVL) application with the plurality of layers executing the plurality of different methods, wherein the plurality of layers include:
(a) a first security layer including authorization for providing summary only identification verification and location information for a desired person; (b) a plurality of second advanced security layers including: (c) multi-layer identity verification layer comprising: a (1) biometrics layer including: a facial recognition sublayer, eye scan sublayer, and biometric markers identification sublayer, (2) Artificial Intelligence (AI) identity verification decision and scoring layer, (3) location tracking layer, (4) proximity detection layer (5) geofencing layer, (6) pattern recognition layer, (7) event recording layer, (8) secure data records layer, (9) data analytics layer, (10) electronic chain of custody layer, (11) jurisdictional biometrics and privacy law compliance layer, (12) law enforcement records layer, and (13) all requested identification verification and location information layer; and
(2) the plurality of sub-layers within the IVL application executing a second set of a plurality of different methods, wherein the plurality of sub-layers include:
(a) an activations sub-layer within the multi-layer IVL application on the server network device operating within a first security layer, a summary only identification and location information for a desired person layer, a second advanced security layer and an all requested identification verification and location information for a desired person layer of the multi-layer IVL application;
(b) an operational platform geofencing sub-layer within the multi-layer IVL application on the server network device operating with a geofencing layer of the multi-layer IVL application;
(c) a device-to-device proximity sub-layer within the multi-layer IVL application on the server network device operating within a proximity detection layer of the multi-layer IVL application;
(d) a real-time location sub-layer within the multi-layer IVL application on the server network device operating within a location tracking layer of the multi-layer IVL application;
(e) a behavioral analytics sub-layer within the multi-layer IVL application on the server network device operating within an artificial intelligence (AI) identity verification decision layer, pattern recognition layer, event recording layer, secure data records layer, data analytics layer and the law enforcement records layer of the multi-layer IVL application;
(f) a confidence scoring sub-layer within the multi-layer IVL application on the server network device operating within the artificial intelligence (AI) identity verification decision layer of the multi-layer IVL application;
(g) a mesh network sub-layer within the multi-layer IVL application on the server network device operating within the second advance security layers of the multi-layer IVL application;
(h) an identity verification sub-layer within the multi-layer IVL application on the server network device operating within the summary only identification and location information for the desired person layer, a biometrics layer, the artificial intelligence (AI) identity verification decision layer, the secure data records layer, a law enforcement records layer and the all requested identification verification and location information for the desired person layer, of the multi-layer IVL application; and
(i) a persistent flag sub-layer within the multi-layer IVL application on the server network device operating within the summary only identification and location information for the desired person layer, the second advanced security layers, muti-layer identity verification layer, event recording layer, the secure data records layer, data analytics layer, electronic chain of custody layer, the law enforcement records layer and the all requested identification verification and location information for the desired person layer, of the multi-layer IVL application.

19. The method of claim 2 further comprising:
receiving a persistent flag activation message on the operational platform on the server network device via the communication network from a network device with one or more processors operated by an authorized agency user or authored user of the operational platform to flag a desired person, desired object or desired vehicle;
detecting on an active registered authorized field network device the persistent flag for the desired person, desired object or desired vehicle at a first physical location;
sending from the active registered authorized field network device a persistent flag detected message to the operational platform on the server network device via the communication network,
wherein the persistent flag detected message includes identifying information about the desired person, desired object or desired vehicle, a time stamp, geographic coordinates and an identifier for the active registered authorized field network device that detected the desired person, desired object or desired vehicle;
receiving on the operational platform on the server network device via the communications network, the persistent flag detection message;
calculating a first confidence score level value on the operational platform on the server network device based on information in the persistent flag detected message about the desired person, desired object or desired vehicle;
sending a first alert message from the operational platform on the server network device via the communications network to the network device operated by the authorized agency user or authorized user,
wherein the first alert message includes the detection timestamp, the geographic coordinates a first physical location, and identity of the registered authorized network device detecting the desired vehicle, the desired person or desired object including the persistent flag;
(a) receiving a status message on the operational platform on the server network device via the communications network indicating the desired vehicle, the desired person or desired object has been detected at a second physical location;
(b) calculating a second confidence score level value on the operational platform on the server network device based on information in the status message about the desired person, desired object or desired vehicle;
(c) determining on the operational platform on the server network device if the second confidence score level value is below a pre-determined threshold, and if so, verifying the second physical location for the desired vehicle, the desired person or desired object with the mesh network;
(d) sending second alert message from the operational platform on the server network device via the communications network to the network device operated by the authorized agency user or authorized user,
wherein the second alert message includes the detection timestamp, geographic coordinates and the second physical location and identity of the registered authorized network device detecting the desired vehicle, the desired person or desired object including the persistent flag;
repeating steps (a) through (d) until the desired vehicle, the desired person or desired object is recovered by the authorized agency user or authorized user; and
storing when the desired vehicle, the desired person or desired object is recovered on the operational platform on the server network device in a blockchain, a database or a cloud storage object all information obtained from all active registered authorized field network devices for the desired vehicle, the desired person or desired object and all the calculated score level values for the for the desired vehicle, the desired person or desired object.

20. One or more non-transitory computer readable mediums each having stored therein a plurality of instructions for causing one or more processors on one more network devices to execute the steps of:
receiving a plurality of registration messages for registering a plurality of authorized network devices each with one or more processors on an operational platform within a multi-layer identification verification and location (IVL) application with a plurality of layers on a server network device with one or more processors,
the IVL application executing a first set plurality of different methods,
the operational platform including a plurality of sub-layers within the IVL application executing a second set of a plurality of different methods;
determining on the operational platform on the server network device a verified identity of users of the registered plurality of authorized network devices;
defining on the operational platform on the server network device, a plurality of operational zones comprising primary geofenced boundaries and internal spatial subdivisions;
continuously monitoring on the operational platform on the server network device via the communications network, the registered plurality of authorized network devices for entry, exit, dwell time, directional movement, and zone transitions across the defined primary geofenced boundaries and the defined internal spatial subdivision boundaries;
performing on the operational platform on the server network device via the communications network, decentralized peer-to-peer proximity network signaling between the registered plurality of authorized network devices, maintaining relational continuity between proximately clustering of the registered plurality of authorized network devices across the defined primary geofenced boundaries and the defined internal spatial subdivision boundaries without contextual reset;
assigning on the operational platform on the server network device, persistent flags to desired vehicles, desired persons or desired objects at a request of an authorized agency or authorized person;
collecting on the operational platform on the server network device via the communications network, real-time positional data, relational data and persistent flag data from the registered plurality of authorized network devices,
wherein, upon detection of a desired vehicle, a desired person or desired object with a persistent flag by any of the registered plurality of authorized network devices, the operational platform on the server network device securely sending an alert message via communications network to the authorized agency or the authorized person that requested the persistent flag,
the alert message including a detection timestamp, geographic coordinates, and identity of a registered authorized network device detecting the desired vehicle, the desired person or desired object including persistent flag;
collecting on the operational platform on the server network device via the communications network, additional information about users of the registered plurality of authorized network devices from a plurality of third-party informational sources;
augmenting on the operational platform on the server network device, device-to-device proximity detection of the registered plurality of authorized network devices through fixed beacons on a fixed infrastructure and mobile beacons on a mobile infrastructure when direct network signaling is limited or unavailable on the communications network for the registered plurality of authorized network devices;
augmenting on the operational platform on the server network device, device-to-device proximity detection the registered plurality of authorized network devices through fixed beacons and mobile beacons on a mesh network when direct network signaling is limited or unavailable for the registered plurality of authorized network devices;
overlaying and displaying on the operational platform on the server network device, onto a unified operational map, movement histories of the registered plurality of authorized network devices, the collected positional data and relational data for the registered plurality of authorized network devices;
evaluating on the operational platform on the server network device, combined positional, proximity, geofence, and behavioral data to identify movement patterns, anomalies, clustering events, and Artificial Intelligence (AI) predictive routing indicators of the registered plurality of authorized network devices;
continuously, calculating, evaluating and updating on the operational platform on the server network device, confidence score values to the collected positional data and collected relational data based on proximity duration, dwell time, movement consistency and environmental beacon corroboration of the registered plurality of authorized network devices,
wherein confidence score level values degrade upon a pre-determined absence time from a pre-determined detection range from the defined primary geofenced boundaries and the defined internal spatial subdivision boundaries by the registered plurality of authorized network devices;
receiving a persistent flag activation message on the operational platform on the server network device via the communication network from a network device with one or more processors operated by an authorized agency user or authored user of the operational platform to flag a desired person, desired object or desired vehicle;
detecting on an active registered authorized field network device the persistent flag for the desired person, desired object or desired vehicle at a first physical location;
sending from the active registered authorized field network device a persistent flag detected message to the operational platform on the server network device via the communication network,
wherein the persistent flag detected message includes identifying information about the desired person, desired object or desired vehicle, a time stamp, geographic coordinates and an identifier for the active registered authorized field network device that detected the desired person, desired object or desired vehicle;
receiving on the operational platform on the server network device via the communications network, the persistent flag detection message;
calculating a first confidence score level value on the operational platform on the server network device based on information in the persistent flag detected message about the desired person, desired object or desired vehicle;
sending a first alert message from the operational platform on the server network device via the communications network to the network device operated by the authorized agency user or authorized user,
wherein the first alert message includes the detection timestamp, the geographic coordinates a first physical location, and identity of the registered authorized network device detecting the desired vehicle, the desired person or desired object including the persistent flag;
(a) receiving a status message on the operational platform on the server network device via the communications network indicating the desired vehicle, the desired person or desired object has been detected at a second physical location;
(b) calculating a second confidence score level value on the operational platform on the server network device based on information in the status message about the desired person, desired object or desired vehicle;
(c) determining if the second confidence score level value is below a pre-determined threshold, and if so, verifying the second physical location for the desired vehicle, the desired person or desired object with the mesh network;
(d) sending second alert message from the operational platform on the server network device via the communications network to the network device operated by the authorized agency user or authorized user,
wherein the second alert message includes the detection timestamp, geographic coordinates and the second physical location and identity of the registered authorized network device detecting the desired vehicle, the desired person or desired object including the persistent flag;
repeating steps (a) through (d) until the desired vehicle, the desired person or desired object is recovered by the authorized agency user or authorized user; and
storing when the desired vehicle, the desired person or desired object is recovered on the operational platform on the server network device in a blockchain, a database or a cloud storage object all information obtained from all active registered authorized field network devices for the desired vehicle, the desired person or desired object and all the calculated score level values for the for the desired vehicle, the desired person or desired object.
